(19) United States
(12) Patent Application Publication
(10) Pub. No.: US 2024/0335833 A1
(43) Pub. Date: Oct. 10, 2024

(54) CONCEPT FOR DETERMINING EXTERNAL INFLUENCING FACTORS ON THE BASIS OF THE CONTROL SIGNAL OF A MICROFLUIDIC COMPONENT

(71) Applicant: Fraunhofer-Gesellschaft zur Förderung der angewandten Forschung e.V., München (DE)

(72) Inventors: Sebastian KIBLER, München (DE); Henry LEISTNER, München (DE); Karl NEUMEIER, München (DE); Thomas THALHOFER, München (DE); Kristjan AXELSSON, München (DE); Daniel ANHEUER, München (DE); Martin RICHTER, München (DE); Johannes HÄFNER, München (DE); Claudia DURASIEWICZ, München (DE); Christian WALD, München (DE); Agnes BUSSMANN, München (DE); Lorenz GRÜNERBEL, München (DE)

(73) Assignee: Fraunhofer-Gesellschaft zur Förderung der angewandten Forschung e.V., München (DE)

(21) Appl. No.: 18/738,051

(22) Filed: Jun. 9, 2024

Related U.S. Application Data
(63) Continuation of application No. PCT/EP2022/084750, filed on Dec. 7, 2022.

(30) Foreign Application Priority Data
Dec. 9, 2021 (DE) 102021214091.2

(51) Int. Cl. B01L 3/00; G01N 27/22

(52) U.S. Cl. CPC B01L 3/502715; B01L 3/50273; G01N 27/22; B01L 2200/143

(57) ABSTRACT

The inventive concept described herein concerns a microfluidic component, comprising a membrane actuator with a membrane element and an actuator element for deflecting the membrane element. A signal generation device is configured to generate an electric control signal having a time-variant signal curve for controlling the membrane actuator, by which the actuator element actuates the membrane element. A signal processing device is configured to detect, during operation of the microfluidic component, an influence on the temporal signal curve of the control signal, caused by one or more external influencing factors, and, on the basis of this influence on the temporal signal curve, to identify and/or classify at least one causal external influencing factor.

### CROSS-REFERENCE TO RELATED APPLICATIONS

This application is a continuation of copending International Application No. PCT/EP2022/084750, filed Dec. 7, 2022, which is incorporated herein by reference in its entirety, and additionally claims priority from German Application No. 10 2021 214 091.2, filed Dec. 9, 2021, which is also incorporated herein by reference in its entirety.

The invention described herein concerns a device in the field of microfluidics. For example, the inventive microfluidic component may be a microvalve or a micropump that may be actuated by means of a microstructured membrane actuator. The present disclosure proposes an innovative concept with which the microfluidic component can monitor itself during operation by evaluating the temporal progress of the control signal.

### BACKGROUND OF THE INVENTION

Fluidic microactuators, such as micropumps or microvalves, driven by membrane actuators may transport liquids or gases or switch fluidic paths. In practice, there may be several disturbances or changes in the fluidic boundary conditions that may impair the intended function of these actuators. Since these actuator components do not have any sensor properties, they cannot detect disturbance incidents.

For example, microactuators are often used in micro-dosage systems. One possibility to monitor a micro-dosage or to detect disturbance incidents is the use of flow sensors, for example anemometers, enabling to measure pressure differences or changes of capacity. In addition, flow sensors or pressure sensors may be used to detect disturbances. In this case, however, there is a disadvantage in that separate components have to be integrated into the micro-dosage system accordingly.

A further approach to detect disturbances is the use of sensor systems in the actuator membrane, i.e. special sensors are integrated directly into the membrane of the microactuator, enabling to determine the voltage state of the membrane, for example. Alternatively, additional electrodes may be mounted on the piezoceramic. However, in this case, there are disadvantages in that additional contacting is required, manufacturing becomes more complex overall, and direct information about the pneumatic or hydraulic state cannot be determined. In addition, the sensor technology has to be housed in critical membrane actuator areas with high electric voltages and great mechanical stresses.

A further possibility to detect disturbance incidents or error states is the use of two micropumps connected in series, comprising a piezo element. The two piezoelectrically driven micropumps are connected such that one of the two pumps is in operation, while the other pump is inactive. The effect of the fluidic signal of the micropump in operation is now detected by the sensor properties of the piezo element of the switched-off second micropump.

In this case, in addition to the microactuator, an additional sensor element is again required, here in the form of a second micropump. Furthermore, the fluidic signal of a micropump is influenced by fluidic lines between the two micropumps and no longer represents the process in the pump chamber of the active micropump.

A further possibility to detect disturbances is the use of a separate electrode on a piezo-actuated drive membrane. When using the piezoceramic as a pump drive element, it has to be charged with a high voltage in a very short period of time. This charging current I=C*dU/dt is significantly higher than the expected sensor effect. Thus, there is an attempt to realize a separate “sensor electrode” on the piezoceramic. The use of a separate electrode as a sensor electrode provides the possibility to utilize the sensor effect of the piezo drive membrane.

However, this again requires a second electrode with a wiring required accordingly. In addition, part of the piezoceramic is occupied by the second electrode, wherein said part may not be used for the actuator system. In addition, the interaction is only detected at the location of the piezoceramic where the separate actuator system is located.

Thus, it would be desirable to improve existing systems for detecting disturbance incidents or for monitoring states of microfluidic components so that additional sensor technology or additional electrodes are not required. In addition, it would be desirable that the microfluidic component does not have to be controlled in a special way, but that a state can be monitored during regular operation, i.e. during regular control.

### SUMMARY

According to an embodiment, a microfluidic component may have: a membrane actuator with a membrane element and an actuator element for deflecting the membrane element, a signal generation device configured to generate an electric control signal having a time-variant signal curve for controlling the membrane actuator, by which the actuator element actuates the membrane element, a signal processing device configured to determine, during operation of the microfluidic component, an influence on the temporal signal curve of the control signal, caused by one or more external influencing factors, and to identify and/or classify, based on said influence on the temporal signal curve, at least one causal external influencing factor.

According to another embodiment, a method for operating a microfluidic component with a membrane actuator comprising a membrane element and an actuator element for deflecting the membrane element may have the steps of: generating an electric control signal for controlling the membrane actuator, by which the actuator element actuates the membrane element, wherein the electric control signal comprises a time-variant signal curve, determining, during operation of the microfluidic component, a temporal signal curve of the control signal influenced by one or more external influencing factors, and identifying and/or classifying at least one external influencing factor on the basis of the determined influenced temporal signal curve.

Another embodiment may have a non-transitory digital storage medium having a computer program stored thereon to perform the inventive method for operating a microfluidic component when said computer program is run by a computer.

The inventive microfluidic component comprises a membrane actuator with a membrane element and with an actuator element for deflecting the membrane element. Furthermore, the inventive microfluidic component comprises a signal generation device configured to generate an electric control signal having a time-variant signal curve for controlling the membrane actuator, by which the actuator element actuates the membrane element. The inventive microfluidic component additionally comprises a signal processing device configured to determine, during operation of the microfluidic component, an influence on the temporal signal curve of the control signal, caused by one or more external influencing factors. In addition, the signal processing device is configured to identify and/or classify, based on this influence on the temporal signal curve, at least one causal external influencing factor.

Accordingly, the regular control signal of the membrane actuator, or its temporal progress during at least one deflection process of the membrane actuator, is observed. In this case, different external influencing factors have different impacts on the temporal progress of the control signal. That is, the control signal changes depending on how the membrane actuator interacts with its environment. These influences of the surroundings change the membrane actuator (e.g. its voltage state or its position) so that certain electric parameters change, which in turn directly affects the current flow of the control signal. Since these interactions can change temporally, the interaction process can be inferred through a precise determination, or measurement, of the control signal.

For example, an external influence in the form of a pressure change underneath a piezo-actuated membrane transducer leads to a force action that, due to the direct piezo effect, leads to a current flow on the piezoceramic that is purely caused by this pressure change. In the context of the present disclosure, this current flow is sometimes also referred to as “sensor current.” This sensor current overlaps the current required to electrically charge the capacitive load. That is, the additional current flow created due to the external influences overlaps the control signal (e.g. charging current) and accordingly leads to deviations in the temporal progress of the control signal.

A precise measurement of the control signal (e.g. the charging current) of the membrane actuator, which is required for regular operation of the membrane actuator anyway, is sufficient to be able to measure time-variant fluidic and mechanical processes at, or in, an inventive microfluidic component (e.g. in a pump chamber of a micropump and/or at a microvalve). This makes the inventive concept described herein very advantageous since there have to be no changes with respect to the components of the microfluidic component. It is sufficient to integrate the corresponding measurement function into the driver electronics of the microfluidic component, advantageously in combination with a suitable means for capturing data and evaluating data.

Thus, with the inventive concept described herein, information indicating how the membrane actuator interacts hydraulically, pneumatically, mechanically, or piezoelectrically with its environment can be extracted from the regular control signal, in a purely electrical way, without further devices, and in real time. Relevant fluidic changes, such as valve degradation, counter pressure variations, actuator fatigue, occurrence of gas bubbles, and the like, can be detected from this information.

The state of the microfluidic component can be monitored on the basis of an inventive signal evaluation of the temporal progress of the control signal. That is, during operation and in particular during regular operation (i.e. special calibration modes are not required), the inventive microfluidic component can monitor itself. The temporal progress gives information about how the microfluidic component interacts with its environment, i.e. which external influencing factors currently affect the microfluidic component. Depending on the type of the prevailing external influencing factors, the temporal progress of the control signal is affected differently. Each individual influencing factor leaves its specific fingerprint in the temporal provision of the control signal, so to speak. Through this, e.g. on the basis of the correspondingly influenced temporal signal curve, the type of currently prevailing external influencing factors can be determined. For example, it can be determined whether there is a defect, and if that is the case, its type can be determined as well.

The invention further concerns a corresponding method for operating a microfluidic component with a membrane actuator comprising a membrane element and an actuator element for deflecting the membrane element. In this case, the method includes a step of generating an electric control signal for controlling the membrane actuator, by which the actuator element actuates the membrane element, wherein the electric control signal comprises a time-variant signal curve. In addition, the inventive method includes a step of determining, during operation of the microfluidic component, a temporal signal curve of the control signal, influenced by one or more external influencing factors, and a step of identifying and/or classifying at least one external influencing factor on the basis of the determined influenced temporal signal curve.

### BRIEF DESCRIPTION OF THE DRAWINGS

Embodiments of the present invention will be detailed subsequently referring to the appended drawings, in which:

FIG. 1 shows a schematic view of a microfluidic component with an inventive signal evaluation according to an embodiment,

FIG. 2 shows a schematic view of different embodiments of a membrane actuator,

FIG. 3 shows a further schematic view of a microfluidic component with an inventive signal evaluation according to an embodiment,

FIG. 4 shows a schematic view of an inventive signal evaluation device according to an embodiment,

FIG. 5 shows an overview of the physical processes within a piezo element,

FIG. 6 shows a graphic illustration of a mathematical function for describing the voltage dependency of the capacitance of a micropump,

FIG. 7A shows a graphic illustration of mathematical functions for describing the temporal signal curve of the current and voltage curves in case of sinusoidal control in a micropump,

FIG. 7B shows a graphic illustration of mathematical functions for describing the temporal signal curve of the current and voltage curves in case of sinusoidal control in a capacitor,

FIG. 8 shows two Lissajous curves for visual representation of hysteresis effects in a micropump compared to a capacitor,

FIG. 9A shows a Lissajous curve of a micropump that conveys liquid with a harmonic control and is exposed to an air bubble as an external influencing factor,

FIG. 9B shows a Lissajous curve of a micropump that conveys liquid with a harmonic control and is exposed to a closure as an external influencing factor,

FIG. 10 shows a so-called confusion matrix for determining system states, or external influencing factors, on the basis of a frequency of correct predictions,

FIG. 11 shows a Lissajous curve of a micropump at different counter pressures,

FIG. 12 shows three different temporal signal curves of control signals with different voltages as well as curves fitted to these signal curves,

FIG. 13 shows the signal curve of the amplitude of the current term Iₚ of a micropump in the suction stroke depending on the applied voltage,

FIG. 14 shows the temporal decay constants of a micropump associated to the current term Iₚ in the suction stroke depending on the applied voltage,

FIG. 15 shows a comparison of the temporal decay constants of a micropump in the suction stroke and in the pressure stroke, each depending on the applied voltage,

FIG. 16A shows the signal curve of the amplitude of the current term I_{CE} of a micropump in the suction stroke depending on the applied voltage,

FIG. 16B shows the temporal decay constant, associated with the current term I_{CE}, of a micropump in the suction stroke depending on the applied voltage,

FIG. 17A shows the signal curve of the amplitude of the sum of the two current terms I_{C}+I_{CE} of a micropump in the pressure stroke depending on the applied voltage.

FIG. 17B shows the temporal decay constant, associated with the sum current term I_{C}+I_{CE}, of a micropump in the pressure stroke depending on the applied voltage,

FIG. 18A shows the signal curve of the amplitude of the sum of the two current terms I_{C}+I_{CE} of a micropump in the pressure stroke depending on the applied voltage in the case of small voltages,

FIG. 18B shows the temporal decay constant, associated with the sum current term I_{C}+I_{CE}, of a micropump in the suction stroke depending on the applied voltage in the case of small voltages,

FIG. 19 shows a block circuit diagram of a measuring structure used to perform the measurements shown in the subsequent figures,

FIG. 20 shows the temporal signal curve of the amplitude of the current term Iₚ of an air-conveying micropump in the suction stroke and in the pressure stroke in its normal state, i.e. without impact of an external influencing factor,

FIG. 21 shows an enlarged illustration of the temporal signal curve in the suction stroke according to FIG. 20,

FIG. 22 shows an enlarged illustration of the temporal signal process in the pressure stroke according to FIG. 20,

FIG. 23 shows the temporal signal curve of the amplitude of the current term Iₚ of a liquid-conveying micropump in the suction stroke and in the pressure stroke in its normal state, i.e. without an impact of an external influencing factor,

FIG. 24 shows an enlarged illustration of the temporal signal curve in the suction stroke according to FIG. 23,

FIGS. 25A-25C show enlarged illustrations of an overshoot in the temporal signal curve in a suction stroke according to FIG. 24,

FIG. 26 shows an enlarged illustration of the temporal signal provision in the suction stroke according to FIG. 23,

FIG. 27A shows the temporal signal curve of the amplitude of the current term Iₚ of a liquid-conveying micropump in the suction stroke under the impact of an external influencing factor in the form of a gas bubble.

FIG. 27B shows a detailed view of the temporal signal curve in the suction stroke according to FIG. 27A,

FIG. 27C shows the temporal signal curve of the amplitude of the current term Iₚ of the liquid-conveying micropump in the suction stroke, a few pump strokes prior to the occurrence of the gas bubble in the pump chamber,

FIG. 27D shows the temporal signal curve according to FIG. 27A, while the gas bubble is located in a pump chamber,

FIG. 27E shows the temporal signal curve of the amplitude of the current term Iₚ of the liquid-conveying micropump in the suction stroke, a few pump strokes after the gas bubble has left the pump chamber,

FIG. 28A shows the temporal signal curve of the amplitude of the current term Iₚ of a liquid-conveying micropump in the suction stroke and in the pressure stroke under the impact of an external influencing factor in the form of a gas bubble,

FIG. 28B shows a detailed view of the temporal signal curve in the pressure stroke according to FIG. 28A,

FIG. 29A shows the temporal signal curve of the amplitude of the current term Iₚ of a liquid-conveying micropump in the suction stroke and in the pressure stroke under the impact of an external influencing factor in the form of a continuously declining counter pressure,

FIG. 29B shows the temporal progress of the counter pressure at the inlet-side reservoir and at the outlet-side reservoir,

FIG. 29C shows a detailed view of the temporal signal curve in the suction stroke according to FIG. 29A,

FIG. 29D shows a detailed view of the temporal signal curve in the pressure stroke according to FIG. 29A,

FIG. 30A shows the temporal signal curve of the amplitude of the current term Iₚ of an air-conveying micropump in the suction stroke and in the pressure stroke under the impact of an external influencing factor in the form of a continuously declining pressure,

FIG. 30B shows a detailed view of the temporal signal curve in the suction stroke according to FIG. 30A,

FIG. 30C shows an enlarged illustration of the temporal signal curve in the suction stroke according to FIG. 30B,

FIG. 30D shows a detailed view of the temporal signal curve in the suction stroke according to FIG. 30A,

FIG. 30E shows an enlarged illustration of the temporal signal curve in the suction stroke according to FIG. 30D,

FIG. 31A shows Lissajous curves of different micropumps in the suction stroke and in the pressure stroke without external influencing factors.

FIG. 31B shows Lissajous curves of different micropumps in the suction stroke and in the pressure stroke under the impact of an external influencing factor in the form of a contact of the membrane element,

FIG. 32 shows a schematic block circuit diagram for illustrating a system structure according to an embodiment, and

FIG. 33 shows a schematic block circuit diagram for illustrating possible components of a signal evaluation device according to an embodiment.

### DETAILED DESCRIPTION OF THE INVENTION

In the following, embodiments are described in more detail with reference to the drawings, wherein elements with the same or similar function are provided with the same reference numerals.

Method steps illustrated or described in the context of the present disclosure may also be performed in any other order than the one that is illustrated or described herein. In addition, method steps relating to a specific feature of a device are exchangeable with said feature of the device, and vice versa.

In the context of the present disclosure, if reference is made to a fluid, this is to be understood as liquids, gases, or mixtures of liquids and gases.

Among other things, the present disclosure describes a membrane actuator with a membrane element and an actuator element. In the context of the present disclosure, if reference is made to a pump chamber pressure, this is to be understood as a pressure applied on a membrane side of the membrane element being in contact with the fluid. For example, such a pressure may also occur in valves comprising such a membrane actuator.

In the context of the present disclosure, if reference is made to a variable pressure or variable pump chamber pressure, this is to be understood as a time-variant and location-variable pressure. If not indicated otherwise, in the context of this disclosure, the term “variable pressure” is to be understood as a time-resolved average value of the time-variant and the location-variable pressure.

In the context of this disclosure, if reference is made to an external influencing factor, this may be understood to be at least one of the following factors:
environmental parameters (e.g. temperature, humidity),
rheological properties of the fluid,
disturbance variables (e.g. particles, air bubbles in liquids),
geometry or dimensions of the membrane actuator,
material parameters (e.g. Young modulus, piezo coefficient d31),
operating parameters (e.g. control signal).

In the context of this disclosure, if embodiments are described using the example of a piezo-actuated membrane actuator, the corresponding explanations also apply to an electrostatically operated membrane actuator, and vice versa.

In the context of this disclosure, if embodiments are described using the example of a micropump, the corresponding explanations also apply to microvalves, and vice versa.

If the nomenclature used herein should deviate, the following applies:

$$\\ d = {CE}^{{}_{} *}$$

$$\\ {I}_{d} = {I}_{CE} = {I}_{ce}$$

$$\\ {τ}_{h} = {τ}_{p}$$

$$\\ {I}_{A} = {I}_{a}$$

$$\\ {τ}_{A} = {τ}_{a}$$

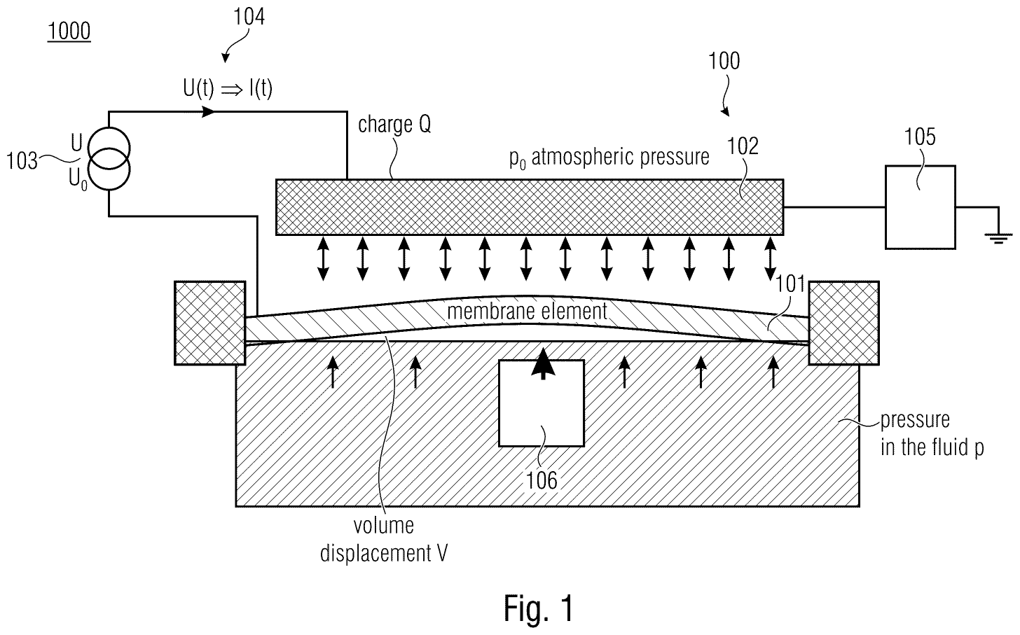

First, in a purely schematic way. FIG. 1 shows a section of an inventive microfluidic component 1000 with a membrane actuator 100. The membrane actuator 100 comprises a membrane element 101 and an actuator element 102. The actuator element 102 is used to deflect the membrane element 101.

In addition, the inventive microfluidic component 1000 comprises a signal generation device 103. The same is configured to generate an electric control signal 104 having a time-variant signal curve for controlling the membrane actuator 100, by which the actuator element 102 actuates the membrane element 101. In this non-limiting example, the signal generation device 103 generates an alternating voltage signal U(t). Analogously, a corresponding quantity derived therefrom can be considered, such as a corresponding alternating current signal I(t).

Furthermore, the inventive microfluidic component 1000 comprises a signal processing device 105. The same is configured to determine, during operation of the microfluidic component 1000, an influence on the temporal signal curve of the control signal 104 caused by one or more external influencing factors, and to identify and/or to classify, based on this influence on the temporal signal curve, at least one causal external influencing factor.

Thus, this external influencing factor leads to an influence on the temporal signal curve of the control signal 104. In this case, different external influencing factors lead to different deviations in the temporal signal curve of the control signal 104. Some influencing factors generate a characteristic deviation in the temporal signal curve, comparable to a fingerprint, i.e. different external influencing factors leave different fingerprints in the temporal signal curve of the control signal 104.

Some examples for external influencing factors and their detection or identification are given in the following. In addition, what follows is a specific description as to how the deviation in the temporal signal curve of the control signal 104 is determined. In anticipation, it is to be noted at this point that a signal analysis of the control signal 104 may be performed according to the invention, considering different signal portions. In the context of this disclosure, these signal portions are also referred to as “current terms.” These individual current terms are based on different external influencing factors that may be identified and/or classified by means of the inventive concept.

However, before going into detail, an overview of the physical processes at different membrane actuators 100, e.g. at piezo-actuated or electrostatically actuated membrane actuators 100, will be given so as to develop a better understanding of the concept of the signal analysis of the control signal 104 described herein. To this end, reference is again made to FIG. 1.

FIG. 1 shows that the actuator element 102 functionally interacts with the membrane element 101, i.e. the membrane element 101 can be deflected by the actuator element 102. This causes a volume displacement V below the membrane element 101. The actuator element 102 and the membrane element 101 are electrically controlled by means of the signal generation device 103. For example, a drive voltage U may be applied to the actuator element 102, while the member element 101 may be contacted with a ground potential U₀. In this case, electric charges Q flow onto the actuator element 103.

The membrane element 101 in combination with the drive element 102 essentially has the properties of a variable electric capacitance. In the case of liquids, hydraulic forces act on the membrane element 101, or, in the case of gases, pneumatic forces act on the same, in the form of a pressure p. Furthermore, mechanical forces, e.g. caused by mechanical components 106, may act on the membrane element 101. In addition, surface forces may act on the membrane element 101, e.g. in the form of a meniscus. A reference pressure p₀, which is often the atmospheric pressure, or a pressure set above the membrane element 101 acts above the actuator element 102.

A fluid, e.g. a gas or a liquid, below the membrane element 101 is pressurized with a pressure p. This pressure p is time-dependent and is determined from the interaction between the membrane actuator 100 and the fluid. In changes of state, which are slow compared to signal propagations in the membrane element 101 and in the fluid (determined by the speed of sound), the pressure or the pressure distribution adapts itself so that the membrane element 101 is in an equilibrium of forces (action=reaction).

However, if this pressure p applied below the membrane element 101 differs from the reference pressure p₀ above the membrane element 101, a pneumatic (in the case of gases as a fluid) or a hydraulic (in the case of a liquid as a fluid) force is applied to the membrane element 101 via the membrane surface. Here, neither the fluid pressure p below the membrane element 101 nor the reference pressure p₀ above the membrane element 101 have to be constant and homogeneous.

Thus, there may be pneumatically caused or hydraulically caused interrelationships with the membrane actuator 101, i.e. there are pneumatic or hydraulic external influencing factors that act on the membrane actuator 100. If, as described above, a mechanical component 106 applies a mechanical force on the membrane actuator 100, mechanical external influencing factors act on the membrane actuator 100 accordingly.

According to an embodiment of the invention, the signal processing device 105 may accordingly be configured to identify and/or classify a hydraulic, pneumatic, or mechanical force acting on at least one membrane side of the membrane element 101 as the external influencing factor that causes the effect on the temporal signal curve.

In some embodiments, the actuator element 102 may comprise a piezoceramic, which will be described later on in more detail. In this case, piezoelectrical external influencing factors may act on the membrane actuator 100 as well.

In this case, according to the invention, the signal processing device 105 may be configured to identify and/or classify a piezoelectrical force acting on at least one membrane side of the membrane element 101 as the external influencing factor that causes the effect on the temporal signal curve.

In all cases, according to the invention, a time-dependent measurement of the, possibly, overlapping pneumatic, hydraulic, piezoelectrical or mechanical interrelationships may be carried out by means of a temporally precise electrical measurement of the control signal 104 (e.g. the voltage signal U(t) or a quantity associated therewith, such as the current signal I(t)). That is, with the invention described herein, it is possible to detect different external influencing factors, such as pneumatic, hydraulic, piezoelectrical, and/or mechanical external influencing factors, acting on the membrane actuator 100, by means of a signal analysis of the control signal 104. In addition, the influencing factors detected can be identified and/or classified.

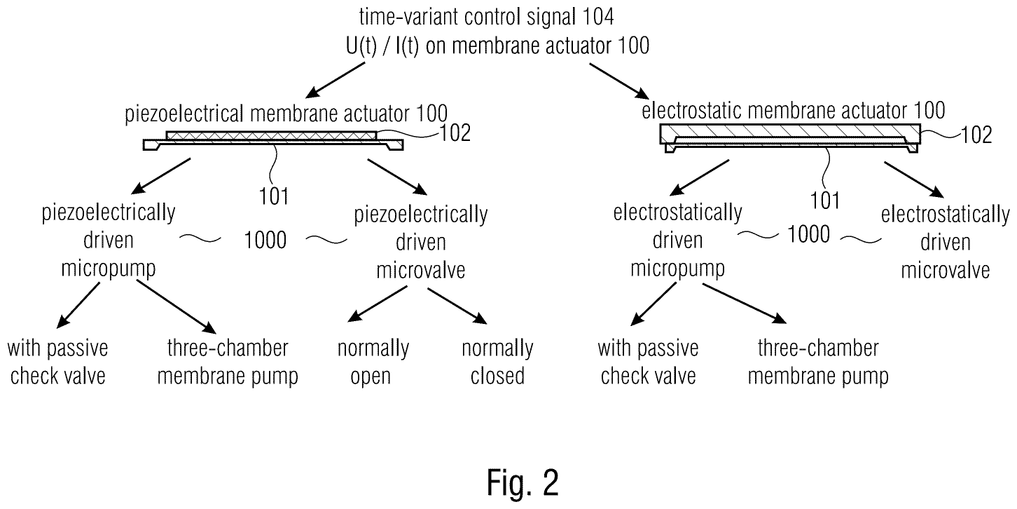

Depending on the embodiment of the membrane actuator 100, the detectable or identifiable external influencing factors may be slightly different. FIG. 2 shows possible conceivable embodiments of an inventive membrane actuator 100.

The left side of FIG. 2 shows a piezoelectrical membrane actuator 100. In this case, the actuator element 102 may comprise a piezoceramic or a piezo element that is fixed to the membrane element 101, e.g. by means of a suitable adhesive. As soon as the control signal 104 is applied to the piezoceramic, the piezoceramic is deformed and actuates the membrane element 101.

For example, an inventive piezoelectric membrane actuator 100 may be used in a piezoelectrically driven micropump. That is, in this case, the inventive microfluidic component 1000 would comprise a piezoelectrically driven micropump. In this case, the piezoelectrical membrane actuator 100 is used as a pump element, i.e. lifting and lowering the membrane actuator 100, a pump stroke, i.e. a suction stroke and a pressure stroke, may be carried out. In this case, the piezoelectrically driven micropump can be configured as a three-chamber membrane pump with active valves or may comprise passive check valves.

Alternatively, e.g., the inventive piezoelectrical membrane actuator 100 may be used in a piezoelectrically driven microvalve. That is, in this case, the inventive microfluidic component 100 would comprise a piezoelectrically driven microvalve. In this case, the piezoelectrical membrane actuator 100 is used as a means for actuation, i.e. the microvalve may be opened or closed by lifting and lowering the membrane actuator 100. The piezoelectrically driven microvalve may be configured as an NO valve (NO=normally open) or as an NC valve (NC=normally closed).

The right side of FIG. 2 illustrates an electrostatically actuated membrane actuator 100. In this case, the membrane element 101 forms a moveable electrode, and the actuator element 102 forms a counter electrode. In this case, the actuator element 102 and the membrane element 101 interact capacitively, which will be described in more detail in the following. As soon as the control signal 104 is applied to the actuator element 101 (counter electrode), it attracts the membrane element 101 (electrode) or pushes it away, generating an up/down movement of the membrane element 101.

For example, an inventive electrostatic membrane actuator 100 may be used in an electrostatically drive micropump. That is, in this case, the inventive microfluidic component 1000 would comprise an electrostatically driven micropump. In this case, the electrostatic membrane actuator 100 is used as a pump element, i.e. by lifting and lowering the membrane actuator 100, a pumping stroke, that is a suction strobe and a pressure strobe, respectively, may be carried out. Here, the electrostatically drive micropump may also be configured as a three-chamber membrane pump with active valves, or may comprise passive check valves.

Alternatively, e.g., the inventive electrostatic membrane actuator 100 may be used in an electrostatically driven microvalve. That is, in this case, the inventive microfluidic component 1000 would comprise an electrostatically driven microvalve. In this case, the electrostatic membrane actuator 100 is used as a means for actuation, i.e. the microvalve can be opened or closed by lifting or lowering membrane actuator 100, respectively. The electrostatically driven microvalve may be configured as a NO valve (NO=normally open) or a NC valve (NC=normally closed).

As initially mentioned, the inventive concept provides a measurement and/or signal evaluation of the control signal 104, enabling to determine one or more external influencing factors that act on the membrane actuator 100, or the microfluidic component 1000. In the following, this will be described in more detail exemplarily using the above-described conceivable embodiments of an inventive piezoelectrically or electrostatically driven membrane actuator 100.

### 1. Piezoelectrically Driven Membrane Actuator

### 1.1 Piezoelectrically Driven Micropump

Piezoelectrically driven micropumps 1000 are usually controlled with a periodic control signal 104, e.g. with a sinusoidal alternating voltage or alternating current signal. In this case, the membrane actuator 100 alternates between moving upwards (suction stroke) and downwards (pressure stroke).

The control signal 104 is not independent on how the membrane actuator 100 interacts with its environment. The respective external influencing factors (e.g. hydraulic, pneumatic, piezoelectric, mechanical) acting on the membrane actuator 100 change the mechanical properties of the membrane actuator 100 (e.g. its voltage state or its position), by which the electrical parameters of the membrane actuator 100 change as well. In turn, this directly affects the current flow. Since the external influencing factors vary temporally, the interaction process, or the respectively prevailing external influencing factor, can be inferred by means of an inventive signal analysis of the control signal 104.

Thus, e.g., a pressure change underneath the piezo membrane actuator 100 leads to an action of force that in turn leads to a current flow in the piezo membrane actuator 100 due to the direct piezo effect, which is solely caused by the pressure change. In the present disclosure, this current flow is also referred to as a “sensor current.” This sensor current overlaps the current required to electrically charge the capacitive load.

In the case of a piezoelectrically driven micropump 1000, this sensor current may be determined precisely by means of an inventive signal analysis and may be distinguished from other current portions (above all, from the charge current I_{C} of the electrical capacitance of the piezo element). Through this, e.g., a change of the pump chamber pressure may be measured temporally and indirectly. The temporal change of the pump chamber pressure is determined by the fluidic processes in the fluidic chamber, among other things. However, if the interrelationships as to why the pump chamber pressure changes temporally are known, the processes in the pump chamber may be measured with the inventive signal analysis of the sensor current. However, even in case of interrelationships that are not fully known in detail, the fluidic or mechanical processes in the pump chamber may be inferred, e.g., by using so-called “machine learning.”

At this point, it is explicitly highlighted again that no additional sensor technology or additional electrodes are required with the inventive concept. In addition, the membrane actuator 100 does not have to be controlled in a special way, e.g. in a special calibration mode. It suffices to control the same in a regular way by means of the control signal 104, i.e. the inventive concept can be performed during regular operation of the microfluidic component 1000. The time-dependent fluidic and mechanical processes in the microfluidic component 1000 can be measured solely by means of a precise measurement or signal analysis of the control signal 104 (e.g. charging current I(t)) onto the membrane actuator 100, which is required anyway for operating the membrane actuator 100. This makes the inventive concept described herein very advantageous since components of the microfluidic components 1000 themselves do not have to be changed. It suffices to integrate the inventive signal analysis into the driver electronics of the microfluidic component 1000, e.g. in connection with a suitable means for data capturing and data evaluation.

As initially mentioned, since piezoelectrically driven micropumps are usually controlled with a periodic signal, the inventive concept additionally enables continuous, time-resolved measurements of the suction stroke and the pressure stroke during operation of the micropump. If changes of the sensor current are measured compared to previous signal curves, it is possible to immediately infer a change in the operation. That is, the micropump continuously and permanently monitors itself during operation, representing a significant improvement over conventional technology.

### 1.2 Piezoelectrically Driven Microvalve

Analogously, in case of a piezoelectrically driven microvalve 1000, there is an interrelationship between pneumatic and hydraulic forces and the intrinsic voltages of a membrane actuator 100. These time-dependent pressure changes may be measured using the sensor current (in the same way as in the piezoelectrically driven micropump), allowing fluidic information to be extracted from the valve chamber, or the valve movement. Additionally, there is the aspect that the driven membrane element 101 (possibly reinforced in the center by means of a rod-like bulge) comes into mechanical contact with a valve seat when the valve closes. This mechanical contact and the blockage of the mechanical movement at an increasing drive voltage lead, through the piezo effect, to a time-dependent current flow that can be detected as a sensor current along the lines of a blocking counter pressure in a previously described micropump.

In this case, it is to be noted that, this contact occurs, if it is undamped (e.g. in case of gas valves), for a very short time in case of a hard-hard seal of the valve, which is associated with correspondingly high stresses and which therefore leads to large and short transient signals in the sensor current. If the valve movement is damped more strongly (e.g. in case of liquids), the stress peaks are smaller, and the sensor current signal is also smaller and more distributed in time. This interrelationship can be derived directly or it may be trained by means of machine learning methods.

In principle, the inventive concept can be used to not only detect closure of a valve, but also which medium (e.g., air or liquid) is located in the valve chamber. In addition, a temporal assignment of the closure time with respect to the actuation cycle can be used to make a statement about its change, and, e.g., degradation of the actuator bias, swelling of a soft value seal, or changes of environmental parameters, such as a pressure above the membrane element or a temperature, can be detected. In addition, overdriving the membrane actuator 100 and therefore an excessive mechanical stress of the piezo-actuated membrane actuator 100 may be avoided when the valve is operated to this detectable contact point only.

The following table 1 shows an overview of the external influencing factors that may act on active piezo-actuated microvalves and that may be identified and/or classified by means of the inventive concept.

TABLE 1

| Operational parameter | |
|---|---|
| (function/state) | External influencing factor (mechanism of action) |
| State detection in switching | Change of states, in particular contact and release of the sealing |
| valves (open/closed) | element are monitored |
| Differentiation of media, e.g. | Damping behavior when opening or closing provides statement |
| for detection of bubbles or | about viscosity of the medium, since the hydraulic pressure acts on |
| condensates, detection of | the actuator when displacing the medium |
| natural aspiration or erroneous | |
| aspiration in dosing systems | |
| Detection of anomalies, e.g. | Additional forces act on the actuator (sticking) or obstruct the |
| particle blocks valve seat or | mechanical movement (particles). This results in temporally |
| sticking obstructs opening | distinguishable charge and discharge curves |
| Fracture and failure detection | Extreme case of the detection of anomalies |
| Adaptive closed-loop control - | By detecting the contact point in the temporal dimension, a |
| prevention of overdrive | statement can be made about the required closing voltage. The |
| | control of each actuation of the actuator can therefore be reduced |
| | to the closure voltage instead of the commonly used maximum |
| | field strength of 2-3 kV/mm. This avoids bending stress above the |
| | valve seat, which could lead to a critical fracture or the sub-critical |
| | crack growth in the ceramics, in the worst case. |
| Detection of actuator | If a decreasing trend in the required closure voltage can be |
| degradation | detected, this may be due to actuator fatigue, e.g., by reduction of |
| | the coefficient d31 or by degradation of the adhesive layer |
| Detection of changes of | Changes of i. the pressure above the membrane, ii. the pressure at |
| environmental parameters | the inlet of the valve, iii. the pressure at the outlet of the valve, iv. |
| | the temperature lead to a change of the balance of the actuator |
| | deflection without electric voltage applied and therefore to a |
| | change of the closing time/closing voltage upon actuation |
| Detection in the behaviour of | Soft elements can swell up when in contact with water or can lose |
| sealing elements | their elastic properties during operation. Both can be distinguished |
| | in principle by transient monitoring of the charging current by the |
| | temporal and absolute changes of the counterforces. The former |
| | changes the closing time, the latter changes the closing dynamics, |
| | i.e. a soft contact becomes hard contact. |

### 2. Electrostatically Driven Membrane Actuator

### 2.1 Electrostatically Driven Micropump

In the case of an electrostatically driven membrane actuator 100 (FIG. 2—right side), in comparison to a piezoelectric drive, there is not electro-mechanical coupling in the sense that a pressure change in the actuator element 102 itself leads to an additional current flow.

However, there is an analog dependency of the current flow onto the membrane actuator 100, which depends on the mechanical and fluidic response.

To begin with, this electrical capacitance C depends on the mechanical position of the membrane actuator 100. For example, let us assume that the membrane element 101 is relaxed and flat at the beginning of a suction stroke, wherein it would comprise an initial capacitance Cₒ. If a control signal (e.g. a voltage U) is applied quickly, e.g., with a time constant τ=R·C₀, with C₀=100 pF=1e-10 F and R=10 kOhm, then τ=1 ρs. In this short period of time, it is assumed that the membrane actuator 100 does not yet move due to inertia and friction of the materials involved (membrane, fluids).

Now, if the membrane 101 moves due to the interrelationship of the electrostatic attractive forces at the applied voltage U₀ with the pump chamber pressure p in the direction of the counter electrode (actuator element 102), the capacitance increases. This results in an additional current flow onto the counter electrode (actuator element 102), which is purely correlated with the movement of the membrane element 101, which in turn also depends on the pump chamber pressure p.

The fundamental movement of the membrane element 101 of an electrostatically driven micropump and the interaction with the pump chamber pressure p in the suction stroke (i.e. after applying the control signal) takes place as follows. To begin with, restoring Hook forces act opposite the deflecting forces, wherein the deflecting forces of the membrane element 101 increase in a non-linear way due to the change of capacitance. If the membrane element is deflected to approximately ⅓ in the direction of the counter electrode 102, the membrane element 102 “snaps,” which causes the membrane element 102 to move very quickly in the direction of the counter electrodes 102.

This membrane movement is stopped when the membrane element 102 contacts the counter electrode 102, first there is contact in the center of the membrane, then the membrane element 101 nestles at the counter electrode 102. After contacting and nestling, the capacitance increase slows down. The counter electrode 102 generates strong intrinsic counter forces until the membrane element 101 finally reaches a balance of forces and comes to a standstill.

During this entire movement of the membrane element 101, the capacitance C(t) at the applied voltage U₀ increases, leading to a corresponding current flow. If this current flow is measured by the inventive signal processing device 105 in a time-resolved manner, the time-resolved position of the membrane element 101 can be inferred directly (in case the relationship between the position and the capacitance is known).

Since, in contrast to the piezoelectric drive, this “sensor current” is dominant in the electrostatic drive, the signal generation device 103 and the signal processing device 105 are faced with much lower requirements.

Furthermore, it makes a difference whether the pump chamber contains air or liquid. In the first case, the membrane element may move more quickly since air has a significantly lower mass than water.

This allows detecting whether the electrostatically driven micropump contains air or liquid. That is, the aggregate state of the fluid located in the microfluidic component (micropump) 1000 can be detected.

In the suction stroke, the control signal 104, e.g. the electric voltage, is switched off, it is shorted, U=0 V, so to speak. The charges dissipate with a very quick (electric) time constant, a voltage is no longer applied after this time. In case of an abrupt voltage change, this time constant τ_{D0} depends on the electrical capacitance at the start of the pressure stroke C_{D0} with the charge resistance R: τ_{D0}=R·C_{D0}, and is in the range of microseconds. In this short period of time, liquid cannot yet flow through the valve.

In the subsequent movement of the membrane element 101, the capacitance changes, however, there is also no longer a current flow (due to U=0 V) when the membrane element 101 moves in the pressure stroke, and the movement can also no longer be measured with the sensor current, accordingly.

Alternatively, it would be possible to not fully switch off the voltage in the pressure stroke, but to lower it to a small value U₁, e-g. U₁=0.01 U₀ or even less. With this, almost the entire stroke would still be available, but there would still be charges available after switching off the membrane actuator 100, and therefore there would be a remaining current flow due to the movement of the membrane actuator 100.

The membrane element 101 is released from the counter electrode 102 and returns to its initial state. During this movement, the capacitance decreases, leading to an opposite current flow.

### 2.2 Electrostatically Driven Microvalve

Along the lines of the above-described piezo-actuated microvalve, movement of the membrane actuator 100 and contact with the valve seat can also be detected during closure of an electrostatically driven microvalve. For more detailed explanations, reference is made to 1.2.

In summary, it is to be noted that embodiments may provide a piezo-actuated membrane actuator 100 or an electrostatically actuated membrane actuator 100. The piezo-actuated membrane actuator 100 may be used in a piezo-actuated microfluidic component 1000, e.g. a piezo-actuated microfluidic pump or a piezo-actuated microfluidic valve. The electrostatically actuated membrane actuator 1000 may be used in an electrostatically actuated microfluidic component 1000, such as an electrostatically actuated microfluidic pump or an electrostatically actuated microfluidic valve.

In all these embodiments, e.g., the signal processing device 104 may be configured to determine the type of the fluid used in the microfluidic component 1000 on the basis of the temporal signal curve of the control signal 104. Alternatively or additionally, the signal processing device 105 may be configured to carry out a differentiation of the aggregate state of the fluid on the basis of the temporal signal curve of the control signal 104, i.e. it may differentiate whether the fluid is gaseous or liquid. Depending on the type of fluid, or depending on the aggregate state of the fluid, the mechanical properties of the membrane actuator 100 may change, i.e. the type of fluid and/or its aggregate state may be described as an external influencing factor that may be identified and/or classified by means of the inventive concept.

In embodiments in which the microfluidic component 1000 comprises a microfluidic pump with a pump chamber, wherein at least one membrane side of the membrane element 101 is in contact with a fluid located in the pump chamber, a variable pump chamber pressure is generated in the pump chamber by actuating the membrane actuator 100. In such embodiments, the signal processing device 105 may be configured to determine the variable pump chamber pressure on the basis of the temporal signal curve of the control signal 104 and use this to identify and/or classify the external influencing factor. That is, the pump chamber pressure causes a signal portion that leads to a temporal deviation of the control signal 104. In turn, the pump chamber pressure varies characteristically with the presence of external influencing factors. Thus, a deviation of the pump chamber pressure leads to a change of the temporal signal curve of the control signal 104, by which, in turn, the external influencing factor that causes the same can be determined. In summary, this means that an external influencing factor changes the pump chamber pressure and, in turn, the pump chamber pressure causes a change in the temporal signal curve of the control signal 104, by which the external influencing factor can be determined. This means that the external influencing factor can be determined on the basis of a deviation in the pump chamber pressure. In the following, this will be described in detail on the basis of specific examples.

In embodiments in which the microfluidic component 1000 comprises a microfluidic valve that enables opening or closing a fluid path, the signal processing device 105 may be configured to identify and/or classify the external influencing factor on the basis of the temporal signal curve of the control signal 104 and to use this to determine a time-variant operational parameter of the microfluidic valve.

At this point, it is again to be noted that the external influencing factor is an external influencing factor that causes the deviation in the temporal signal curve of the control signal 104.

Merely as an example, the first three lines of table 1 will be explained to this end.

Line 1: A change of state of the valve, e.g. contact or release of the sealing element, leads to a characteristic change in the temporal signal curve of the control signal 104. This change in the temporal signal curve allows determining a corresponding operational parameter, e.g. valve is open/closed.

Line 2: Depending on the viscosity of the fluid used, the damping behavior changes when opening or closing the valve, leading to a characteristic change in the temporal signal curve of the control signal 104. This change in the temporal signal curve allows determining a corresponding operational parameter, e.g. presence of bubbles or condensate, natural aspiration, or erroneous aspiration.

Line 3: For example, when opening the valve, additional forces may act on the actuator (so-called sticking), or the mechanical movement of the valve may be obstructed by additional forces, e.g. if a particle prevents fully closing the valve. This results in temporally distinguishable charge and discharge curves, i.e. in a characteristic change of the temporal signal curve of the control signal 104. This change in the temporal signal curve allows determining a corresponding operational parameter, e.g. a particle blocks a valve seat, or sticking obstructs opening.

### 3. Measuring the Sensor Current

In the following, the inventive concept will be described using the example of a piezo-actuated membrane actuator 100. With reference to the above explanations, however, the example described herein analogously applies to electrostatically actuated membrane actuators 100 as well.

To begin with, it is a challenge to measure the current flow to, or from, the piezoceramic (actuator element) 102 without influencing the charge and discharge current. In addition, the measurement circuit (signal processing device) 105 should have a high signal quality so as to measure the low currents without any errors. It has to be possible to realize the entire circuit concept as space-efficiently and cost-efficiently as possible.

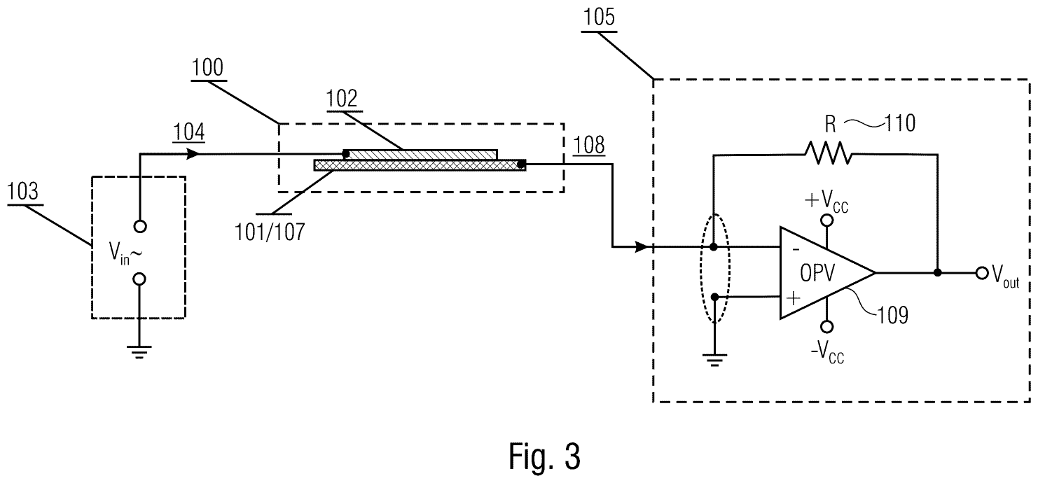

FIG. 3 shows a schematic view of an embodiment with a signal processing device 105 configured to determine the temporal progress of the control signal 104.

To begin with, FIG. 3 shows the above-described piezoelectrically (or electrostatically) driven membrane actuator 100. In the case of a piezo-actuated membrane actuator 100, the actuator element 102 may be a piezoceramic. The actuator element 102 may be arranged on a carrier substrate 107. In some embodiments, the membrane element 101 may be configured as the carrier substrate on which the actuator element 102 is arranged. For example, the carrier substrate 107, or the membrane element 101, and the actuator element 102 may be connected by means of adhesive joining techniques.

A control electrode is located on the top side of the actuator element 102, and, a ground electrode electrically shorted by a point contact with the carrier substrate 107, or the membrane element 101, is located on the bottom side.

The actuator element 102 is connected to the signal generation device (control electronics) 103. The signal generation device 103 generates the control signal 104. The carrier substrate 107, or the membrane element 101, is connected to the signal processing device (measurement circuit) 105 configured to detect the combined charge flow 108 dissipating from the carrier substrate 107, or the membrane element 101.

In the present embodiment, the signal generation device 103 comprises a voltage source that generates the control signal 104 in the form of an alternating voltage signal. Alternatively, the signal generation device 103 may comprise a current source that generates the control signal 104 in the form of an alternating current signal.

The output of the supply voltage Vᵢₙ of the voltage source 103 is connected to the control electrode of the piezoceramic 102. The ground output of the voltage source 103 is connected to the ground of the measurement circuit 105. The ground electrode of the piezoceramic 102 (or the conductive surface of the carrier substrate 107) is connected to the inverting input of an operational amplifier 109. The non-inverting input is connected to the ground potential of the signal generation device 103. The circuit illustrated here generates a virtual ground potential at the inverting input of the operational amplifier 109. The control signal 104, i.e. the current flow I into the piezoceramic 102, can be determined by the measuring resistor 110. This current flow I comprises at least two signal portions, i.e. the charge current I_{C} and the sensor current I_{S}, wherein the following applies: I_{C}+I_{S}=I=U/R.

By using a voltage-controlled operational amplifier 109, the entire current flow I to or from the capacitive element (membrane actuator) 100 may be measured without putting a load on the current source (signal generation device) 103 through the measurement circuit (signal processing device) 105. This results in Uk=−R*I for the terminal voltage Uk or Vₒᵤₜ at the output of the measurement circuit 105.

For a high-resolution measurement of the sensor current I_{S} and the charge current I_{C} illustrated in FIG. 3, a correspondingly high amplification is used. However, in case of high currents, above all when using rectangular signals, this leads to an overdrive of the measurement circuit 105. For this reason, two proposed solutions (active and passive) are presented in a following so as to ensure the quality and reliability of the measurement circuit (signal processing device) 105.

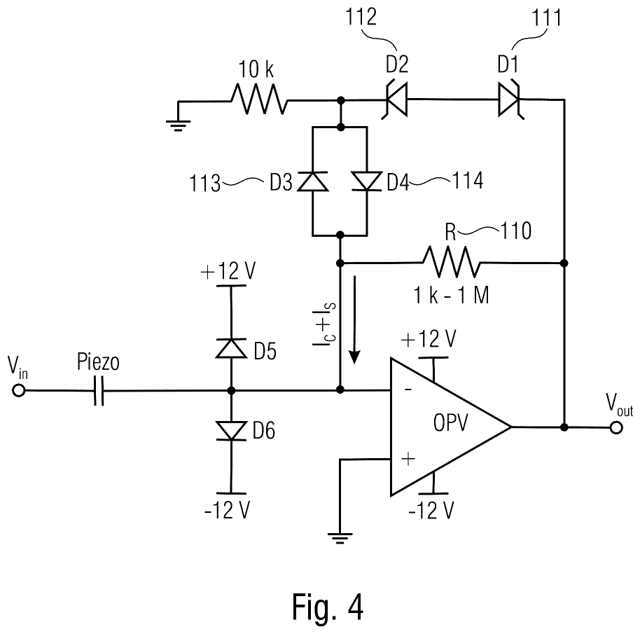

For the active solution, the measurement circuit 105 may be extended by a digital potentiometer. Thus, depending on the application and the control signal 104, the amplification of the measurement circuit 105 can be adjusted ideally. Additionally, the variable amplification is used so as to, depending on the application, amplify characteristic signal portions. When using a correspondingly quick logic circuit, the large charge current I_{C} and the small sensor current I_{S} can be measured. Alternatively, FIG. 4 shows a passive solution that may use a constant resistance and a diode network. The maximum current is limited via two Zener diodes 111, 112. The leakage current via the Zener diodes 111, 112 is reduced by additional low leakage diodes 113, 114, resulting in an increase of the signal quality. The maximum of the terminal voltage Uk is determined by the Zener voltage U_{Z} and the forward voltages of the low leakage diodes UF,D and the Zener diode UF,ZD: Uk<UZ+UF, ZD+UF, D=4.3 V+0.7 V+0.5 V=5.5 V. Among other things, the advantage of the passive solution is that it is very compact, reliable, simple, and easy to integrate into an ASIC.

Furthermore, the signal processing device 105 may comprise a measuring resistor 110 connected between the inverting input and the output of the operational amplifier 109. The control signal 104 then drops across this measuring resistor 110 and the signal processing device 105 processes the same.

The control signal 104 comprises a temporal signal curve that differs depending on whether external influencing factors are acting on the microfluidic element 1000. In addition, the temporal signal curve of the control signal 104 differs depending on the prevailing external influencing factors. That is, if there are no external influencing factors, the control signal 104 comprises a first temporal signal curve. However, if there are one or more external influencing factors, the control signal 104 is influenced by them, and the influenced control signal 104 comprises a different second temporal signal curve.

In embodiments of the invention, the signal processing device 105 is accordingly configured to differentiate a first temporal signal curve of the control signal 104 corresponding to an actuation of the membrane actuator 100 without external influence from a different second temporal signal curve of the control signal 104 corresponding to an actuation of the membrane actuator 100 under the effect of at least one external influencing factor.

### 4. Qualitative Consideration of the External Influencing Factors and the Corresponding Interrelationships of the Piezoelectric Membrane Actuator

The following section develops a model as to how the sensor current I_{S} represents the fluidic interrelationships of a piezoelectrically driven micropump 1000. This model is subject to simplifications, e.g.:
disregard of hysteresis
disregard of piezo creep
assumption of linear valve characteristic curves
separation and superposition of fluidic and electric models
linearization of change of state of the gas bubble
description of elastomechanics with simplifications of the Kirchhoff plate theory

Due to these simplifications, this model cannot represent the entire reality precisely in the sense of a “White Box” model (cf. Section 7.1—White Box). However, significant interrelationships are explained, which significantly simplifies the understanding of the present invention. In some cases of disturbance detection, “machine learning” with neural networks can be used (cf. Section 7.2—Black Box), wherein the subsequently described model may significantly simplify machine learning (cf. Section 7.3—Grey Box). By using the subsequently described model, machine learning training may be fully omitted as well in other cases.

### 4.1 Electromechanical Coupling of the Membrane Actuator

The subsequent sections are again exemplarily described on the basis of a piezo-actuated membrane actuator 100, wherein all explanations can obviously also be applied to an electrostatically driven membrane actuator 100.

First, electromechanical coupling (in the small signal) may be described by the following linear approximation:

$$Q ( p , U ) = {C}_{e l} ( U - {U}_{0} ) + {C}_{E}^{*} ( p - {p}_{0} ) \qquad [ Equation 1 a ]$$

Q: Electric charge onto the piezoceramic, U voltage at the piezoceramic, C*_{E} coupling factor, p pressure on the membrane actuator. The coupling factor C*_{E} describes the change of the electric charge when the pressure difference changes. Cₑₗ represents the electric capacitance of the piezoceramic.

That is, the electric charge Q flowing onto the membrane actuator 100 depends on the temporally variable control signal 104 (voltage U) as well as on the temporally variable pressure p (FIG. 1) underneath the membrane element 101. The electric charge Q comprises a first term Cₑₗ·(U−U₀) linked to the electrical capacitance Cₑₗ and the potential difference (U−U₀) of the of the time-variant electric voltage U. In addition, the electric charge Q comprises a second term C_{E}*(p−p₀) linked to the piezo coupling factor C_{E}* and the time-variant and/or location-variable pressure p, or the pressure difference (p−p₀) between the bottom side and the top side of the membrane element 101. Equation [1a] describes the direct piezo effect of the membrane transducer, or the membrane actuator 100.

The corresponding “twin equation” may be formulated as follows: the piezo membrane transducer 100 carries out a volume displacement V when there is a change of the pressure difference (p−p₀) or of the potential difference (U−U₀) (or of both). This volume displacement V may be calculated as follows:

$$V = {C}_{p} ( p - {p}_{0} ) + {C}_{E}^{*} ( U - {U}_{0} ) \qquad [ Equation 1 b ]$$

The coefficient Cₚ represents the “fluidic capacity” of the membrane transducer, i.e. how much does the displaced volume change when the pressure difference between the membrane top and bottom sides changes. The coupling factor C_{E}* describes how much the displaced volume changes when the electric potential difference (U−U₀) changes.

It can be highlighted that the coupling factor C_{E}* from Equation [1b] is identical to the coupling factor C_{E}* according to equation [1a].

Under the model requirement of the Kirchhoff plate theory, an analytic solution that calculates the coefficients Cₚ, (fluidic capacity) and C_{E}* (coupling factor) for a round piezo membrane (e.g. PZT ceramic) and a round carrier membrane (e.g. metal or silicone) has been found (source https://www.sciencedirect.com/science/article/pii/S0924424710002311). Thus, the fluidic capacity Cₚ is determined analytically, it depends on the radius of the piezoceramic Rₚ, the thickness of the piezoceramic Tₚ, the radius of the carrier membrane R_{M}, the thickness of the carrier membrane T_{M}, and as the elasticity moduli and the Poisson numbers of the two materials (piezoceramic and carrier substrate). The exact expression for the (longer) analytic equations of Cₚ and C_{E}* can be found in the appendix of the dissertation of M. Herz, lead author of the above-cited publication.

The coupling factor C_{E}* is calculated analytically (in the same derivation), it depends (same as Cₚ) on the above-described parameters.

It is important to note that the coupling factor C_{E}* is additionally proportional to the piezoelectric charge constant d₃₁, which is usually indicated in data sheets of piezoceramic manufacturers.

To illustrate C_{E}*: the stroke volume ΔV of a micropump without any counter pressure (p=p₀) driven between the voltage level of a negative voltage U−(e.g. U−=−40 V, membrane is deflected “upwards”, i.e. away from the pump chamber bottom) and a positive voltage U+(e.g. U+=100 V, membrane is deflected downwards) is calculated from equation 1b as follows:

$$Δ V = {C}_{E}^{*} ( {U}_{-} - {U}_{+} ) \qquad [ Equation 1 c ]$$

This helps to illustrate the meaning of coefficient C_{E}*. The coefficient C_{E}* is negative since it is directly proportional to the coefficient d31, which in turn is negative for physical reasons (if an electric field is applied to the piezoceramic in the polarization direction (z-direction) by applying a voltage, the piezoceramic shrinks in the lateral direction). This is why the stroke volume is positive in Equation [1c].

The two coupling equations are symmetrical and illustrated in the following:

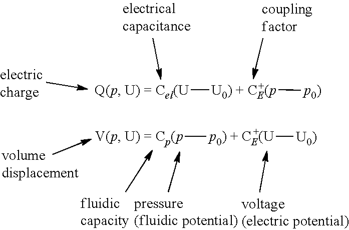

This assumes that the electric effect and the piezoelectric effect are added linearly. The current onto the piezo membrane actuator 100 results from the time derivative of [Equation 1]:

$$I = \frac{d Q}{d t} = {C}_{e l} \cdot \frac{d ( U - {U}_{0} )}{d t} + ( U - {U}_{0} ) \cdot \frac{d {C}_{e l}}{d t} + ( p - {p}_{0} ) \cdot \frac{d {C}_{E}^{*}}{d t} + {C}_{E}^{*} \cdot \frac{d ( p - {p}_{0} )}{d t} \qquad [ Equation 2 ]$$

This time derivative considers (with the chain rule) that the electric capacitance Cₑₗ and the coupling factor C_{E}* are not constants, but are time-dependent (due to the large signal behavior of the piezoceramic).

In case of microfluidic components 100, such as micropumps and microvalves, since controlling the piezoceramics regularly occurs at high electric voltages (or high electric field strengths; the field strength in the piezoceramic E corresponds to E=(U−U₀)/Tₚ, with the thickness of the piezoceramic Tₚ) in the large-signal operation, the electric capacitance Cₑₗ and the coupling factor C_{E}* are voltage-dependent. Since, during control, the electric voltage varies with time, the values of Cₑₗ and C_{E}* also vary according to the large-signal behavior of the piezo material. Again, it is to be noted that C_{E}* is proportional to the piezoelectric charge constant d₃₁, that C_{E}* increases in the large signal (at high voltages), and that C_{E}* is larger at high field strengths than at low field strengths approximately by the factor 1.5 (depending on the piezo material).

Assuming the ground potential U₀=constant; and the atmospheric pressure p₀=constant (within small time intervals), the following simplification results:

$$I = \frac{d Q}{d t} = {C}_{e l} \cdot \frac{d U}{d t} + ( U - {U}_{0} ) \cdot \frac{d {C}_{e l}}{d t} + ( p - {p}_{0} ) \cdot \frac{d {C}_{E}^{*}}{d t} + {C}_{E}^{*} \cdot \frac{d p}{d t} \qquad [ Equation 3 ]$$

In the present example, the current I represents the control signal 104. Since all four terms on the right side of [Equation 2] are time-dependent, there are four signal portions in total, which may also be referred to as “sensor currents” I_{U}, I_{C}, I_{ce}, Iₚ in the context of the present disclosure. Addition of these for sensor currents I_{U}, I_{C}, I_{ce}, Iₚ results in the total current I, i.e. the control signal 104 comprises four signal portions I_{U}, I_{C}, I_{ce}, Iₚ.

$$I = \frac{d Q}{d t} = {I}_{U} + {I}_{C} + {I}_{c e} + {I}_{p} = {C}_{e l} \cdot \frac{d U}{d t} + ( U - {U}_{0} ) \cdot \frac{d {C}_{e l}}{d t} + ( p - {p}_{0} ) \cdot \frac{d {C}_{E}^{*}}{d t} + {C}_{E}^{*} \cdot \frac{d p}{d t} \qquad [ Equation 4 ]$$

Each of these addends is linked to a temporal change of a specific physical quantity. Upon sudden rectangular disturbance, the electromechanical system is brought out of balance, and again reaches balance with typical time constants. More precisely, the following physical sub-systems have come out of balance, and now try to achieve balance again;
1) the free electric charges on the metallization of the piezoceramic (term Iᵤ)
2) the domain sizes change after the voltage change and strive to achieve a new state of balance (terms I_{c} and I_{ce})
3) the pump chamber pressure strives to achieve a new state of balance that is essentially caused by the flow of the medium through the valves (term Iₚ).

### 4.2. Compensation Processes Upon Sudden Application of a Voltage Change

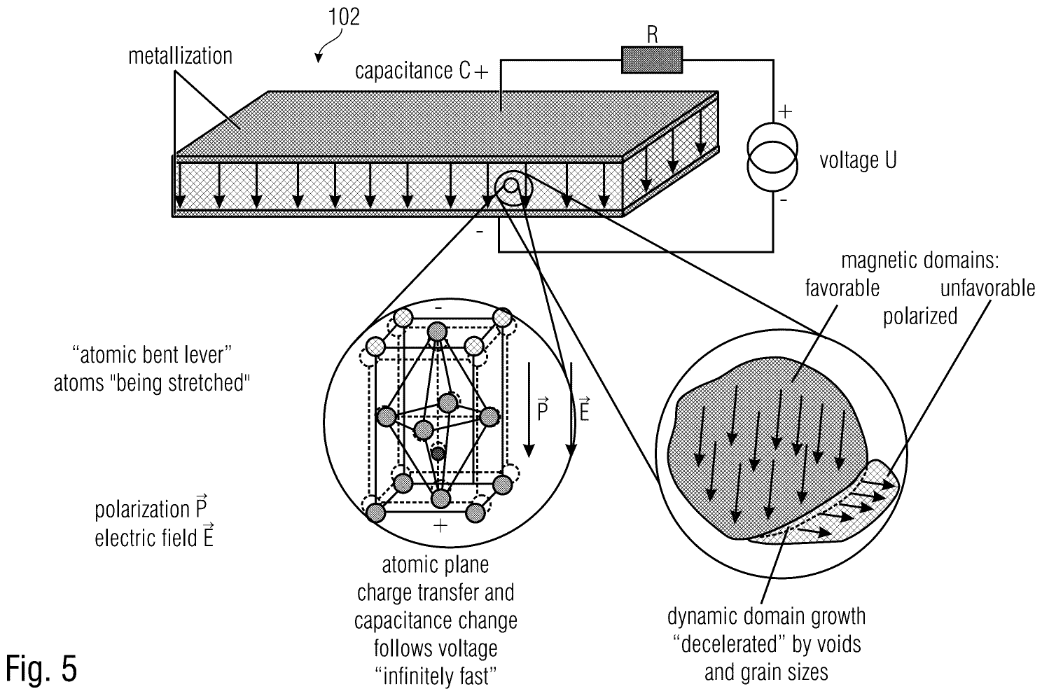

Upon a sudden voltage change, there are two essential effects (cf. FIG. 5):
1) The electrons flow to the capacitance C of the piezoceramic 102, by which
   a. the electrons flow onto the piezoceramic 102 which the time constant [symbol] =R*Cₑₗ, and
   b. the atoms “stretch infinitely fast,” and this stretch is then transmitted with the speed of sound. By the atoms stretching:
      i. the capacitance changes very quickly (this large signal capacitance is larger than the capacitance at small voltages. This is why more charges flow to the piezoceramic 102), and
      ii. the coefficient d₃₁ also increases (large signal behavior)

All changes under 1) should have decayed within [symbol] =R*Cₑₗ and should not lead to any further current flow onto the piezoceramic 102.
2) The increase of favorably located magnetic domains (Weiss regions) by domain growth, wherein these are decelerated by defects and grain boundaries. These changes take place on a significantly slower time scale □_{D}. Due to this domain growth, the volume that is polarized favorably increases. This effect, also referred to as piezo creep, represents approximately a few percent of the overall effect. This changes:
   a. the capacitance again, and
   b. the coefficient d₃₁ also becomes slightly larger.

From this consideration, it can be noted that the capacitance C as well as the coefficient d₃₁ (piezoelectrical lateral or transversal effect or d31 effect, wherein the mechanical force acts laterally to the applied field) initially change very quickly with the voltage U, and later on more slowly with the domain growth.

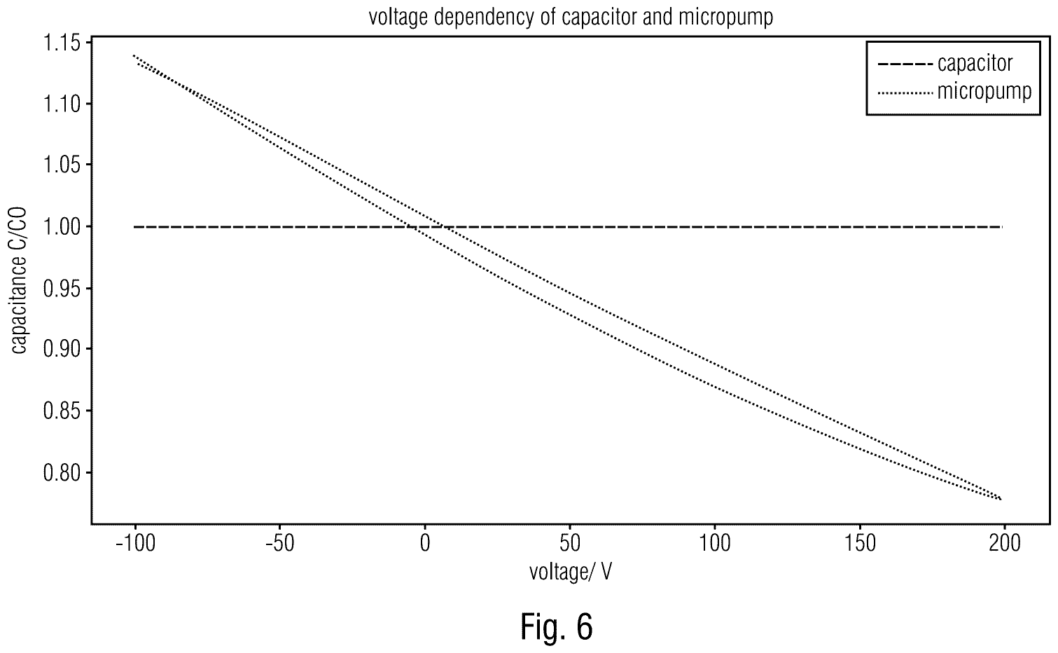

FIG. 6 shows an example for a measurement of the voltage-dependent electrical capacitance C(U) of the piezoceramic 102. The electrical capacitance in the large signal behavior (the typical voltage range for micropumps and microvalves) was measured as a function of the electric voltage applied. It can be seen that the capacitance is voltage-dependent, i.e.

$$\frac{d {C}_{e l}}{d U} \neq 0 .$$

Since the electric voltage is time-dependent, the term dCₑₗ/dU is also time-dependent. This is proof that the term

$${I}_{C} = U \frac{d {C}_{e l}}{d U} \neq 0$$

differs from zero. In addition, slight hysteresis of the capacitance can be determined.

In case of a sudden application of a voltage change, each of the above-mentioned physical sub-systems independently tries to achieve its respective state of balance, wherein this takes a different time, i.e. each physical sub-system decays with a specific time constant ┘┘ as follows:
1) the change of the voltage with time dU/dt occurs exponentially with the time constant [symbol] =R*Cₑₗ, with the charge resistance R
2) the change of the pressure with time dp/dt occurs for fluidic reasons. The associated current term or sensor current Iₚ can therefore be utilized to “look into” the pump chamber with a microscope, so to speak, with the typical stroke time □ₕ
3) the change of the capacitance dCₑₗ/dt is related to the piezo effect. ┘ᵣ and the capacitance of the piezoceramic 102 are that large, among other things, because there are so many dipoles within the piezoceramic 102 after the polarization has taken place. While the electrons and atoms of the piezo structure can follow a disturbance “infinitely fast”, so to speak, the propagation of the magnetic domains (Weiss regions) takes place on a much slower time scale ┘_{C}. From this so-called “piezo creep”, it is known that the time scale can reach into the range of seconds.
4) the change of the coupling constant dC_{E}*/dt is also related to the piezo effect. This effect is (at least partially) similar to 3):
   a. while the electrons and atoms of the piezoceramic 102 can follow a disturbance “infinitely fast”, the propagation of the magnetic domains (Weiss regions) takes place on a slower time scale □_{d}. This is very similar (or even identical) to □_{C}. From the “piezo creep”, it is known that this time scale can reach into the range of seconds.
   b. the coupling constant C_{E}* is proportional to the piezoelectrical coefficient d31, which depends on the large signal, i.e. in the case of high voltage amplitudes, the coefficient d31 is larger than in case of small voltages approximately by a factor of 1.5, which may in turn influence the derivation of C_{E}*.

With the above explanations, the compensation processes may then be described in [Equation 4] as follows:

$$I = \frac{d Q}{d t} = {I}_{U} + {I}_{C} + {I}_{c e} + {I}_{p} = {C}_{e l} \cdot \frac{d U}{d t} + ( U - {U}_{0} ) \frac{d {C}_{e l}}{d t} + ( p - {p}_{0} ) \cdot \frac{d {C}_{E}^{*}}{d t} + {C}_{E}^{*} \frac{d p}{d t} \qquad [ Equation 4 ]$$

1) The compensation process of the free charges:

$${I}_{U} = {C}_{e l} \cdot \frac{d U}{d t} = {I}_{U 0} {e}^{- \frac{t}{{τ}_{a}}} ; with {τ}_{a} = R \cdot {C}_{e l} \qquad [ Equation 5 ]$$

2) The compensation process of the pump chamber pressure (without squeeze film damping and with linearized valve characteristic curves)

$${I}_{p} = {C}_{E}^{*} \cdot \frac{d p}{d t} = {I}_{p 0} {e}^{- \frac{t}{{τ}_{h}}} ; with {τ}_{h} = {R}_{fluidic} * {C}_{fluidic} \qquad [ Equation 6 ]$$

The fluidic time constant τₕ is the product of the total fluidic flow resistance R_{fluidic} (definition of flow resistance R: ┘p=R*Q) and the fluidic capacity C_{fluidic} (definition of fluidic capacity C: ┘V=C*_p). The flow resistance R_{fluidic} may be approximated as a sum of the flow resistance of the pump chamber and the flow resistance of the opened valve and closed valve, while the fluidic capacity C_{fluidic} is formed by the sum of the fluidic capacity of the drive membrane Cₚ and the (optional) fluidic capacity of a gas bubble (C_{gas}): these fluidic resistances and fluidic capacities are not constant and change their values during the pump process. For example, the flow resistance of an open flap valve is much smaller at the beginning of the pump process when the valve is opened than at the end of the pump process when the valve is closed. Regardless, this compensation process may be approximated with [Equation 6].

The transient current curve of Ip measured by the inventive property of the “intrinsic sensor technology” of the microfluidic component 1000 described herein therefore gives direct insights into fluidic processes in the microfluidic component 1000, e.g. a micropump.
3) The compensation process of the domains
   a) with respect to the coupling factor C_{E}*

$${I}_{c e} = ( p - {p}_{0} ) \cdot \frac{d {C}_{E}^{*}}{d t} = {I}_{c e 0} {e}^{- \frac{t}{{τ}_{d}}} \qquad [ Equation 7 ]$$

b) with respect to the electrical capacitance Cₑₗ

$${I}_{C} = ( U - {U}_{0} ) \cdot \frac{d {C}_{e l}}{d t} = {I}_{C 0} {e}^{- \frac{t}{{τ}_{C}}} \qquad [ Equation 8 ]$$

The compensation process of the capacitance Cₑₗ and the coupling factor C_{E}* have the same physical causes, i.e. the growth of the domains. These two compensation processes therefore take place approximately with the same time constant:

$${τ}_{d} = {τ}_{C} = {τ}_{p i e z o} \qquad [ Equation 9 ]$$

Wherein the amplitudes I_{C0} and I_{d0} can differ. This results in the following
a) with respect to the coupling factor C_{E}*

$${I}_{c e} = ( p - {p}_{0} ) \cdot \frac{d {C}_{E}^{*}}{d t} = {I}_{c e 0} {e}^{- \frac{t}{{τ}_{P i e z o}}} \qquad [ Equation 10 ]$$

b) with respect to the electrical capacitance of the piezoceramic Cₑₗ

$${I}_{C} = ( U - {U}_{0} ) \cdot \frac{{dC}_{el}}{dt} = {I}_{C 0} {e}^{- \frac{t}{τ piezo}} \qquad [ Equation 11 ]$$

Thus, ultimately, the result for the approach for the total current I is:

$$I = \frac{dQ}{dt} = {I}_{U} + {I}_{p} + {I}_{C} + {I}_{ce} = {I}_{U 0} {e}^{- \frac{t}{{τ}_{a}}} + {I}_{p 0} {e}^{- \frac{t}{{τ}_{h}}} + ( {I}_{C 0} + {I}_{ce 0} ) {e}^{- \frac{t}{τ piezo}} \qquad [ Equation 12 ]$$

Thus, the result is a system with seven coefficients, i.e. four current amplitudes and three time constants. While the electric time constant is fast, the two fluidical time constants are slower. By fitting the coefficients, the electrical mechanical coupling may be fully captured during the pump operation.

In the interpretation of the sensor current, it is essential that these physical compensation processes after a disturbance (e.g. applying an electric voltage) independently strive to achieve the state of balance. This makes it possible to consider the current flow as a superposition of these effects according to [Equation 12] and to “fit the same”. Thus, information with respect to charging the capacitance, processes in the piezoceramic, and fluidic interactions may be determined through a single measurement process.

4.3 Electromechanical Coupling and Compensation Processes in the Control with a Harmonic Alternating Voltage Signal

If a sinusoidal alternating voltage signal is applied to a piezo-actuated membrane actuator 100, e.g. in a piezoelectrically driven micro membrane pump 1000, there is an overlap of the time constants, of the material effects described, and of the fluid-mechanical system response. This leads to a distortion of the current signal.

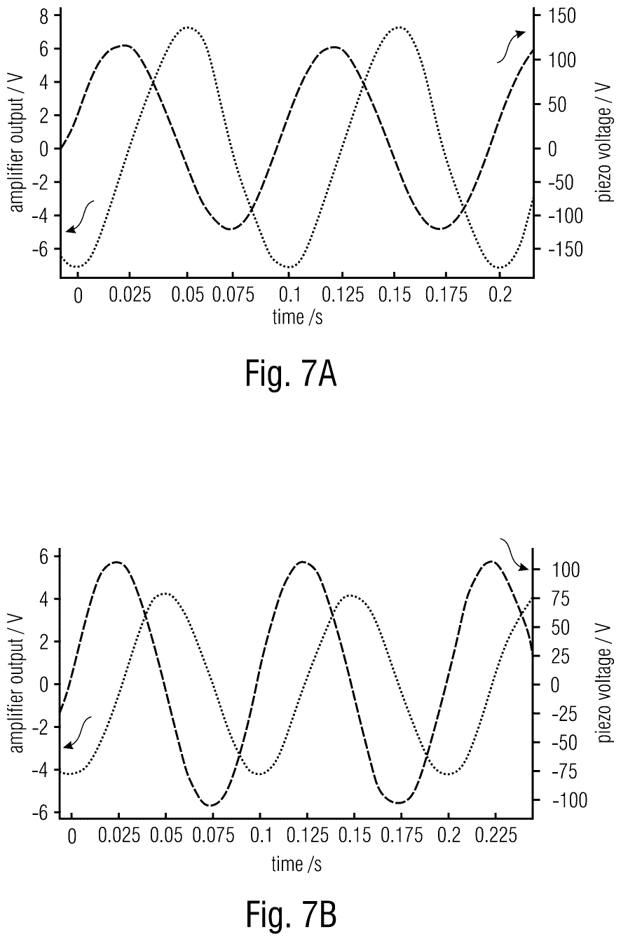

FIG. 7A shows the current and voltage curve of a micro membrane pump with sinusoidal control. FIG. 7B shows, as a comparison, the time-resolved current curve in a control of a capacitor.

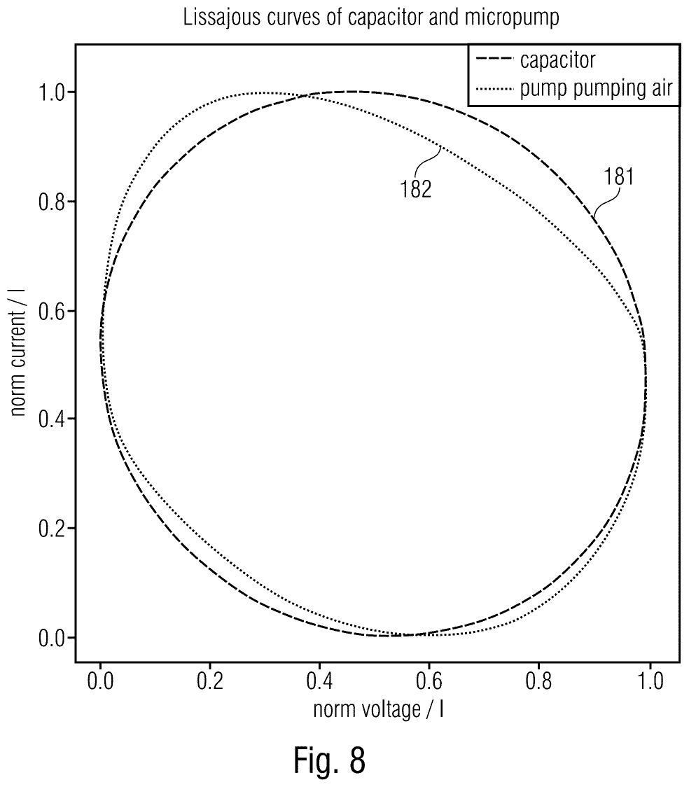

To visually illustrate hysteresis effects, it is suitable to plot the output signal (here the measured current) across the input signal (alternating voltage). The figures (Lissajous curves) created are illustrated in FIG. 8 and provide information about the ratio of the output signal to the input signal. In an ideal capacitor, there is a phase offset of 90° between the voltage and the current, leading to a circular Lissajous curve 181. External influencing factors acting on the microfluidic component 1000, or the membrane actuator 100, distort the current signal (FIG. 7a), leading to a Lissajous curve 182 (FIG. 8) that deviates from the circular shape 181.

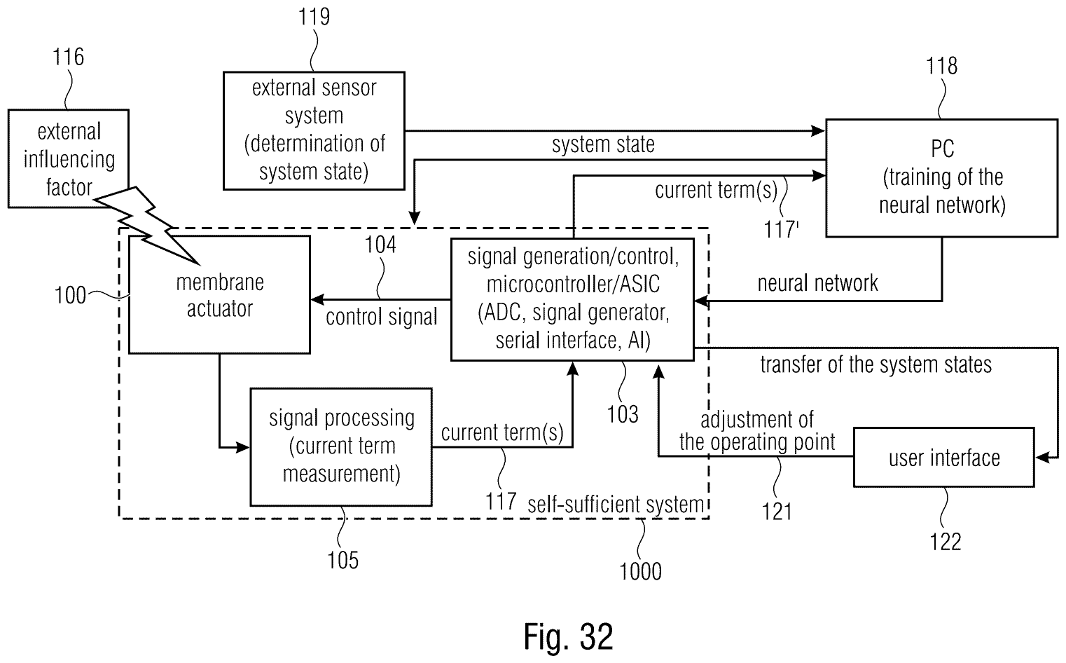

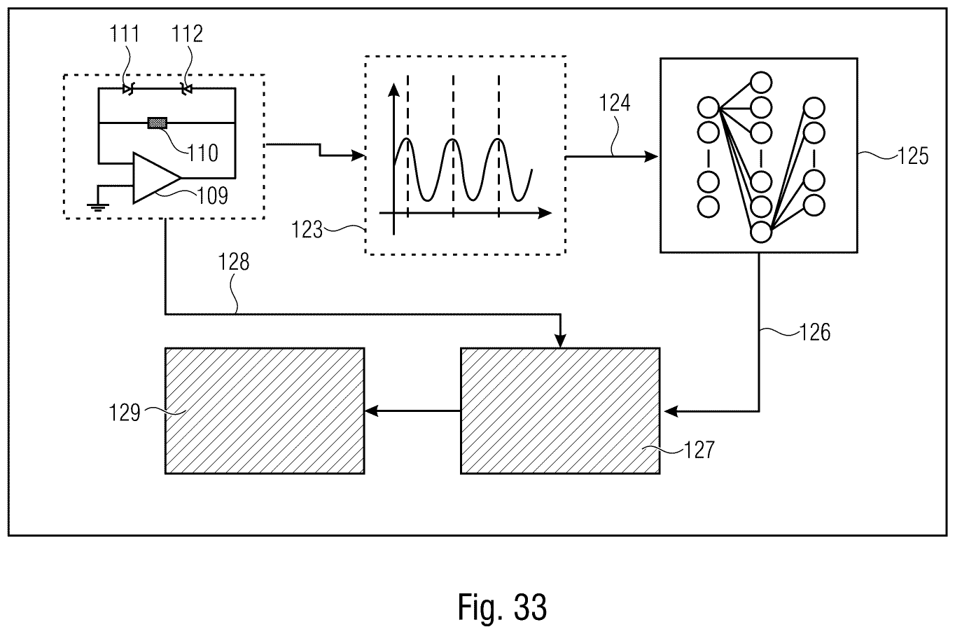

The overlap of the different time constants and effects creates non-linear differential equations whose initial value problems cannot be solved in a simple way. In order to be able to make statements about different system states (e.g. air bubbles in liquid dosage, closure of the fluid path—blockage) from the current curve recorded, methods from the field of machine learning (cf. section 7, as well as FIGS. 32 and 33) can be used. Patterns may be reliably derived with the help of function approximations from the field of classification.

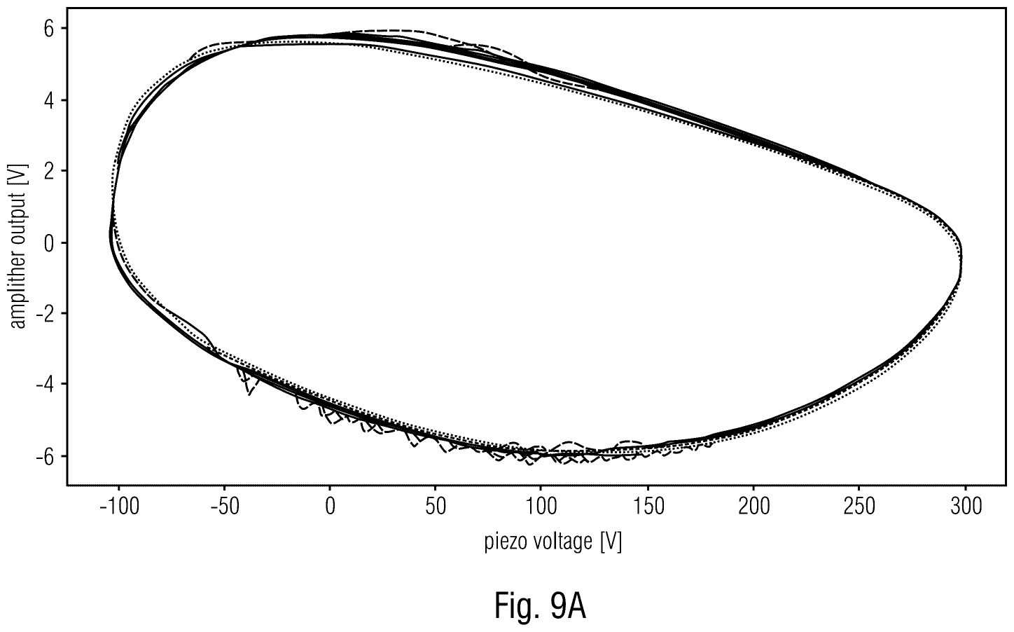

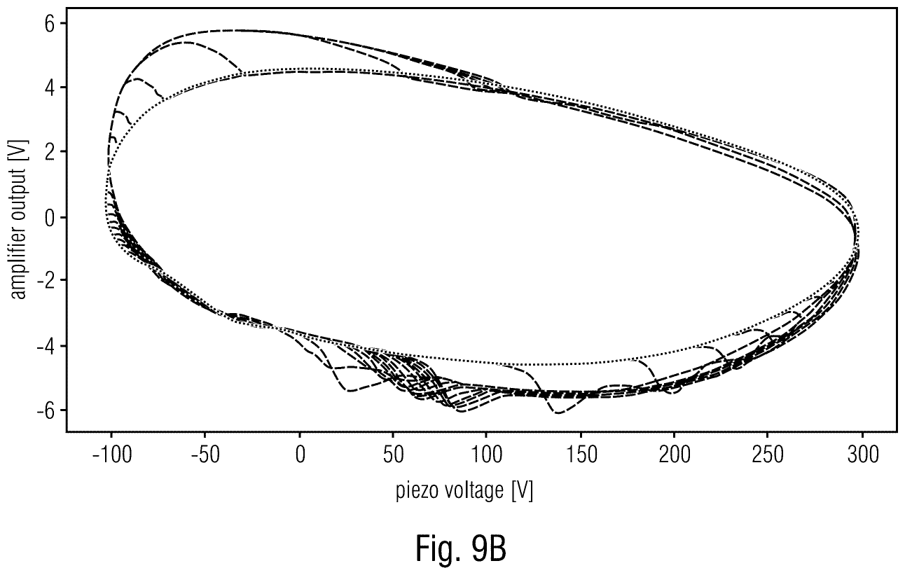

FIGS. 9A and 9B exemplarily show Lissajous curves of a micropump that doses a liquid with a harmonic control and is exposed to the disturbances of an “air bubble” (FIG. 9A) and a “closure” (FIG. 9B) when doing so. Both figures show recurring patterns.

Through extraction of significant features, the amount of data may be reduced to a minimum without losing important information. If this reduced data is provided to classification algorithms, unseen measurement data may be mapped to the respective states with a certain probability.

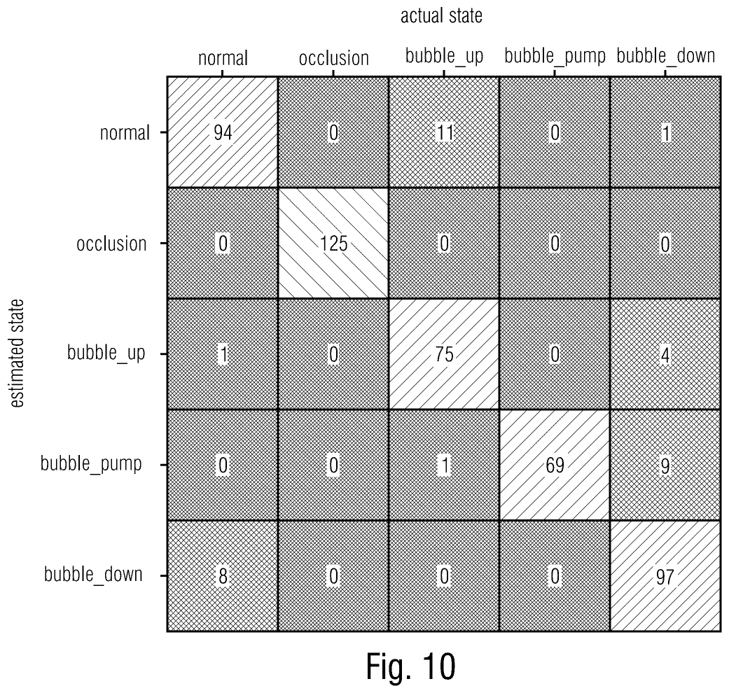

The confusion matrix shown in FIG. 10 shows the frequency of correct predictions of unseen data. High values in the main diagonal signal a very good prediction of states. The first line and the first column each describe the normal state without external influencing factors. The second line and the second column each describe a system state with an occlusion. The third line and the third column each describe a system state with an air bubble located in front of the pump chamber (bubble_up). The fourth line and the fourth column each describe a system state with an air bubble located in the pump chamber (bubble_pump). The fifth line and the fifth column each describe a system state with an air bubble located behind the pump chamber (bubble_down).

In addition to the classification of states, the tools of machine learning also offer the possibility of regression of system sizes (e.g. the counter pressure).

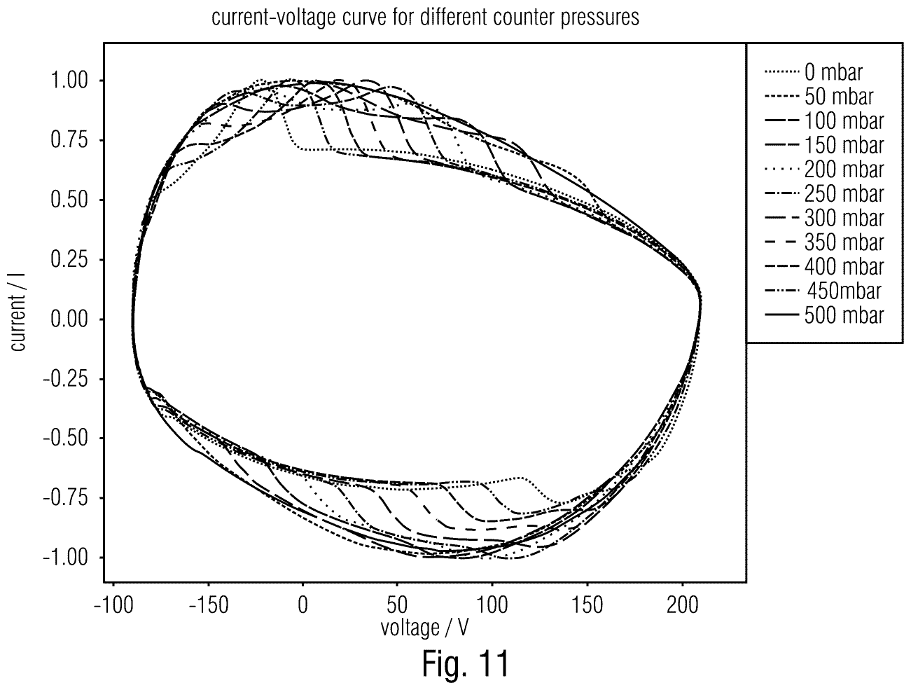

Thus, FIG. 11 exemplarily shows a voltage-current curve, or Lissajous curve, of a micropump at different counter pressures. Again, there are recurring patterns that can be extracted and classified accordingly.

### 5. Experiment for a Discussion of the Compensation Processes

The subsequent experiment carried out by the inventors can be used to explain the above-described compensation processes in more detail. This experiment was designed with the following parameters, avoiding as many interfering influences as possible.
A silicon micropump with a structural size of 5×5 mm² (5×5 high flow pump) is used, this micropump has a pump chamber with a height of 20 μm. This is why pressure drops in the pump chamber do not play a dominant role compared to pressure drops at the microvalves. Thus, with an acceptable approximation, a homogenous pump chamber pressure p can be assumed.
The micropump cycles between U=0 V and U=U+V, the stroke at which the voltage ends at U=0 V is considered. Through this, (when the voltage goes to zero) the term I_{C}=U* dCₑₗ/dt can be neglected.
The starting voltage is increased step by step, from U=1 V to U=100 V.
The transient current data I(t) is measured.
The measurement data is then fitted with exponential functions.

All measurements in this section use a rectangular control, i.e. the voltage change at the piezoceramic occurs suddenly at the start. The current flowing onto the piezoceramic is measured, and the current measurement values obtained are fitted by means of exponential functions.

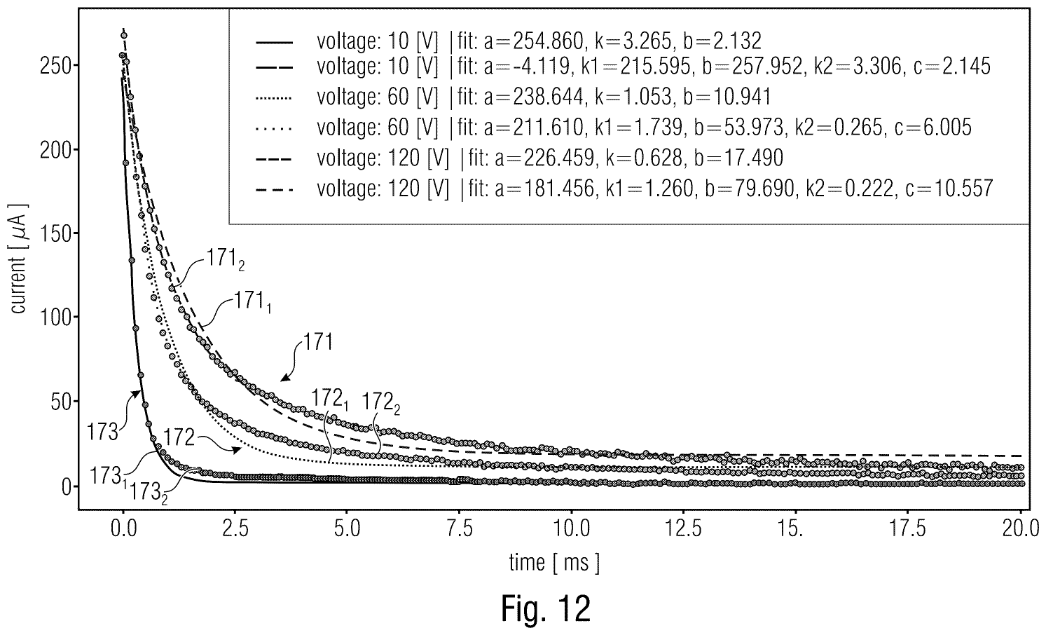

FIG. 12 shows the raw data of the measurements, i.e. transient measurement points for the current flowing onto the piezoceramic. The plotted dots indicate the individual measurement values, wherein the upper measurement values 171 were determined at a voltage of U=10 V, the central measurement values 171 at a voltage of U=60 V, and the lower measurement values 173 at a voltage of U=120V.

If the respective measurement data is fitted with a simple exponential function, there are significant deviations with respect to the measurement results. This can be seen with the curves 171₁, 172₁, 173₁ indicated by solid lines. However, if a linear superposition of two exponential functions is fitted, the fit matches the measurement data very well, which can in turn be seen with the curves 171₂, 172₂, 173₂ indicated by dotted lines. These dotted-line curves match the individual measurement points almost identically. This indicates that two compensation processes overlap, according to the above explanations.

Specifically, for each suction stroke and for each pressure stroke, four fit parameters for Iₚ₀, □ₕ, I_{c0}+I_{d0}, □_{piezo} can be gathered from this measurement series.

### 5.1 Sensor Current: Measurement and Interpretation of the Amplitude

The following discusses the dependencies of the these four fit parameters with respect to the drive voltage for the suction stroke and the pressure stroke.

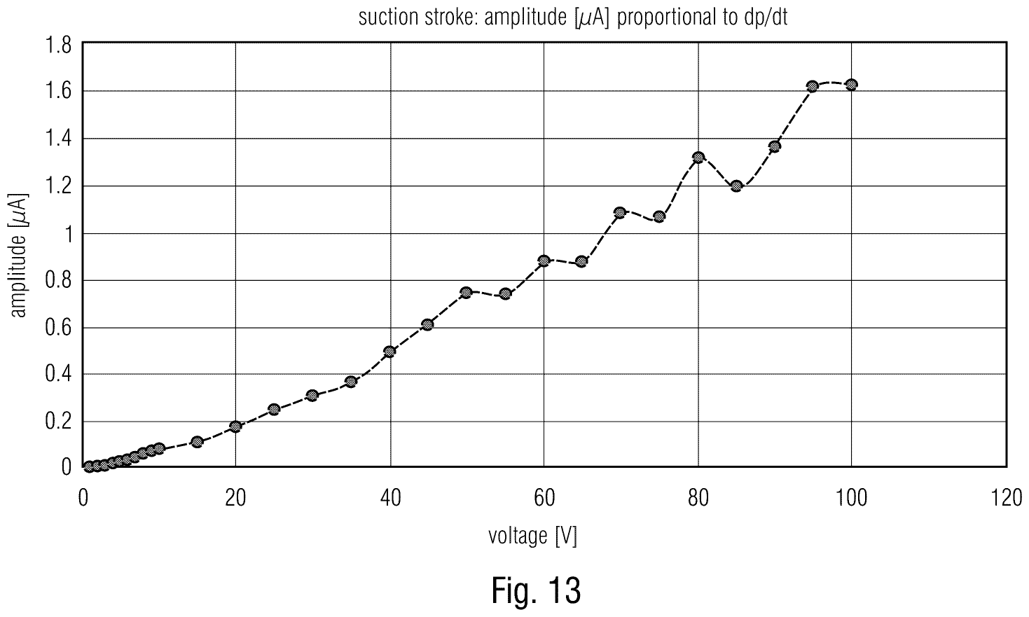

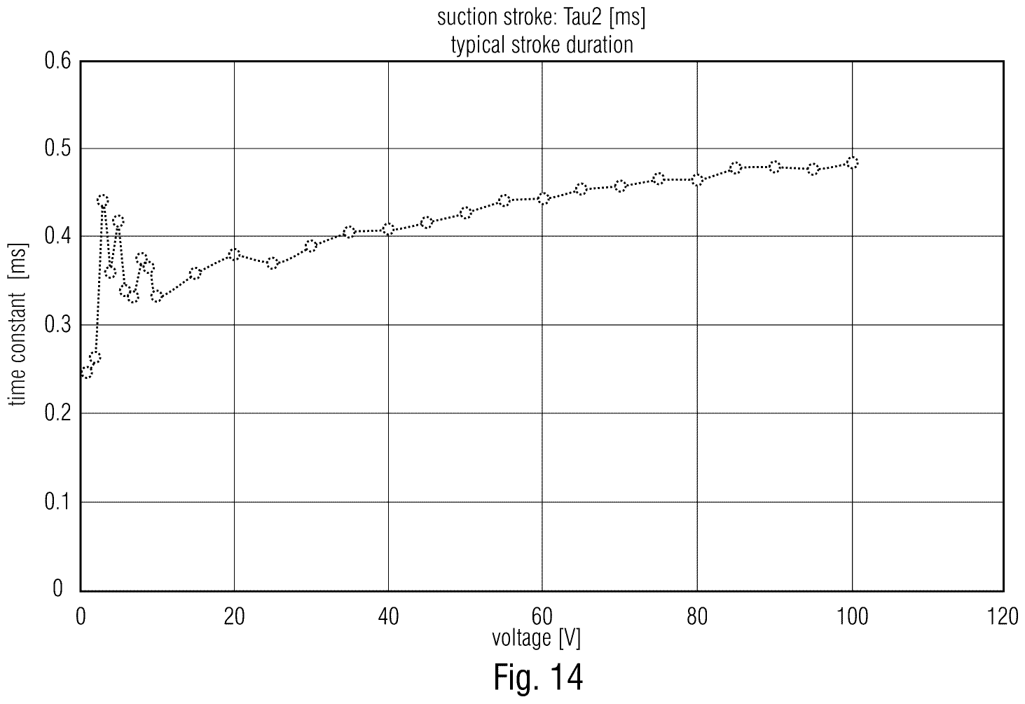

FIG. 13 shows the dependency of a current amplitude Iₚ₀ with respect to the voltage in the suction stroke. This is linked to the corresponding time constants that are subsequently discussed with reference to FIG. 14. Initially, however, the current amplitude Iₚ₀ (y axis) can be seen as a function of the voltage (x axis) in FIG. 13.

Reminder: The current amplitude Iₚ₀ results according to [Equation 6] from the compensation process of the pump chamber pressure (without squeeze film damping and with linearized valve characterising curves) as:

$${I}_{p} = {C}_{E}^{*} \cdot \frac{dp}{dt} = {I}_{p 0} \cdot {e}^{- \frac{t}{{τ}_{h}}} ; \qquad [ Equation 6 ]$$

$$with$$

$${τ}_{h} = {R}_{fluidic} * {C}_{fluidic}$$

Here, the pump chamber pressure behaves as follows:

$$p ( t ) = \frac{{C}_{E}^{*}}{{C}_{p} + {C}_{gas}} ( U - {U}_{0} ) \frac{1}{1 - \frac{{τ}_{a}}{{τ}_{h}}} ( {e}^{- \frac{1}{{τ}_{a}} t} - {e}^{- \frac{1}{{τ}_{h}} t} ) \qquad [ Equation 13 a ]$$

Among others, equation [13a] was published in 1994 (with a different nomenclature) (https://iopscience.iop.org/article/10.1088/0960-1317/4/4/004)

Equation [13a] is important since it describes (in an approximated, linearized model) the temporal behaviour of the pump chamber pressure when the pressure first builds up after a (exponential) voltage change and then diminishes due to the flow through the microvalves (via their current resistances R_{EV} and R_{AV}, respectively).

Equation [13a] is the special solution of a common differential equation with a disturbance element for the electric voltage U(t).

This differential equation can be illustrated as follows:

$$\frac{dp}{dt} = \frac{1}{{C}_{fluidic}} ( \frac{{p}_{1}}{{R}_{EV}} + \frac{{p}_{2}}{{R}_{AV}} - p ( \frac{1}{{R}_{EV}} - \frac{1}{{R}_{AV}} ) - {C}_{E}^{*} \frac{dU}{dt} ) \qquad [ Equation 13 b ]$$

with the following parameters:
p₁ and p₂: used to calculate the pressure at the inlet (p₁) and the counter pressure at the outlet (p₂) applied at the micropump.
C_{fluidic}: fluidic capacity, as a sum of the fluidic capacities of the membrane Cp, a (optional) gas bubble C_{gas}, the inlet valve (C_{EV}) and the outlet valve (C_{AV}). The last two fluidic capacities (C_{EV} and C_{AV}) are usually very small and can be neglected for the most part.
R_{EV} and R_{AV}: These indicate the fluidic resistances of the two passive check valves. In reality, they are not constants, but (above all at very small pressure differences at the valve) they are pressure-dependent. In the analytic solution of the differential equation, however, they are assumed to be constant. Particularly through this approximation step, the solution p(t) of equation [13b] will approximate the real curve only in the sense of a grey box model. In case of a certain stroke (e.g. a pressure stroke), the outlet valve is open, while the inlet valve is closed. The fluidic conductance 1/R_{AV} is significantly larger than 1/R_{EV}. Thus, the term 1/R_{EV} may be neglected in the solution of p(t) in the pressure stroke (and vice versa in the suction stroke).

Equation [13a] describes a special solution of differential equation [13b] with the following initial conditions:
1) The initial condition is p(0)=0
2) The disturbance element is a charge of the electrical capacitance Ci of the piezoceramic across an electric charge resistance Rₑₗ,

$$U ( t ) = {U}_{A} ( 1 - {e}^{- \frac{t}{{τ}_{a}}} ) , \qquad [ Equation 13 c , d ]$$

$$mit$$

$${τ}_{a} = {C}_{el} {R}_{el}$$

In case of control via a piezo amplifier, this rise time ┘ₐ may be in the range of a few microseconds, wherein it is in the range of ┘ₐ=0.5 ms in self-sustaining, battery-operated micropump control electronics (due to the higher electric internal resistance of the batteries, among other things). That is, a positive voltage is applied to the piezoceramic, describing the pressure stroke (the membrane moves towards the pump chamber bottom, the stroke volume is displaced through the outlet valve).
3) In the solution of equation [13a], the pressure and the counter pressure were set to zero, or to the reference pressure of the atmospheric pressure p₁=p₂=p₀.
4) The flow resistance of the inlet valve (closed in the pressure stroke) is neglected.

It is also important to note that the differential equation [13b] can only be solved portion by portion since, upon change of sign of the pressure difference at the valves, the parameters 1/R_{AV} and 1/R_{EV} change abruptly.

Further solutions of these differential equations may be determined with general primary and counter pressures p1 and p2 as follows:

The solution with an exponential voltage ramp up (same as for equation [13a]), but with primary and counter pressures p₁ and p₂:

$$p ( t ) = \frac{\frac{1}{{C}_{total}} ( \frac{{p}_{1}}{{R}_{EV}} + \frac{{p}_{2}}{{R}_{AV}} ) ( 1 - {e}^{- \frac{1}{{τ}_{h}} t} )}{\frac{1}{{τ}_{h}}} - \frac{\frac{{C}_{E}^{*}}{{C}_{total}} \frac{{U}_{A}}{{τ}_{a}} ( {e}^{- \frac{1}{{τ}_{a}} t} - {e}^{- \frac{1}{{τ}_{h}} t} )}{\frac{1}{{τ}_{h}} - \frac{1}{{τ}_{a}}} \qquad [ Equation 13 e ]$$

And a solution with a sinusoidal voltage excitation:

$$U ( t ) = {U}_{A} cos ( ω t ) = {U}_{A} cos ( \frac{t}{{τ}_{a}} ) \qquad [ Equation 13 f ]$$

With the initial condition p(0)=0:

$$p ( t ) = \frac{\frac{{p}_{1}}{{R}_{EV}} + \frac{{p}_{2}}{{R}_{AV}}}{\frac{1}{{R}_{EV}} - \frac{1}{{R}_{AV}}} ( 1 - {e}^{- \frac{t}{{τ}_{h}}} ) + \frac{{C}_{E}^{*}}{{C}_{total}} \frac{{U}_{A}}{{τ}_{a}} \frac{\frac{1}{{τ}_{h}} sin ( ω t ) - ω cos ( ω t ) + ω {e}^{- \frac{t}{{τ}_{h}}}}{\frac{1}{{{τ}_{h}}^{2}} + {ω}^{2}} \qquad [ Equation 13 g ]$$

The voltage U(t) may be designed by the developer of the micropump system with the control signal and has a large influence on the mechanical and fluidic response of the system. If the voltage change U(t) is so fast that natural oscillations of the valve (or even of the membrane transducer) are excited, they may be put in oscillation. If the voltage change occurs very slowly (much slower than the fluidic time constant ┘ₕ), significant pressure can no longer be built up in the pump chamber, since the fluid immediately flows through the valve at the slow membrane speeds. Above all, this is the case in harmonic excitation with a small angular frequency ┘.

If these time-dependent equations [13a, 13e, 13g] are derived with respect to the time and are multiplied with C_{E}*, the “sensor current” Iₚ is obtained directly, which, according to the invention, opens the door for the electric detection of the fluidic or mechanical effects “connected to” the pump chamber pressure, by means of data science methods and “machine learning”.

In summary, with respect to the above equation [13a], among other things, it is to be noted that the pump chamber pressure builds up with the time constant □ₐ and diminishes with the time constant □ₕ. The pressure amplitude p(t) is proportional to the voltage amplitude U−U₀, thus, the time derivative dp/dt is proportional to U−U₀.

Since the sensor current Iₚ₀ is proportional to dp/dt, one would assume a linear increase of the amplitude with the voltage. However, the increase is non-linear. The non-linear part can be explained as follows:

The amplitude Iₚ₀ is proportional to the coupling factor C_{E}*, which is in turn proportional to the coefficient d31 of the piezoceramic. FIG. 13 clearly shows the non-linear behaviour of the characteristic curve of the voltage amplitude. This is a clear indication that the non-linear rise of d31 can be measured with this measurement. So far, a factor of 1.5 was assumed as a practical value for the increase of the coefficient d31 between the small signal and the large signal, since the increase of the rise of the characteristic curve between very low voltages (small signal) and large voltages (large signal) approximately corresponds to this factor 1.5.

A factor that is correlated with the pressure amplitude in the pump chamber may be extracted from the amplitude Iₚ₀, i.e. a measure for the large signal behaviour of the coefficient d31 can also be determined (through a variation of the voltage amplitude). Thus, the large signal behaviour of the coefficient d31 can be identified with the inventive concept disclosed herein as well.

### 5.2 Sensor Current: Measurement and Interpretation of the Time Constants

FIG. 14 shows the curve of the time constant □ₕ in the suction stroke, while the pressure in the pump chamber diminishes. The time constant (y axis) is plotted as a function of the applied voltage (x axis).

In the case of small voltage values, noise is still too large to be able to precisely determine the time constant □ₕ. According to the experiment discussed herein, the “high flow pump” has a typical stroke time □ₕ of significantly below 1 millisecond (the pump has been designed in this way) for air as a medium. Since, in case of gases, this pump shows an increase of the conveying rate of above 1 kHz, the fluidic time constant is below 1 millisecond, i.e. the exponential function fit whose time constant is below 1 millisecond can be interpreted as the sensor current.

The time constant □ₕ increases with a rising voltage amplitude. This is physically consistent, since, in case of a higher voltage, the pump membrane comes closer to the pump chamber bottom, through which the flow resistance rises and the outflow process slows down.

According to the experiment discussed herein, the pressure drop at the pump chamber slit (despite the pump chamber height of 20 μm) is still larger than the pressure drop at the microvalves. Thus, if the voltage rises, the actuator comes closer to the pump chamber, the slit resistance rises and □ₕ increases.

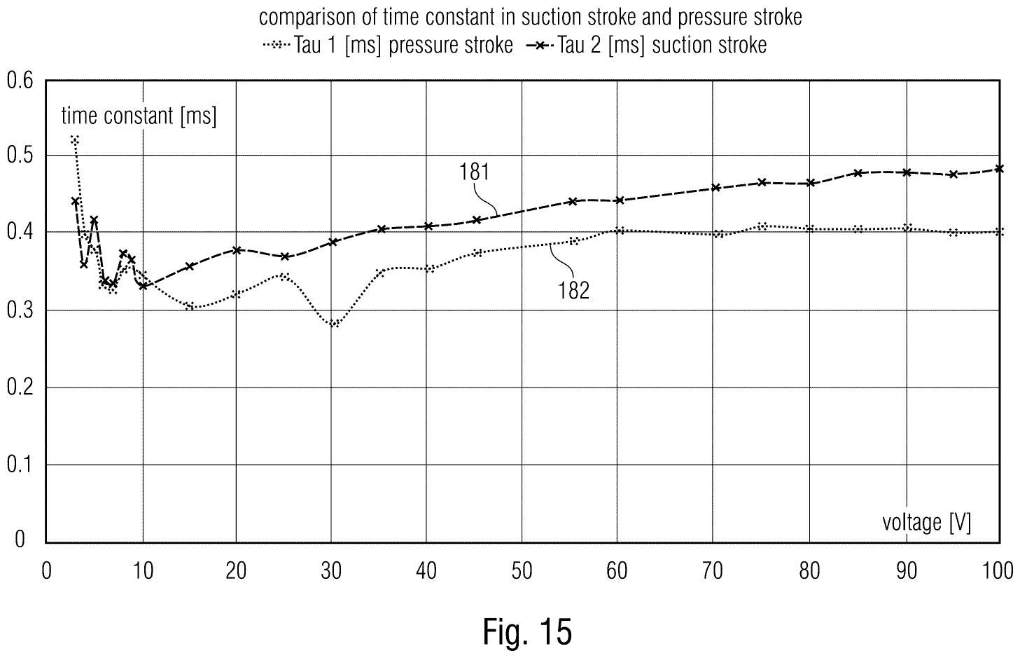

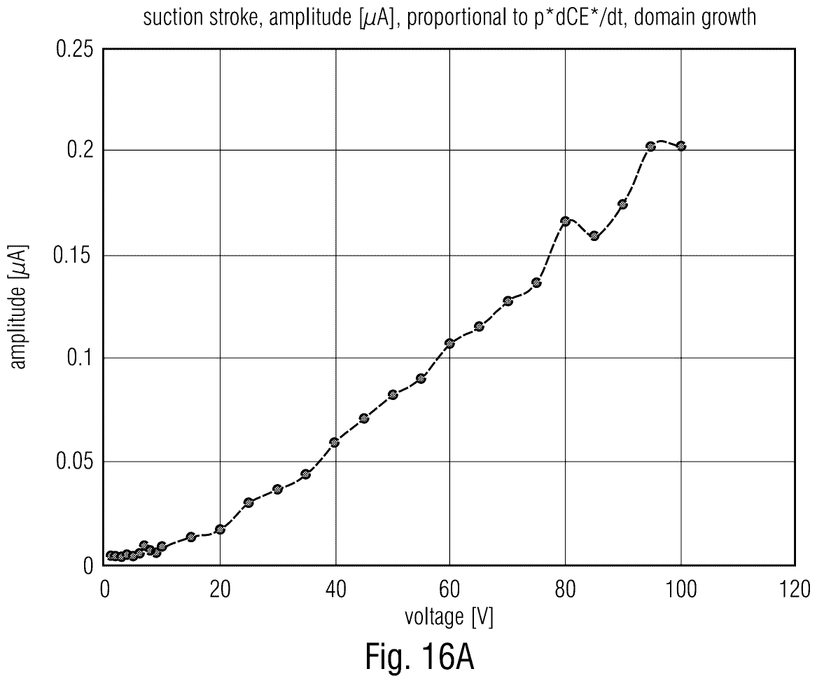

In comparison, FIG. 15 shows the time constant for the pressure stroke. That is, the curve 181 corresponds to the curve for the temporal progress of the time constant in the suction stroke previously discussed with reference to FIG. 14. The curve 182 shows the temporal progress of the time constant for the pressure stroke.

To begin with, it can be directly gathered from FIG. 15 that the time constant for the suction stroke (curve 181) is slightly larger than in the pressure stroke, i.e. the pressure drop in the suction stroke is longer than in the pressure stroke. With respect to the pump chamber pressure from [Equation 13], this may be explained as follows:

$$p ( t ) = \frac{{C}_{E}^{*}}{{C}_{p} + {C}_{gas}} {U}_{A} \frac{1}{1 - \frac{{τ}_{a}}{{τ}_{h}}} ( {e}^{- \frac{1}{{τ}_{a}} t} - {e}^{- \frac{1}{{τ}_{h}} t} ) \qquad [ Equation 13 ]$$

For the time constant □ₕ, this results in the following:

$${τ}_{h} = {R}_{fluidic} ( {C}_{M} + {C}_{gas} ) \qquad [ Equation 14 ]$$

The typical stroke time is proportional to the fluidic capacity since the sum of the fluidic capacity of the drive membrane Cₚ and the fluidic capacity of the air C_{gas} is in the pump chamber. In general, the fluidic capacity describes the change of the volume as a function of a pressure change. In the drive membrane, the fluidic capacity is essentially constant in the context of the Kirchhoff plate theory, while, it is larger in gas volumes at smaller absolute pressures (suction stroke) than at larger absolute pressures (pressure stroke) due to the state change equation (depending on the speed of the state change it is isothermal, adiabatic or polytropic).

However, the fluidic capacity of air C_{gas} is not constant and corresponds to the tangent of the isothermal or adiabatic state equation, and is proportional to the dead volume:
Pressure stroke: the remaining dead volume after the compression
Suction stroke: the remaining dead volume after the expansion

That is, the fluidic capacity of the gas bubble C_{gas} is larger in the suction stroke than in the pressure stroke, thus, the typical stroke time in the suction stroke is larger than in the pressure stroke when pumping a compressible medium such as air.

Incidentally, this would also mean that 50/50 is not the optimum duty factor when pumping compressible media such as air, but that the suction stroke needs more time than the pressure stroke.

### 5.3 Extraction of the Flow Resistance in the Microfluidic Component (in Case of a Microfluidic Valve or in the Pump Chamber of Micropumps)

The sensor current that depends on the pressure under the membrane element 101 may be expressed as follows (under consideration of [Equation 23]):

$${I}_{p} = {U}_{A} \frac{{( {C}_{E}^{*} )}^{2}}{{C}_{M} + {C}_{gas}} ( \frac{1}{{τ}_{h}} {e}^{- \frac{t}{{τ}_{h}}} - \frac{1}{{τ}_{a}} {e}^{- \frac{t}{{τ}_{a}}} ) \qquad [ Equation 15 a ]$$

Equation [15a] may be derived via the piezoelectric coupling factor k. Square k² is a measure for the ratio of mechanical energy output to electric energy input.

$${I}_{p} = {k}^{2} {C}_{el} {U}_{A} \frac{{C}_{M}}{{C}_{M} + {C}_{gas}} ( \frac{1}{{τ}_{h}} {e}^{- \frac{t}{{τ}_{h}}} - \frac{1}{{τ}_{a}} {e}^{- \frac{t}{{τ}_{a}}} ) \qquad [ Equation 15 b ]$$

The following relationship applies:

$${( {C}_{E}^{*} )}^{2} = {k}^{2} {C}_{el} {C}_{M} . \qquad [ Equation 15 c ]$$

Rearranging the equation and solving it for k² results in:

$${k}^{2} = \frac{{( {C}_{E}^{*} )}^{2}}{{C}_{el} {C}_{M}} . \qquad [ Equation 15 d ]$$

Thus, the following results for the sensor current Iₚ as a function of k:

$${I}_{p} = \frac{{k}^{2} {C}_{e l} {U}_{A}}{{τ}_{h}} \frac{{C}_{M}}{{C}_{M} + {C}_{g a s}} {e}^{- \frac{t}{{τ}_{h}}} \qquad [ Equation 15 e ]$$

Thus, equation [15a] and all subsequent equations may be expressed without k, and, from equation [15a], the following results for the sensor current Iₚ after the time constant □ₐ has subsided:

$${I}_{p} = \frac{{U}_{A}}{{τ}_{h}} \frac{{( {C}_{E}^{*} )}^{2}}{{C}_{M} + {C}_{g a s}} {e}^{- \frac{t}{{τ}_{h}}} \qquad [ Equation 16 ]$$

### 5.3.1 Extraction of the Flow Resistance in the Case of an Air Pump

If the microfluidic component 1000 is an air pump, i.e. a micropump configured to convey air, the flow resistance R_{fluidic} can be calculated as follows:

$${R}_{fluidic} = \frac{{τ}_{h}}{{C}_{M} + {C}_{g a s}} \qquad [ Equation 17 ]$$

In addition, the flow resistance Rₜₒₜₐₗ can be calculated as follows from the amplitude:

$${I}_{p , 0} = {U}_{A} \frac{{( {C}_{E}^{*} )}^{2}}{{R}_{fluidic}} \frac{1}{{( {C}_{M} + {C}_{g a s} )}^{2}} \qquad [ Equation 18 ]$$

$${R}_{fluidic} = {U}_{A} \frac{{( {C}_{E}^{*} )}^{2}}{{I}_{p , 0}} \frac{1}{{( {C}_{M} + {C}_{g a s} )}^{2}} \qquad [ Equation 19 ]$$

That is, the fluidic resistance R_{fluidic} may be calculated independently.

### 5.3.2 Extraction of Further Fluidic Parameters for the Case of an Air Pump

In addition, the term dI_{p,0}/dU can be measured in the small signal:

$$\frac{{dI}_{p , 0}}{d {U}_{s mall signal}} = \frac{1}{{R}_{fluidic}} \frac{{( {C}_{E}^{*} )}^{2}}{{( {C}_{M} + {C}_{g a s} )}^{2}} \qquad [ Equation 20 ]$$

$$\frac{{dI}_{p , 0}}{{dU}_{small signal}} = \frac{1}{{τ}_{h}} \frac{{( {C}_{E}^{*} )}^{2}}{{C}_{M} + {C}_{g a s}} \qquad [ Equation 21 ]$$

In addition, the time constant □ₕ can be calculated from the current amplitude Iₚ as follows:

$${τ}_{h} = \frac{{U}_{A}}{{I}_{p , 0}} \frac{{( {C}_{E}^{*} )}^{2}}{{C}_{M} + {C}_{g a s}} \qquad [ Equation 22 ]$$

### 5.4 Consideration of the Fitted Time Constants:

1) Exponential function for the pump chamber pressure change dp/dt
2) Exponential function for the change of the coupling constant dd/dt.

The coupling constant d can vary for different physical reasons. To begin with, the (static) amplitude of the coupling constant d may change in the large signal, wherein, according to experience, the amplitude rises by approximately 50% between the small and large signal. This increase, on the one hand, may be due to the domain growth (this effect shows a slow relaxation), and, on the other hand, the “atomic force curve” of the atoms may be non-linear (this effect does not show slow relaxation).

The temporal change of the coupling constant C_{E}* is also linked to the “pulsation” of the domains. The time constants are defined by obstacles that the domain growth finds in propagation or (such as in the above experiment) shrinking. This pulsation is purely a material property of the ceramic.

The initially mentioned piezo creep when applying a step function has the same cause. These time constants are slow and reach from milliseconds to the range of seconds.

At small voltages, the entire exponential function seems to disappear. Among other things, this may be explained by the fact that the pulsating domain growth hardly takes place any longer in the small signal. Furthermore, the factor C_{E}*·d/dt is multiplied by the pump pressure p, which is also very small at low voltages.

### 5.5 Extraction and Discussion of the Amplitudes

In addition to the above-discussed time constants, the amplitudes of the two signal portions, or sensor currents Iₚ₀ and I_{d0}, are also of interest.

The analytical expression for Iₚ(t) is:

$${I}_{p} = {U}_{A} \frac{{( {C}_{E}^{*} )}^{2}}{{C}_{M} + {C}_{g a s}} \frac{1}{1 - \frac{{τ}_{A}}{{τ}_{h}}} ( \frac{1}{{τ}_{h}} {e}^{- \frac{t}{{τ}_{h}}} - \frac{1}{{τ}_{A}} {e}^{- \frac{t}{{τ}_{A}}} ) \qquad [ Equation 23 ]$$

The following applies at the point in time t=0:

$${I}_{p 0} = {U}_{A} \frac{{( {C}_{E}^{*} )}^{2}}{{C}_{M} + {C}_{g a s}} \frac{1}{{τ}_{A}} \qquad [ Equation 24 ]$$

$${I}_{p 0} = - \frac{{U}_{A}}{{C}_{e l} {R}_{e l}} \frac{{( {C}_{E}^{*} )}^{2}}{{C}_{M} + {C}_{g a s}} \qquad [ Equation 25 ]$$

5.6 Extraction and Discussion of the Piezo-Specific Fit Parameters Measured

### 5.6.1 Domain Growth U*dC/dt+p*dd/dt for Suction and Pressure Strokes, Amplitude, and Time Constant

The compensation processes of the two signal portions or current terms I_{ce} and I_{C} (cf. [Equation 12]), are linked to the piezo effect, or the piezo material used. In this case, there are two parts:
a) with respect to the coupling factor C_{E}*

$${I}_{c e} = ( p - {p}_{0} ) \cdot \frac{d {C}_{E}^{*}}{d t} = {I}_{c e 0} {e}^{- \frac{t}{{τ}_{P i e z o}}} \qquad [ Equation 26 ]$$

b) with respect to the electrical capacitance Cₑₗ dC*e

$${I}_{C} = ( U - {U}_{0} ) \cdot \frac{d {C}_{e l}}{d t} = {I}_{C 0} {e}^{- \frac{t}{{τ}_{piezo}}} \qquad [ Equation 27 ]$$

### 5.6.2 Consideration of the Suction Stroke

In the suction stroke, the voltage U is switched off. This has the following effects:
The term I_{C} becomes zero, since U=0
The magnetic domains (Weiss regions) shrink, i.e. the coefficient d31 becomes smaller and dC_{E}*/dt becomes negative
Since p−p₀ is smaller than zero in the suction stroke, this term also becomes negative
Overall, two negative factors are multiplied in the calculation of I_{ce}, i.e. I_{ce} is positive in the suction stroke.

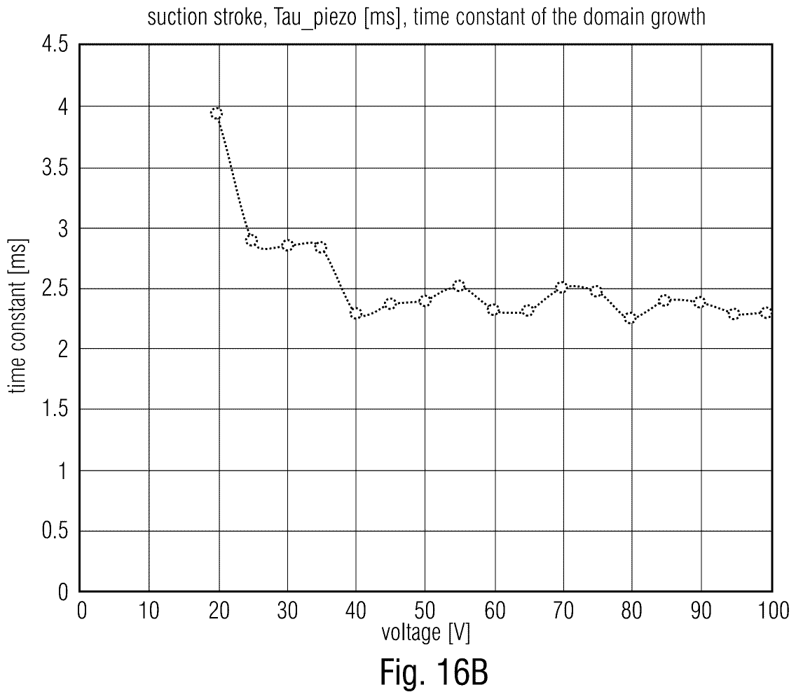

The corresponding measurement series for the amplitude and the time constant for the suction stroke are shown in FIGS. 16A and 16B. FIG. 16A shows the temporal progress of the amplitude (y axis) of the piezo-caused current term I_{ce} as a function of the voltage U (x axis). FIG. 16B shows the temporal progress of the piezo-caused time constant □_{piezo} (y axis) as a function of the voltage U (x axis).

FIG. 16A shows that the current term I_{ce}=p·dC_{E}*/dt is positive. Since the pressure amplitude is correlated with the voltage amplitude, the amplitude increases with the voltage. Due to the large-signal effect of the coefficient d31, or C_{E}*, domain shrinking becomes larger at large voltages than at small voltages. With respect to time constant □_{piezo}, it is to be noted that it is in the range of approximately 2 milliseconds.

### 5.6.3 Consideration of the Pressure Stroke

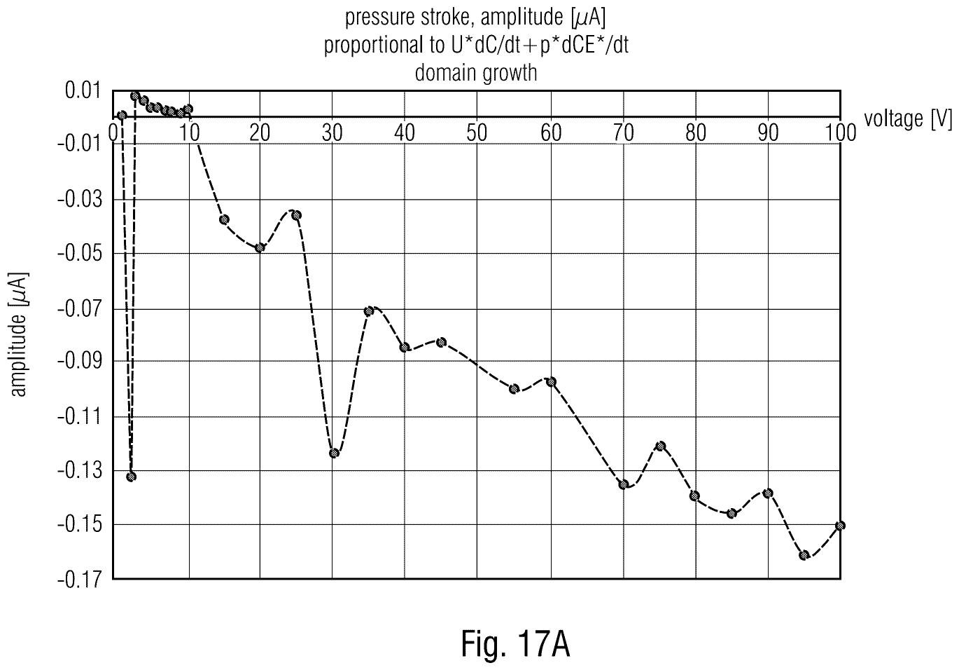

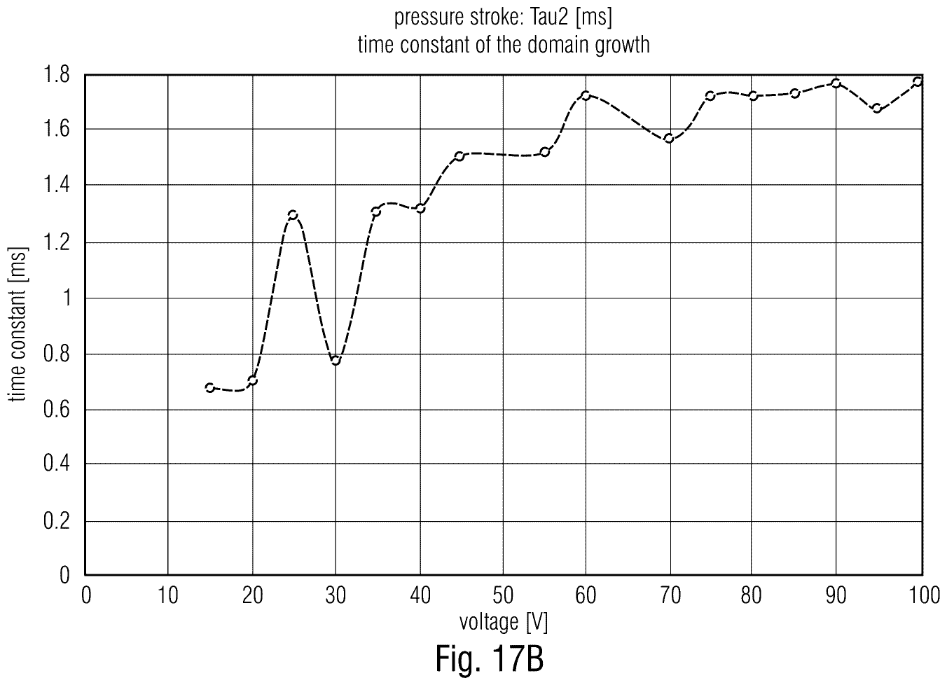

The corresponding series of measurements for the amplitude and the time constant for the pressure stroke are shown in FIGS. 17A and 17B. FIG. 17A again shows the temporal progress of the amplitude (y axis) of the piezo-caused current term I_{ce} as a function of the voltage U (x axis). FIG. 17B in turn shows the temporal progress of the piezo-caused time constant □_{piezo} (y axis) as a function of the voltage U (x axis).

In the pressure stroke, the term I_{ce}=p−p₀ is positive. The magnetic domains (Weiss regions) extend, dC_{E}*/dt is therefore also positive, since the coefficient d31, and therefore also C_{E}*, increases. The current term or signal portion I_{ce} is therefore also positive.

$${I}_{c e} = ( p - {p}_{0} ) \cdot \frac{d {C}_{E}^{*}}{d t} = {I}_{c e 0} {e}^{- \frac{t}{{τ}_{P i e z o}}} \qquad [ Equation 28 ]$$

The second piezo-caused signal portion or current term I_{C} (=capacitance term) is also positive since (U−U₀) is positive, and the change of the electrical capacitance is also positive, which is why U_{c} is also positive:

$${I}_{C} = ( U - {U}_{0} ) \cdot \frac{d {C}_{e l}}{d t} = {I}_{C 0} {e}^{- \frac{t}{{τ}_{piezo}}} \qquad [ Equation 29 ]$$

The amplitude measured in the pressure stroke is positive, however, it is slightly smaller than in the suction stroke. The time constant □_{piezo} in the pressure stroke is also slightly smaller than in the suction stroke, i.e. the domain growth works quicker than the domain shrinkage.

### 5.6.4 Consideration at Small Voltages

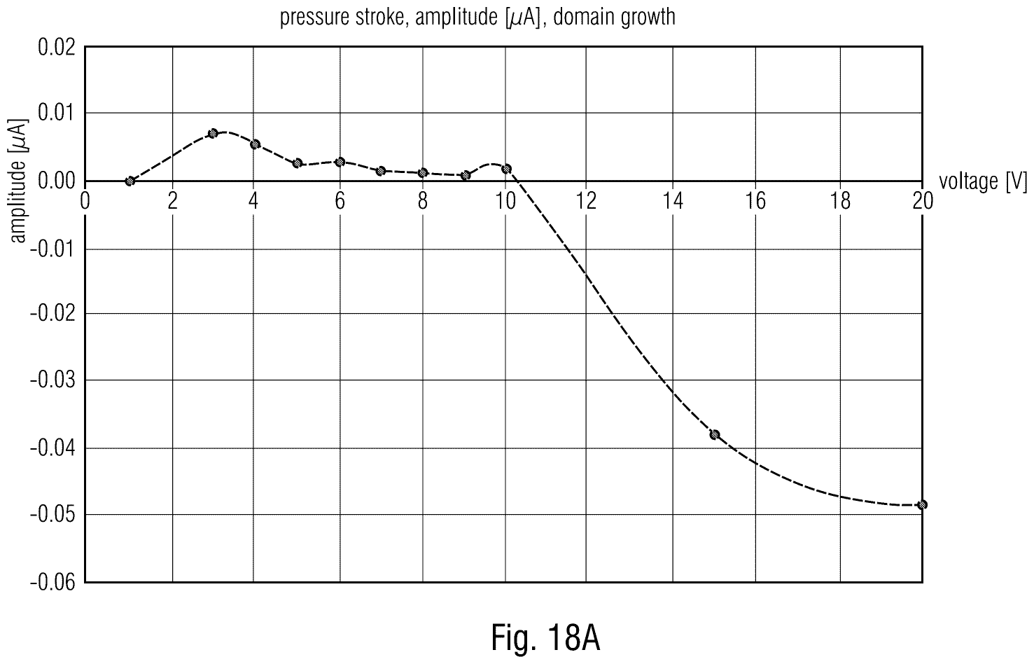

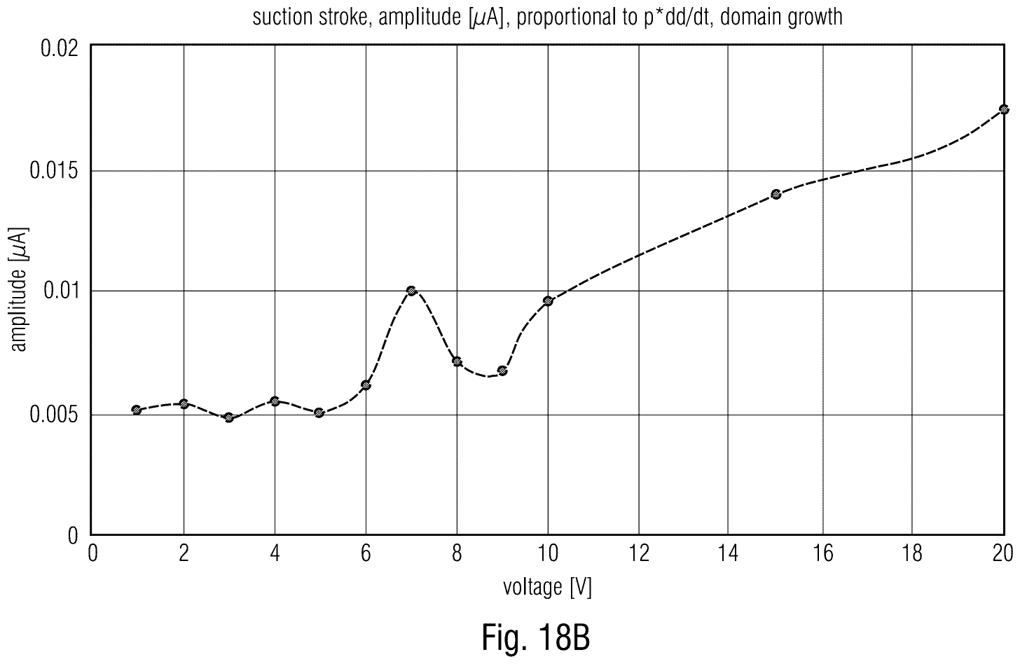

FIGS. 18A and 18B show the corresponding series of measurements for the amplitude and the time constant at small voltages. FIG. 18a shows the temporal progress of the amplitude (y axis) of the piezo-caused current term I_{ce} as a function of the voltage U (x axis) at small voltages in pressure stroke. FIG. 18B shows the temporal progress of the piezo-caused time constant □_{piezo} (y axis) as a function of the voltage U (x axis) at small voltages in the suction stroke.

As can be seen here, at very small voltage amplitudes, there is no domain growth and no hysteresis, neither in the pressure stroke nor in the suction stroke.

### 5.7 Further Experiments

In addition to the experiment described in section 5, further conceivable experiments may be carried out to verify and optimize the inventive concept.

For example, the bare piezoceramic could be measured. This would be the simplest way to find out whether the pump chamber pressure term Iₚ fully disappears and therefore only the signal portions or current terms I_{c} and I_{ce} remain. To examine the parameters I_{ce0}, I_{c0}, □_{piezo} without the term dp/dt, piezo-actuated membrane actuators 100 without a valve chip or without a valve flap could be examined. Then, the term dp/dt would be approximately zero.

Alternatively or additionally, the glued-on and biased piezoceramics can be measured, and a comparison could be used to determine how much the parameters change due to the bias compared to a bare piezo element.

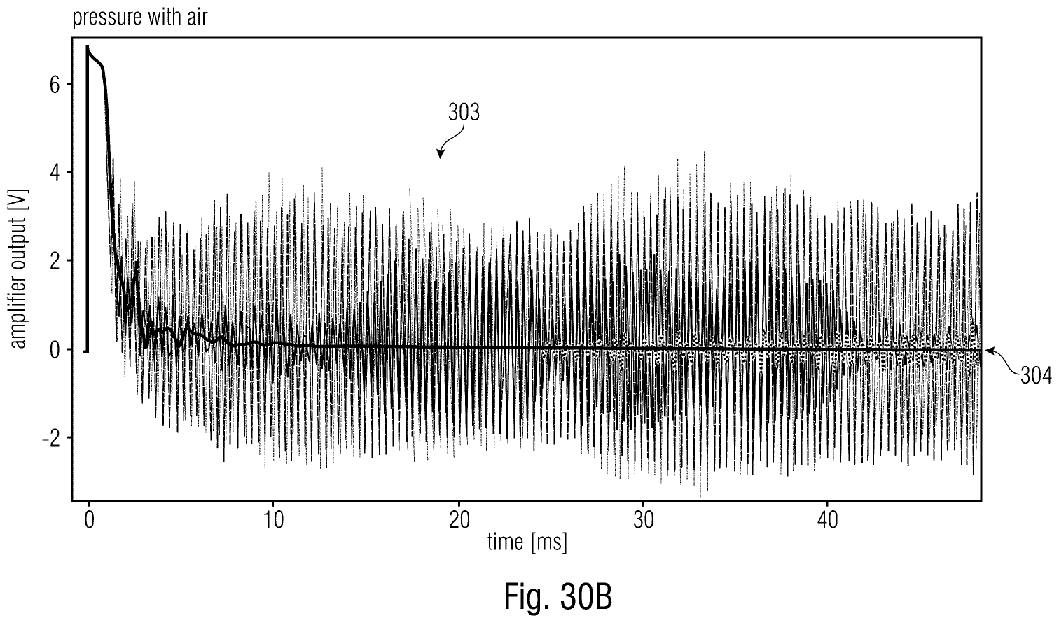

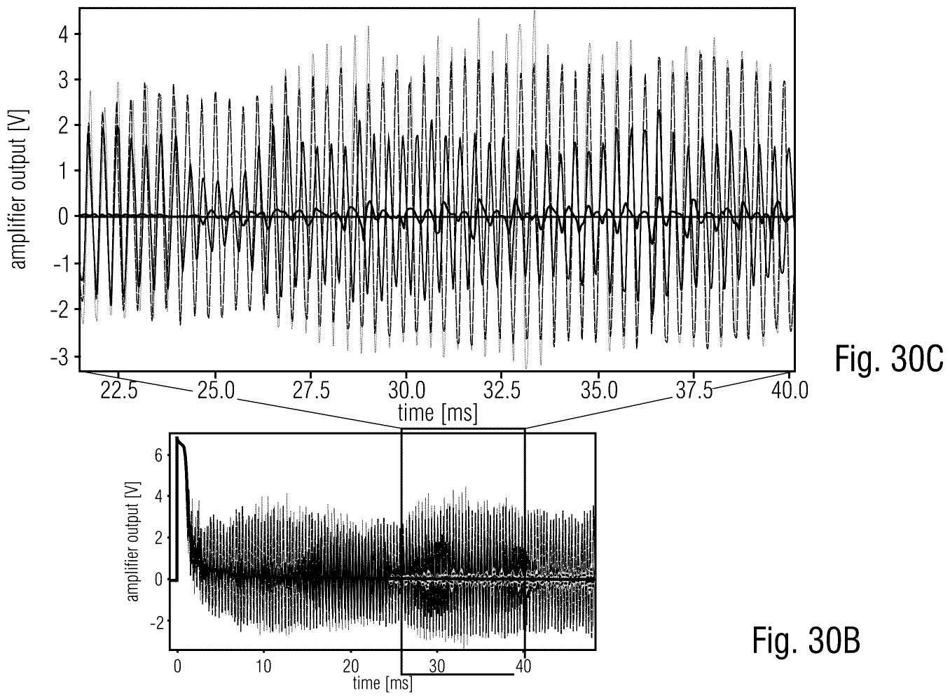

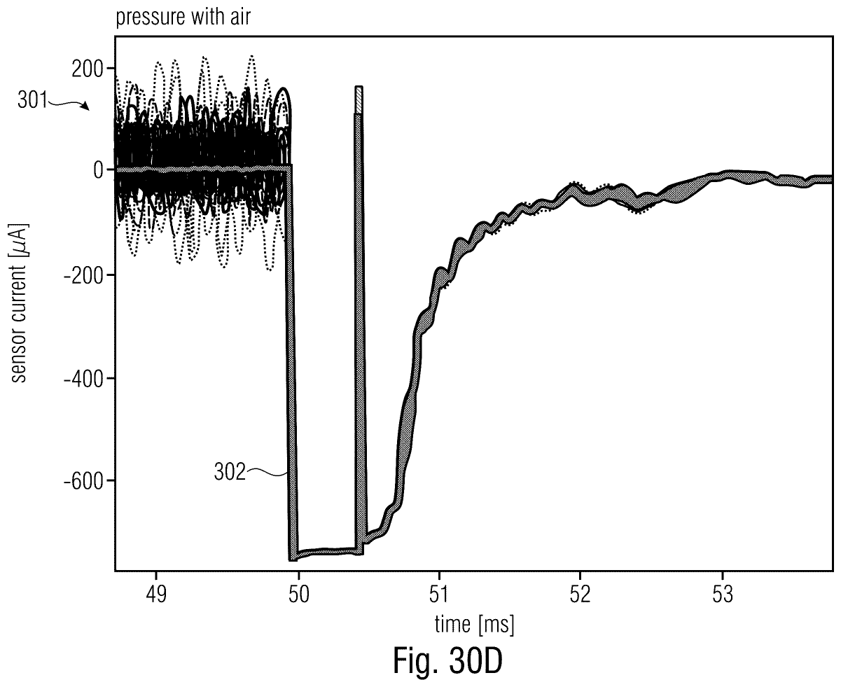

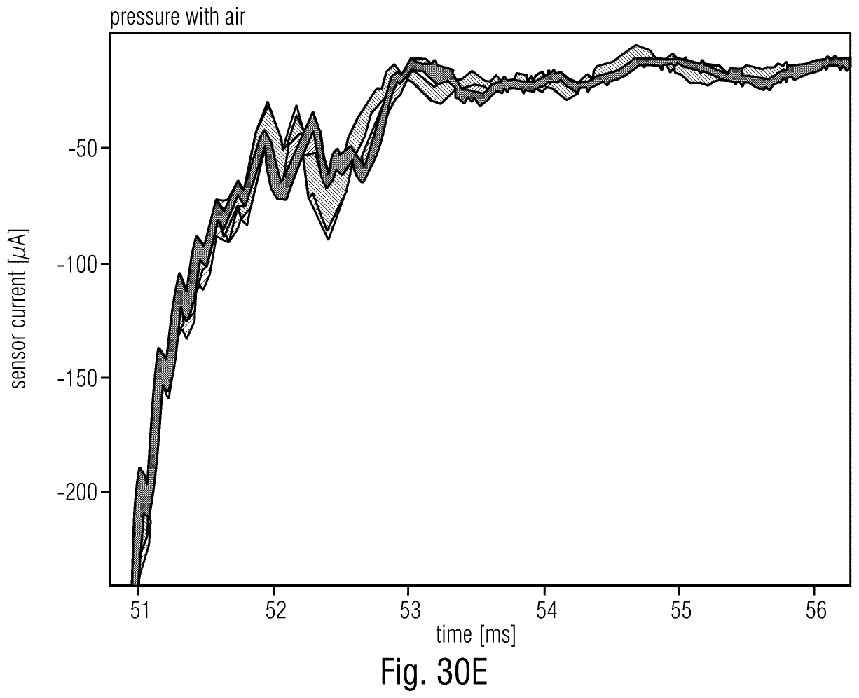

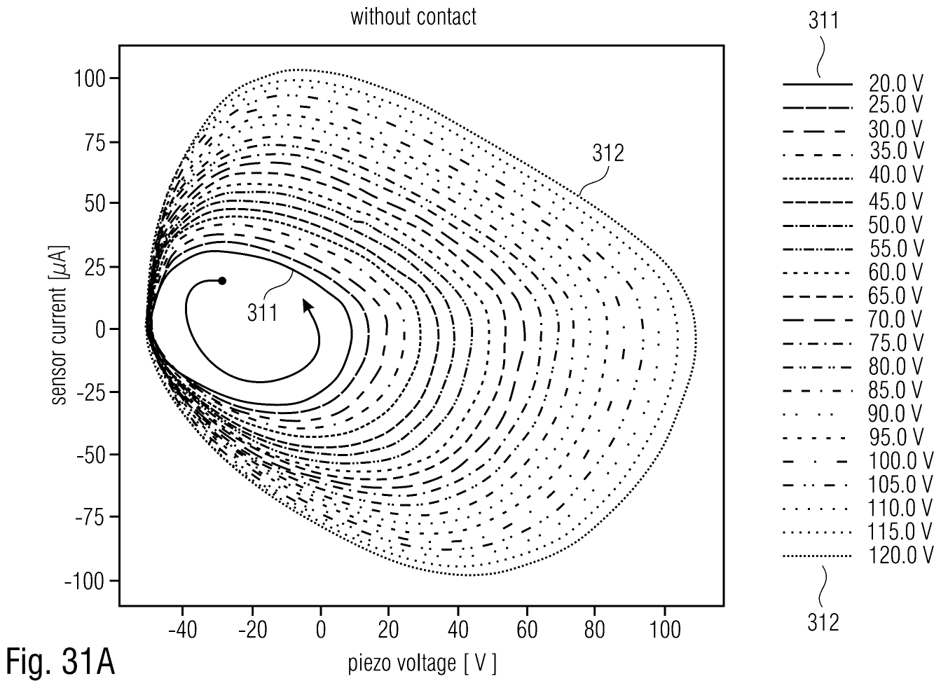

The following could be further conceivable experiments or measurements:
1) Increase of the voltage U+ in small steps, starting with U+=1 Volt (thereby determining the small signal with confidence)
2) Considering the pressure stroke, i.e., coming from 0 V to U+. This additionally results in the term U*dC/dt, i.e. the amplitude I_{c0} should be added in addition to the amplitude I_{ce0}, otherwise, the other parameters should change little. Alternatively or additionally, instead of the time constant □_{piezo}, fitting can be carried out by means of the individual time constants □_{c} and □_{d}, among other things, to confirm that these parameters □_{c} and □_{d} are equal.
3) A different series resistor (or resistance) R 110 that prolongs the electric time constants in a selective way could be used to verify that there is no interrelationship.
4) Beside the variation of the counter pressure (section 6.3 and FIGS. 30A to 30E), the pressure could be varied, cf. from −15 kPa . . . 0 kPa.

### 6. Determining External Influencing Factors on the Basis of the Temporal Signal Curve Using the Example of an Electrostatically Driven and a Piezoelectrically Driven Membrane Actuator

In summary, the above discussion of the theory shows that the control signal 104 (e.g. an alternating current signal I(t)) comprises a temporal signal curve that can be influenced by external influencing factors. That is, the temporal signal curve deviates upon presence of an external influencing factor from the temporal signal curve without any external influencing factor. Different influencing factors may cause different deviations in the temporal signal curve, corresponding to a characteristic fingerprint that is detectable in a temporal signal curve.

In the context of the present disclosure, a temporal signal curve influenced by an external influencing factor is also referred to as an influenced signal curve of the control signal 104. Accordingly, the control signal 104 itself may also be referred to as an influenced control signal 104.

The control signal 104 may comprise several signal portions or current terms, depending on whether the microfluidic component 1000, or the membrane actuator 100, is driven piezoelectrically or electrostatically.

### 6.1 Electrostatically-Actuated Membrane Actuator

In case of an electrostatically driven membrane actuator 100, for example, the sensor current may comprise two different current terms linked to the electrical capacitance. The first signal portion or current term I_{U} describes the free electric charges on the actuator element 102. The second signal portion or current term I_{C}, depends, as previously described, on the domain sizes. The second current term I_{C} is linked to a temporal change of the capacitance between the membrane element 101 and the actuator element 102 due to the movement of the membrane element 101. Thus, in the electrostatically drive membrane actuator 100, the control signal 104 comprises the following two signal portions or current terms:

$$I = \frac{d Q}{d t} = {I}_{U} + {I}_{C} = {C}_{e l} * \frac{d U}{d t} + ( U - {U}_{0} ) \frac{d {C}_{e l}}{d t} \qquad [ Equation 30 ]$$

According to embodiments of the present invention, the signal processing device 105 is configured to differentiate at least two different signal portions I_{U}, I_{C} of the influenced control signal 104 from each other, wherein
a first signal portion I_{U} is linked to a temporal change of the electric voltage when charging or discharging the capacitance between the membrane element 101 and the actuator element 102, and
a second signal portion I_{C} is linked to a temporal change of the capacitance between the membrane element 101 and the actuator element 102 due to the movement of the membrane element 101.

That is, the membrane actuator 100 may be an electrostatically driven membrane actuator (cf. FIG. 2—right side) whose membrane element 101 forms a movable electrode and whose actuator element 102 forms a counter electrode, wherein the actuator element 102 and the membrane element 101 cooperate capacitively, and wherein the control signal 104 causes a charge flow on the counter electrode 102, by which the membrane element 101 moves relative to the counter electrode 102. During this movement of the membrane element 101 relative to the counter electrode 102, there is a change of capacitance that is in turn linked to the signal portion or current term I_{C} influencing the temporal progress of the control signal 104.

Thus, the signal portions or current terms I_{U} and I_{C} in the control signal 104 have different causes, i.e. there are different external influencing factors that may influence the individual signal portions or current terms I_{U} and I_{C} to a different extent and therefore influence the temporal progress of the overall control signal 104 to a different extent. That is, the individual signal portions or current terms I_{U} and I_{C} are correlated with different external influencing factors that are able to differently influence the temporal progress of the control signal 104.

Thus, according to embodiments of the invention, the inventive signal processing device 105 is configured to perform a signal analysis of the temporal signal curve of the control signal 104 for determining and/or classifying the at least one causal external influencing factor, wherein individual signal portions I_{U}, I_{C} of the control signal 104 are determined, wherein the individual signal portions or current terms I_{U} and I_{C} are correlated with different external influencing factors that differently influence the temporal progress of the control signal 104. Thus, the signal processing device 105 is configured to assign a specific signal portion or current term I_{U} and I_{C} to a specific external influencing factor and to use this to identify and/or classify the respective external influencing factor.

For example, the signal processing device 105 may be configured to determine the membrane deflection, or the time-variant position of the membrane element 101, by means of the signal portion or current term I_{C} since, during movement of the membrane element 101 towards the actuator element 102, the capacitance between the membrane element 101 and the actuator element 102 varies temporally so that the signal portion I_{C} changes.

That being said, the time-variant position of the membrane element 101 also depends on the pressure acting on the membrane element 101 (cf. FIG. 1). Thus, according to embodiments of the invention, the signal processing device 105 is configured, on the basis of the signal portion I_{C}, to determine the pressure acting on the membrane element 101 and to identify the same as the external influencing factor. That is, the pressure acting on the membrane element 101 may be determined on the basis of a signal analysis of the temporal progress of the control signal 104, and in particular on the basis of the signal portion or current term I_{C}.

During the entire movement of the membrane element 101, the capacitance Cₑₗ(t) is increased with the applied voltage U₀, leading to a corresponding current flow. When this current flow is measured in a time-resolved way with the signal processing device 105, the time-resolved position of the membrane element 104 may therefore be inferred directly (in case of a known relationship between position and capacitance)

That is, provided that the relationship between the change of capacitance (=second signal portion I_{c}) and the membrane deflection is known, a deviation from the known signal curve may be interpreted as an external influencing factor in the form of an additional pressure.

Correspondingly, according to embodiments of the invention, the signal processing device 105 initially knows the temporal signal curve of the second signal portion I_{C} without any external inflecting factor. The signal processing device 105 is configured to determine a deviation of temporal signal curve of the second signal portion I_{C} caused by the pressure in contrast to the known temporal progress of the second signal portion I_{C}, and, on the basis of this deviation, to determine the pressure acting on the membrane element 101 and to identify the same as the external influencing factor.

### 6.2 Piezoelectrically-Actuated Membrane Actuator

The piezoelectrically-actuated membrane actuator 100 has already been discussed above in the theoretical part. Here, the actuator element 101 comprises at least one piezo element, e.g., in the form of a piezoceramic, functionally connected, e.g. glued to, the membrane element 101.

For example, when the control signal 104 is applied to the membrane actuator 100, or the actuator element 102, in the form of an alternating voltage signal, the actuator element 102 (e.g. piezoceramic) is deformed due to the inverse piezo effect. Due to this deformation of the actuator element 102, the membrane element 101 accordingly bulges upwards or downwards, i.e., the membrane element 101 is actuated, or deflected, through the same. This makes it possible to open or close a valve, or to carry a suction stroke or a pressure stroke of a micropump.

Now, when an external influencing factor acts on the piezo membrane actuator 100, e.g. through a particle, an air bubble, contact at the valve seat, etc., this leads to a force acting on the membrane element 101, wherein the membrane element 101 then applies a corresponding counter force, or counter pressure (action=reaction). Through this, the piezo actuator element 101 generates a corresponding current or voltage signal, caused by the direct piezo effect. This signal generated by the direct piezo effect overlaps the control signal 104 causing the inverse piezo effect. This overlapping signal caused by external influencing factors then in turn causes the temporal signal curve of the control signal 104 to change. That is, the temporal progress of the control signal 104 is influenced by the external influencing factor so that there is an influenced control signal 104, in the sense of the present disclosure.

Correspondingly, according to the embodiments of the invention, the membrane actuator 100 is a piezoelectrically driven membrane actuator whose actuator element 102 comprises at least one piezo element, wherein the control signal 104 causes deformation of the piezo element by using the inverse piezo effect, by which the piezo element applies an actuation force onto the membrane element 101. The temporal signal curve of the control signal 104 is influenced by a signal that originates from the piezo element, which the piezo element generates due to a counter force of the membrane element 101 on the basis of the direct piezo effect.

For example, a pressure change under the piezo membrane actuator 100 leads to an action of force, and, due to the direct piezo effect, to a current flow to the piezoceramic caused only by the pressure change. In the context of the present disclosure, this current flow is also referred to as a “sensor current”.

In a piezoelectrically driven membrane actuator 100, the sensor current may comprise the following four different signal portions or current terms (cf. [Equation 4]).

$$I = \frac{d Q}{d t} = {I}_{U} + {I}_{C} + {I}_{c e} + {I}_{p} = {C}_{e l} \cdot \frac{d U}{d t} + ( U - {U}_{0} ) \cdot \frac{d {C}_{e l}}{d t} + ( p - {p}_{0} ) \cdot \frac{d {C}_{E}^{*}}{d t} + {C}_{E}^{*} \cdot \frac{d p}{d t} \qquad [ Equation 4 ]$$

Thus, compared to the electrostatically driven membrane actuator 100, two further signal portions or current terms I_{ce}, Iₚ are added in case of the piezoelectrically driven membrane actuator 100. While the two signal portions or current terms I_{U}. I_{C} are essentially caused by the electrical capacitance and occur in the electrostatically and the piezoelectrically driven membrane actuator 100, the two signal portions or current terms I_{ce}, Iₚ are essentially attributed to the piezo effect and therefore only occur in the piezo-actuated membrane actuator 100. In the piezo-actuated membrane actuator 100, the capacitive current term I_{C} at least partially depends on the piezo effect since the change of capacitance is here caused by large signal effects of the piezoceramic (actuator element 102).

Here, it is again the case that the individual portions or current terms I_{U}, I_{C}, I_{ce}, Iₚ are correlated with different external influencing factors that differently influence the temporal progress of the control signal 104.

Correspondingly, according to embodiments of the present invention, the signal processing device 105 is configured to perform a signal analysis of the temporal signal curve of the control signal 104 for determining and/or classifying the at least one causal external influencing factor, wherein individual signal portions are I_{U}, I_{C}, I_{ce}, Iₚ of the control signal 104 are determined, wherein the individual signal portions I_{U}, I_{C}, I_{ce}, Iₚ are correlated with different external influencing factors that differently influence the temporal progress of the control signal 104. The signal processing device 105 is configured to allocate a certain signal portion to a certain external influencing factor and to use the same to identify and/or classify the respective external influencing factor.

According to an embodiment of the invention, the signal processing device 105 may therefore be configured to at least differentiate the above-mentioned four different signal portions or current terms I_{U}, I_{C}, I_{ce}, Iₚ of the influenced control signal 104, wherein
the first signal portion I_{U} is essentially linked to a temporal change of the electric voltage when charging or discharging the capacitance between the membrane element 101 and the piezo actuator element 102,
the second signal portion I_{P} is essentially linked to a temporal change of a pressure acting on the membrane element 101, and is also proportional to the piezo coupling factor C_{E}*,
the third signal portion I_{C} is essentially linked to a temporal change of the electrical capacitance caused by large signal effects of the piezo actuator element 102, and
the forth signal portion I_{ce} is essentially linked to a temporal change of the piezo coefficient d31 that changes due to large signal effects in the piezo actuator element 102, and that it is also proportional to the temporal change of the pressure acting on the membrane element 101.

As described above in the theoretical part, each of these individual signal portions I_{U}, I_{C}, I_{ce}, Iₚ strives to achieve a state of balance through an individual temporal compensation process, wherein, during the respective temporal compensation process, each signal portion comprises an individual temporal amplitude curve I_{U0}, Iₚ₀, I_{c0}, I_{ce0} (cf. e.g., FIG. 13) as well as an individual time constant □ₐ, □ₕ, □_{d}=□_{c}=□_{piezo} (cf. e.g., FIG. 14) within which the temporal compensation process takes place.

Correspondingly, according to embodiments of the invention, the signal processing device 105 is configured to determine the external influence on the basis of the respective amplitude curve I_{U0}, Iₚ₀, I_{c0}, I_{ce0} and/or the respective time constant □ₐ, □ₕ, □_{d}=□_{c}=□_{piezo} from one or more of the individual signal portions I_{U}, I_{C}, I_{ce}, Iₚ.

### 6.3 Evaluation and Interpretation of Measurements for Determination of External Influencing Factors

The subsequent section describes the determination of external influencing factors using specific series of measurements performed with a piezo-actuated membrane actuator 100. From the above discussions, it is clear that these results are also valid for electrostatically actuated membrane actuators 100.

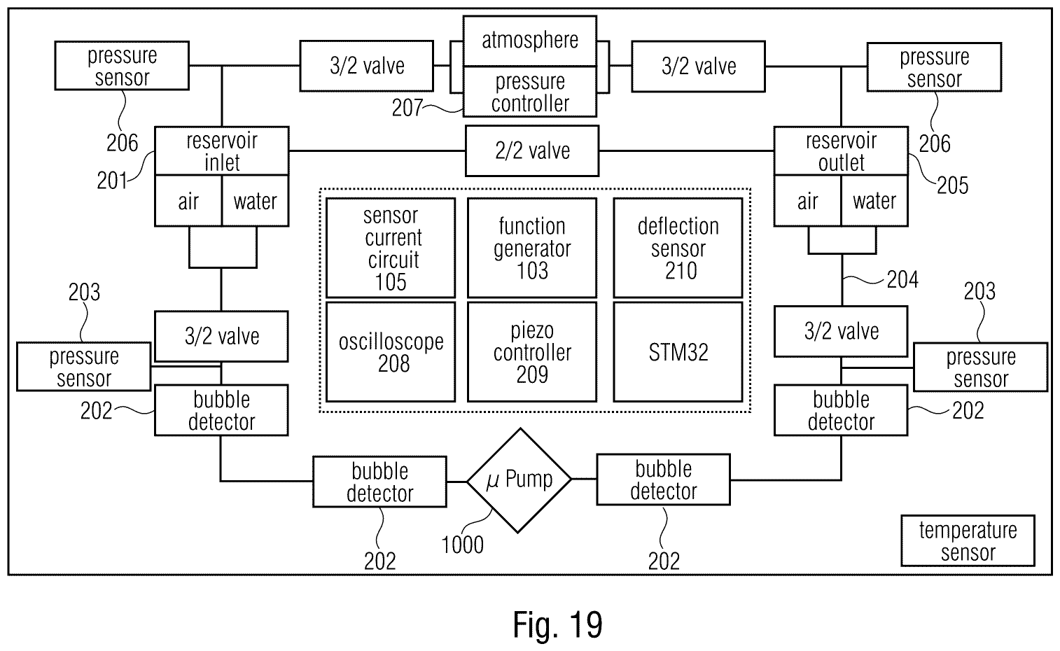

To begin with, FIG. 19 schematically shows the measuring station used. The same comprises an inventive microfluidic component 1000 in the form of a micro membrane pump. The micro membrane pump 1000 comprises an inventive membrane actuator (not illustrated) 100 with a membrane element 101 and an actuator element 102.

In an inlet-side reservoir 201, air and water may be selected as the medium or fluid to be conveyed. In the clockwise direction, two bubble detectors 202 and one pressure sensor 203 are arranged in front of the micropump 1000 (upstream). Behind the micropump 1000 (downstream), there are also two bubble detectors 202 and one pressure sensor 203. Via the illustrated lines 204, the micropump 1000 conveys the fluid into the outlet-side reservoir 205. Further sensors are arranged between the two reservoirs 201, 205, such as further pressure sensors 206 and a pressure controller 207 for monitoring and adjusting a normalized atmospheric pressure.

The entire logic is schematically illustrated in the middle of FIG. 19. The same includes the signal generation device 103 as well as the signal processing device 105. The signal generation device 103 may comprise a functional generator configured to generate different input functions (step function, Dirac function, sinusoidal signals, rectangular signals, etc.) as a control signal 104. Furthermore, the logic may comprise an oscilloscope 208 so as to determine the (influenced) control signal 104. In addition, the logic may comprise a piezo controller 209 for controlling and monitoring the piezo actuator element, as well as a deflection sensor 210 that monitors the deflection of the membrane element.

Using the schematically illustrated hardware, the following may be performed:
Measurement of ambient pressure, temperature, humidity,
Change between water and air as medium to be conveyed,
Injection of bubbles to simulate an external influencing factor (disturbing factor),
Detection of bubbles with the bubble sensor,
Time-dependent detection of the membrane stroke of the micropump,
Counter pressure sender for water and air (switchable),
(Optional) measurement of the conveyer rate in the inlet and outlet paths with anemometric flow sensors,
(Optional) measurement of the conveyer rate with differential pressure sensors

With this, the following can be controlled:
Micropumps with any control or voltage signal (e.g. rectangular or sinusoidal voltage) and/or
Switching valves so as to switch between water and air operation, or to inject gas bubbles of different sizes.

In addition, a primary or counter pressure variation is possible.

Using the schematically illustrated measuring station, a time-resolved measurement of the following can be carried out:
Sensor current for suction and pressure strokes with sensor current electronics,
Actuator stroke for suction and pressure stroke,
Bubbles by means of bubble sensors,
(Optional) flow rates.

The following series of measurements were performed, which will be described in more detail in the following with reference to the drawings:
“normal state” with air, 10 Hz, control signal: rectangular,
“normal state” with water, 10 Hz, control signal: rectangular,
water with air bubble, 10 Hz, control signal: rectangular,
water with counter pressure, 10 Hz, control signal: rectangular,
air with bias pressure, 10 Hz, control signal: rectangular, and
contact at the pump chamber bottom, control signal: sinusoidal voltage, trajectories

The temporal progress of the control signal 104 was measured, which will be shown in the following drawings. This will explain how the temporal progress of the control signal 104 varies upon presence of external influencing factors (compared to the “normal state” without any external influencing factors). As described in the above theoretical part, the control signal 104 may comprise up to four different signal portions or current terms I_{U}, I_{C}, I_{ce}, Iₚ, subsequently considering as an example the current term Iₚ, which is proportional to the pressure below the membrane element (or pump chamber pressure) as well as proportional to the piezo coefficient C_{E}*. This current term Iₚ is also referred to as the sensor current in the subsequent figures. The subsequent discussion of the signal portion Iₚ can be applied analogously to the other signal portions or current terms I_{U}, I_{C}, I_{ce}.

In addition, the control signal measured also captures fluidic effects that cannot be derived from the simplified model of overlapping exponential compensation processes.

For example, the inlet value may be excited to oscillate in its mechanical natural frequency (eigenfrequency), leading to pressure oscillations in the pump chamber. These pressure oscillations overlap in the decaying pressure and are captured with the term Iₚ, wherein an oscillation overlaps the decay process.

“Fluidic resonances” are a further example. It has been known for a long time that the inertia of the liquid in the inlet and outlet lines can be coupled into the micropumps under certain constellations. Citation:
“Simulation of microfluid systems”; Zengerle, R., Richter, M.; Journal of Micromechanics and Microengineering; 1994, 4(4). pp. 192-204, 004

When the micropump is active, it is not only the liquid in the pump chamber that has to be move, but also the liquid column behind the open valve since liquid cannot be compressed. This inertia of the liquid tubes in the inlet and outlet may be described in a coarse model by means of a “fluidic inertance” L_{fluidic}, which is defined as being fully analogous to an electrical inductance. This fluidic inertance represents together with the fluidic capacity of the drive membrane Cₚ a system that can oscillate, with the fluidic resonance frequency

$$f = \frac{1}{2 π \sqrt{{L}_{fluidic} \cdot {C}_{p}}} .$$

The oscillations that are possible therethrough lead to oscillations of the pump chamber pressure, which was shown both theoretically and as an experiment in the above-mentioned publication of 1994.

This fluidic coupling can be decoupled by providing pressure smoothing elements directly in front of and behind the pump, as already described in 1994. However, these additional elements are only advantageous in certain applications, the fluidic resonances often do not interfere with the pump operation.

All of these effects overlap the previously described “normal” exponential compensation processes and therefore provide additional information about the state of the valve flap and even about the periphery outside of the micropump.

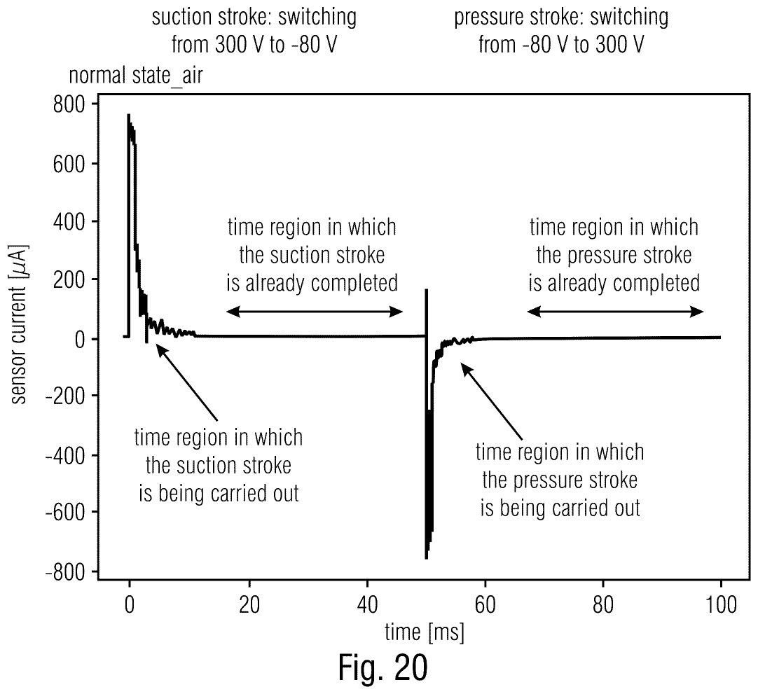

To begin with, FIG. 20 shows the case of a “normal state” with air, wherein the pump frequency is 10 Hz and the control signal is rectangular. Here, a total of ten measuring curves was recorded and overlapped. The measuring curves appear to be almost identical and characterize the normal state, i.e. without any external influencing factors.

Air was used as the pump medium, and the micropump 1000 was operated without counter pressure. A rectangular voltage with a time constant [symbol] <<1 ms and a frequency off 10 Hz (┘_{A}=┘ₐ) was used as the control signal 104.

FIG. 20 shows the suction stroke on a time scale or between 0 ms and approximately 10 ms. What follows thereafter is a time region in which the suction stroke is already fully completed (between approximately 10 ms and 15 ms). The pressure stroke starts at 50 ms. The time region in which the pressure stroke is carried out extends to approximately 65 ms on the time scale. Subsequently, there a time region up to 100 ms in which the pressure stroke is already fully completed. Then, the next suction stroke (not illustrated here) starts at 100 ms. In this normal state, in addition to the expected exponential compensation (with fluidic information about ┘ₕ), oscillations of the valve flap can be observed. Since air has a lower density than water by the factor of 100 and a lower viscosity than water by the factor of 50, the valve flap may oscillate. Furthermore, the air in the lines in front of and behind the pump has such a low mass and such a high fluidic capacity that fluidic resonances cannot be observed when pumping air.

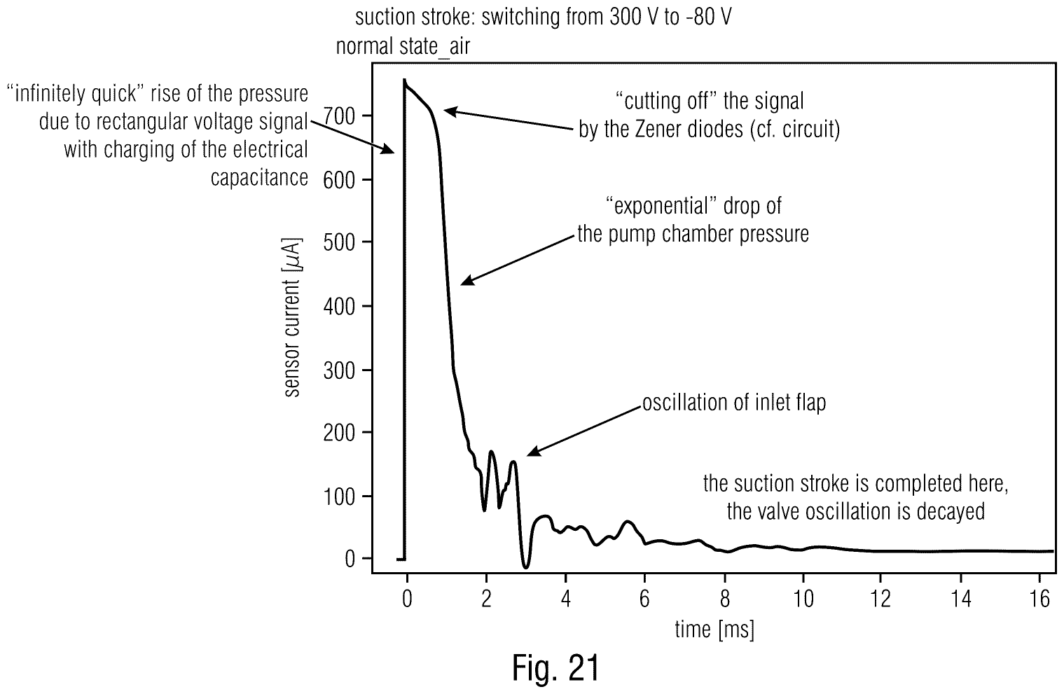

FIG. 21 shows a detailed view of a temporal signal curve in the suction stroke (with air as the pump medium) in the normal state, i.e. without any external influencing factors. To begin with, the signal curve comprises an abrupt rise, resulting from the rectangular control signal 104, with the capacitance of the piezo charging. This abrupt rise is cut off in the signal curve, due to the Zener diodes 111, 112 of FIG. 4. The signal curve decays exponentially, i.e. the pump chamber pressure decreases exponentially. At the end of the decay process, there are oscillations that result due to oscillations of the inlet flap. In the range starting from approximately 10 ms, the suction stroke is fully completed and the valve oscillation is decayed. The decay rate of this oscillation can also provide information about the geometry of the valve flap and the contact ridge.

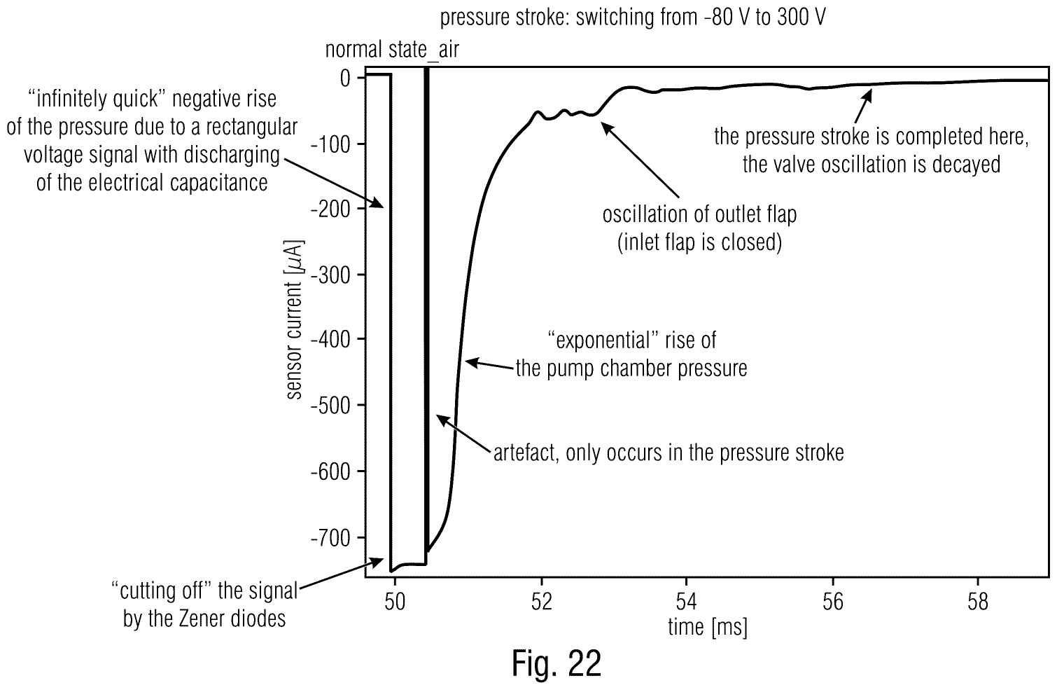

FIG. 22 shows a detailed view of the temporal signal curve in the pressure stroke (with air as the pump medium) in the normal state, i.e. without any external influencing factors. To begin with, the signal curve again comprises an abrupt (negative) rise, resulting from the rectangular control signal 104, with the capacitance of the piezo discharging. This abrupt rise is cut off in the signal curve, caused by the Zener diodes 111, 112 of FIG. 4. What follows is an artifact that only occurs in the pressure stroke and can disregarded for the time being. Subsequently, the signal curve also decays exponentially, i.e. the pump chamber pressure increase exponentially. Toward the end of the decay process, there are oscillations that result due to oscillations of the outlet flap. In the range starting at approximately 56 ms, the pressure stroke is fully completed and the valve oscillation is decayed.

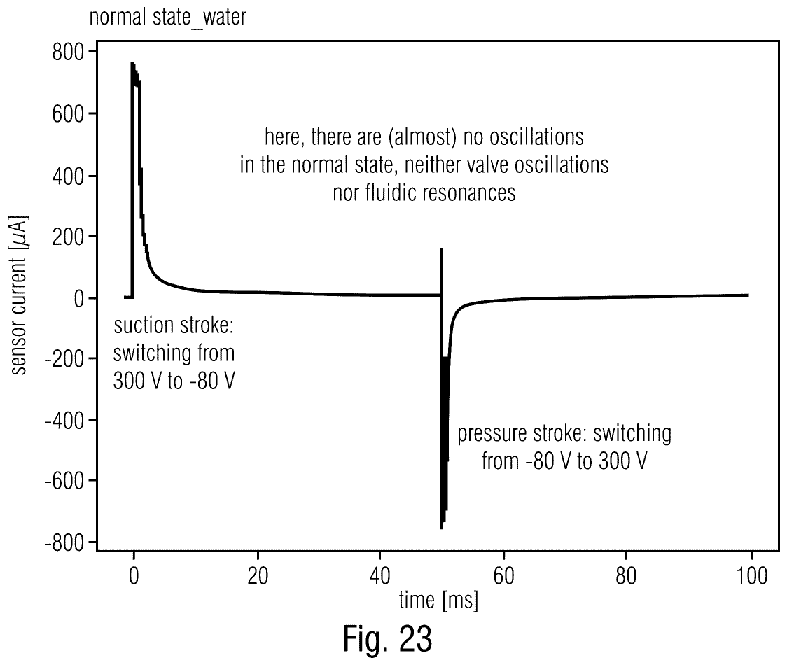

FIG. 23 shows the case of a “normal state” with water that is free of bubbles, a pump frequency of 10 Hz and a rectangular control signal. A total of 90 measuring curves was recorded and overlapped. The measuring curves appear to be almost identical and characterize a normal state, i.e. without any external influencing factors.

Water was used as the pump medium, and the micropump 1000 was operated without any counter pressure. A rectangular voltage with a time constant [symbol] and a frequency of f=10 Hz was used as the control signal 104.

FIG. 23 shows the suction stroke on the time scale between 0 ms and approximately 10 ms. What subsequently follows is a time region in which the pressure stroke is already fully completed (between approximately 10 ms and 50 ms). The pressure stroke starts at 50 ms. The time region in which the pressure stroke is carried out extends to approximately 57 ms on the time scale. What subsequently follows is a time region up to 100 ms in which the pressure stroke is already fully completed. The next suction stroke starts at 100 ms (not shown here).

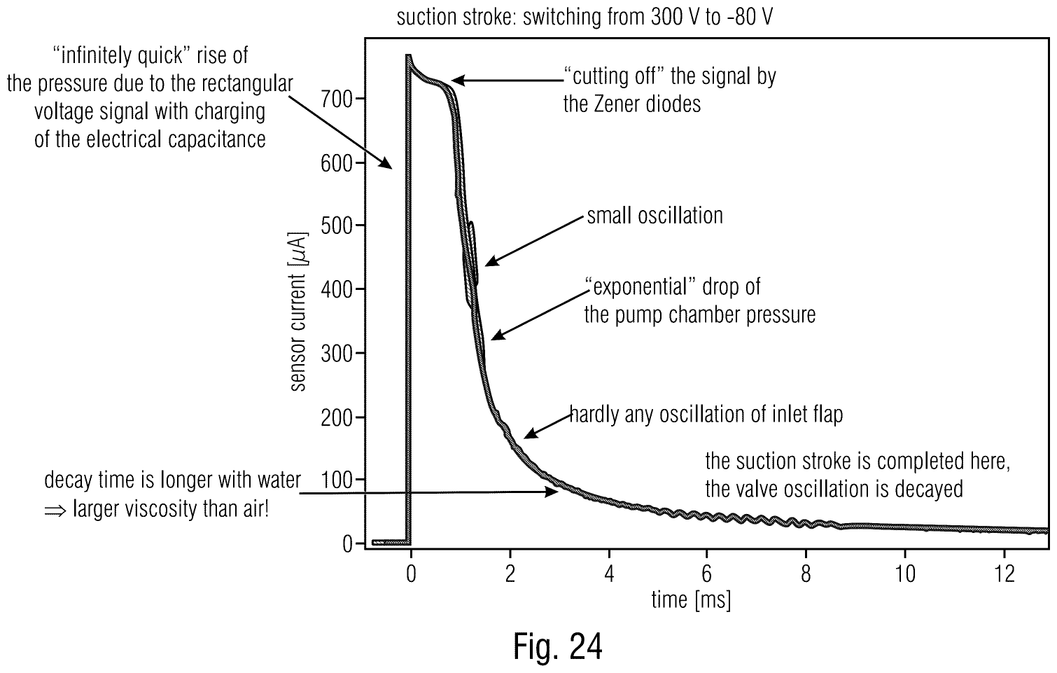

FIG. 24 shows a detailed view of the temporal signal curve in the suction stroke (water being the pump medium) in a normal stage, i.e. without any external influencing factors. First, the signal curve comprises an abrupt rise, resulting from the rectangular control signal 104, with the capacitance of the piezo charging. This abrupt rise is cut off in the signal curve, caused by the Zener diodes, 111, 112 of FIG. 4. The signal curve decays exponentially, i.e. the pump chamber pressure also decreases exponentially, wherein a small oscillation occurs in the region of approximately 1.5 ms, which will be discussed in more detail later on. Toward the end of the decay process, with water being the pump medium, there are hardly any oscillations of the inlet flap. Water has a higher viscosity than air by the factor of 50, by which these oscillations are damped much more strongly. In the region starting at approximately 6 ms, the suction stroke is fully completed and the valve oscillation is decayed.

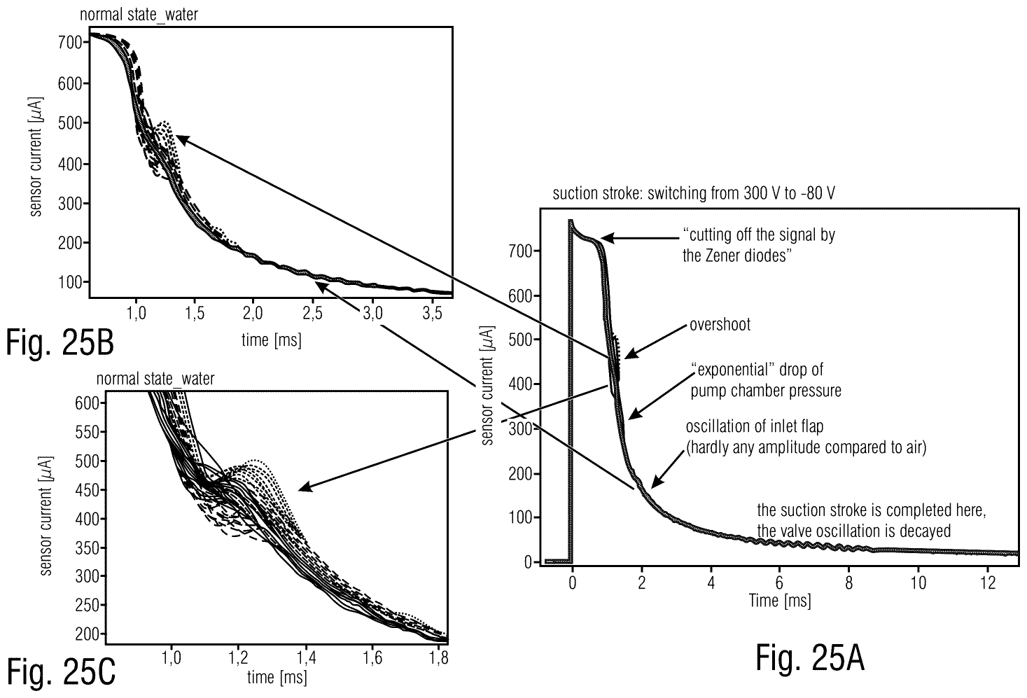

FIGS. 25A, 25B and 25C show detailed views of the previously mentioned overshoot in the exponential decay process, wherein FIG. 25A corresponds to the previously discussed FIG. 24, FIG. 25B shows an enlarged illustration of the overshoot, and FIG. 25C shows a further enlarged view.

As initially mentioned, 90 curves were superimposed here. The originally submitted documents of this application were originally colored and contained a color coding of the individual measuring curves. This color coding represents the recording times of the individual measuring curves, i.e. the time at which a respective measuring curve was recorded (relative to the other measuring curves). According to this color coding, the measuring times extend starting with yellow tones, through green tones, to blue tones and purple tones. That is, the measuring curves having yellow tones were recorded first, the measuring curves with green tones were recorded subsequently, the measuring curves with blue tones were recorded thereafter, and the measuring curves with purple tones were recorded at the end. In addition, this color coding was used for all figures discussed in this section.

For example, FIGS. 25B and 25C show that the measuring curves spaced apart the furthest from the actual exponential function (purple), as illustrated in FIG. 25, were recorded first (yellow tones). With an increasing measuring duration, the individual measuring curves approximate the curve of the exponential function, i.e. the color code gradient moves towards the inside in the direction of the exponential function of FIG. 5 with increasing measuring times. This overshoot is presumably due to fluidic resonances and/or degassing and/or cavitation.

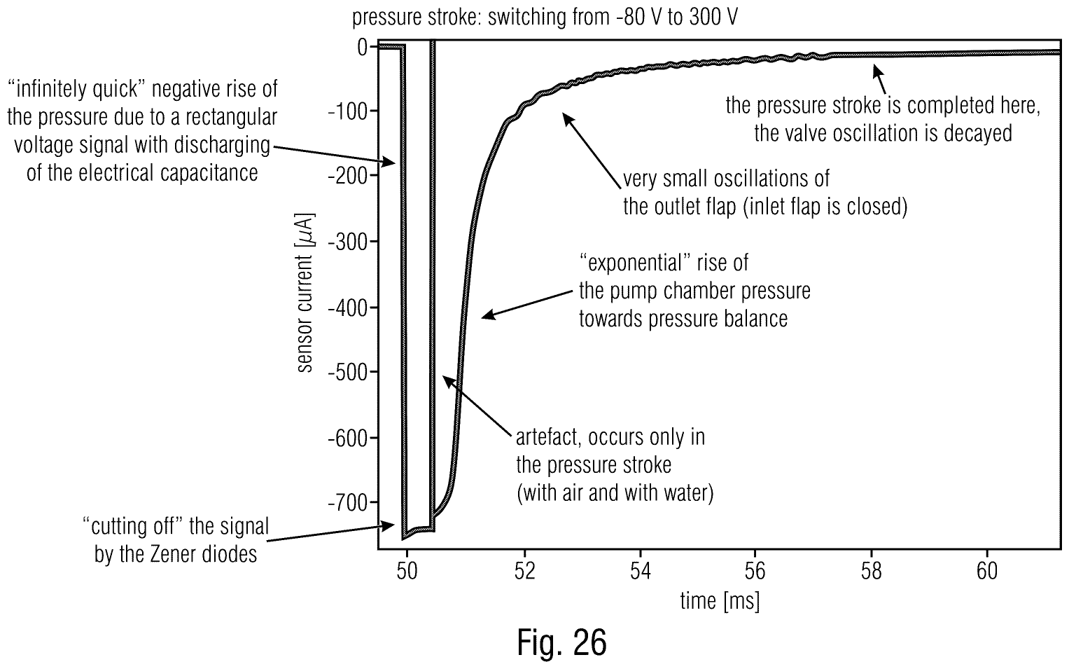

FIG. 26 now shows a detailed view of the temporal signal curve in the pressure stroke (with water being the pump medium) in a normal state, i.e. without any external influencing factors. To begin with, the signal curve again comprises an abrupt (negative) rise, resulting from the rectangular control signal 104, with the capacitance of the piezo discharging. This abrupt rise is cut off in the signal curve, caused by the Zener diodes 111, 112 of FIG. 4. What follows is an artefact that again occurs only in the pressure stroke and can be disregarded for the time being. Subsequently, the signal curve again decays exponentially, i.e. the pump chamber pressure increases exponentially up to the pressure equalization with the external pressure (e.g. atmospheric pressure). Toward the end of the decay process, there are only very small oscillations that result due to oscillations of the outlet flap. In the region starting at approximately 54 ms, the pressure stroke is here again fully completed and the valve oscillation is decayed.

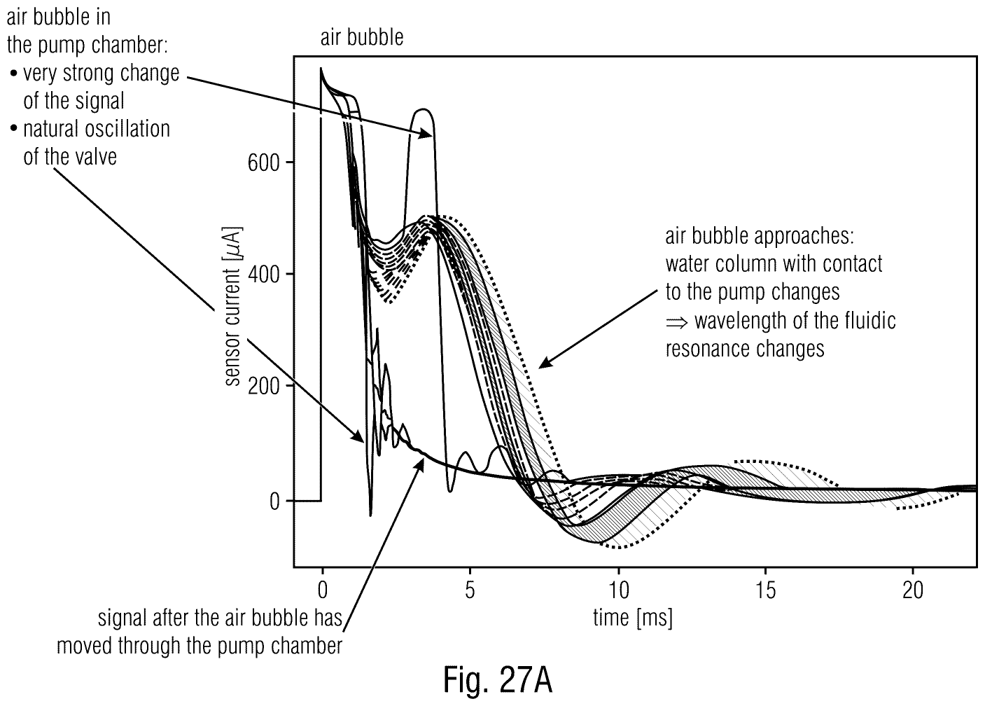

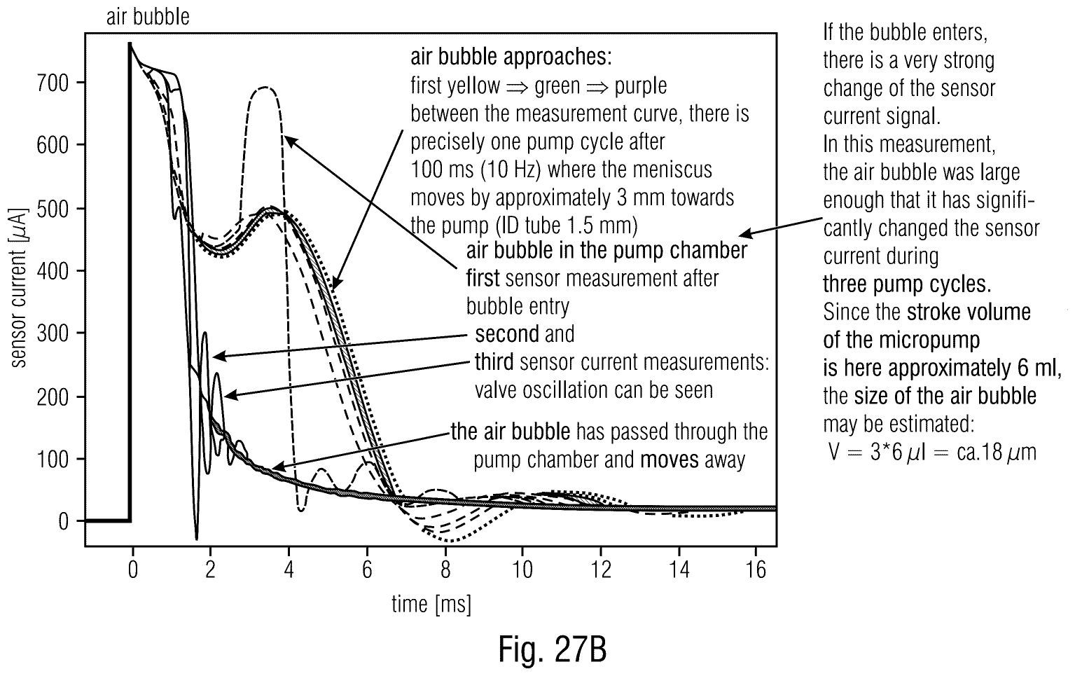

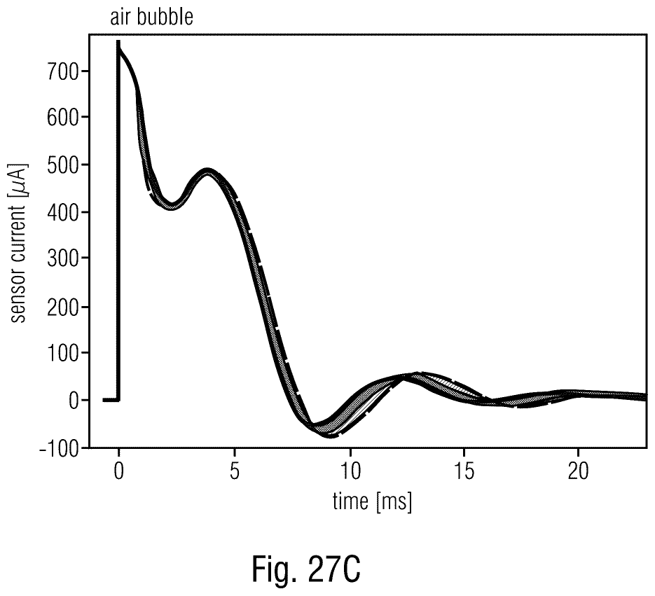

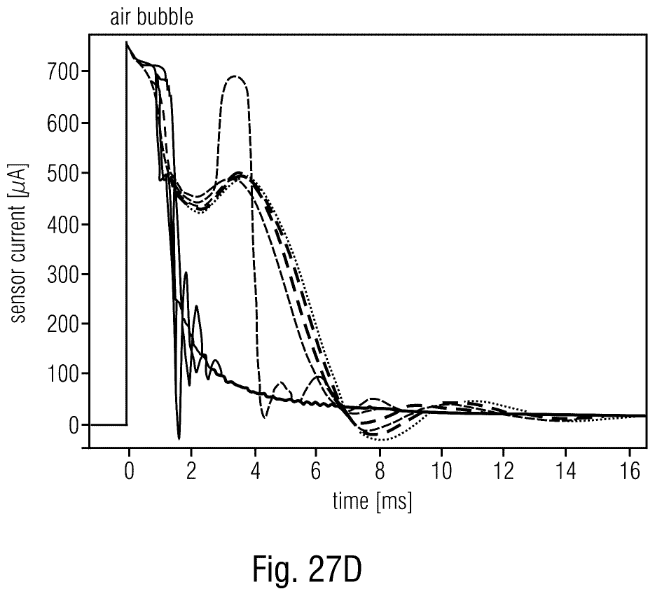

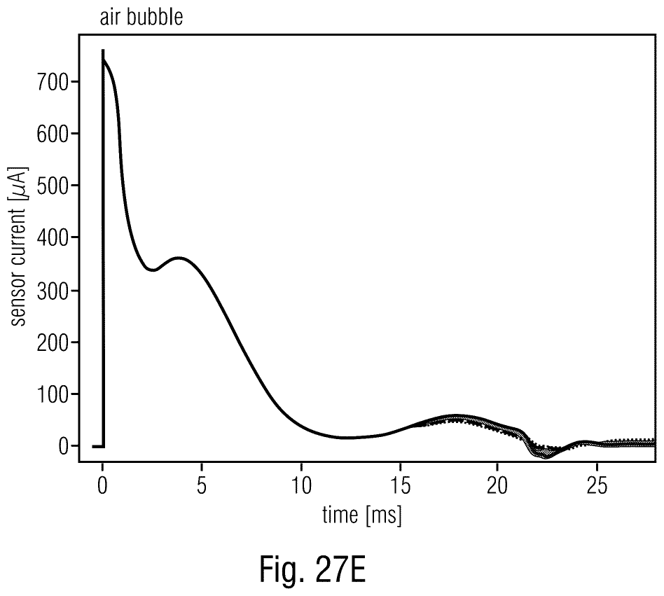

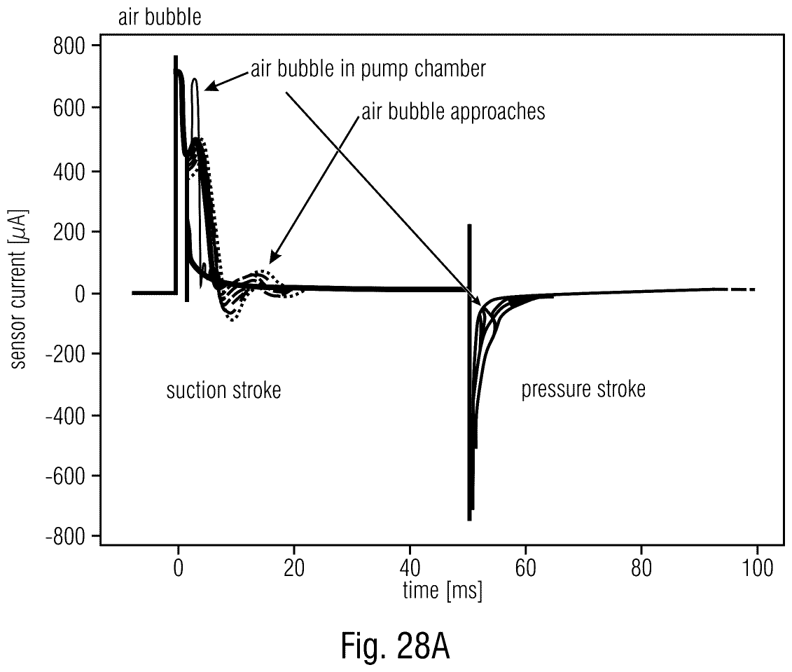

FIGS. 27A and 27B now show a case in which a disturbance variable in the form of an air bubble is added. This air bubble corresponds to an external influencing factor changing the temporal progress of the control signal 104. FIGS. 27A and 27B show the inventive detection of an air bubble in a suction stroke.

The micropump was operated with a pump frequency of 10 Hz, and a rectangular voltage was used as the control signal. The pump medium was water, and an air bubble was introduced into the system. In FIGS. 27A and 27B, 30 measuring curves were superimposed, wherein twenty suction strokes were recorded prior to the entry of the bubble into the pump chamber, three suction strokes while the bubble was located in the pump chamber, and seven further suction strokes during which the bubble moved away from the pump chamber. The above-mentioned color coding was use here as well again.

To begin with, it can be seen that the temporal signal curve changes significantly when the air bubble approaches the pump chamber. This leads to a significant deviation in comparison to the exponential decay process in the normal state (FIG. 24). Here, (FIG. 27B) a significant overshoot can be seen in the region from approximately 4 ms to 5 ms, as well as at approximately 8 ms and 11 ms. At this point, it is to be noted that all time indications given herein are purely exemplary to describe the temporal signal curve, since the present patent application cannot use colored drawings and can therefore also not use color coding.

This overshoot results from the water column in contact with the pump changing due to the air bubble. This changes the wave length of the fluidic resonance.

As soon as the air bubble enters the pump chamber, the temporal signal curve changes significantly. There is a very clear spike, or a very clear deviation from the exponential decay function in the normal state (FIG. 24), in the region of approximately 4 ms. In this regard, reference is made to FIG. 27b and the label “first sensor current measurement after bubble entry” illustrated.

In addition, increased natural oscillations of the valve can be seen in the subsequent second and third sensor current measurements during which the bubble is still located in the pump chamber. Since low-viscosity air is now temporarily located in the pump chamber, the valve flaps can now oscillate, which is represented in the measured signal.

If the pump chamber contains air, surface forces act on the pump membrane and on the valve flaps. For example, these surface forces may lead to the valves no longer being able to move freely. The drive membrane can also experience asymmetrical stress, depending on where a meniscus is located. All of this affects the pressures in the pump chamber. Since it is not possible to predict how exactly the bubble will move through the pump chamber, the behavior of the signal seems to be chaotic.

As soon as the air bubble exits the pump chamber and moves away, the temporal signal curve again approximates the exponential decay function in the normal state (FIG. 24). Here, the more the air bubble moves away, the stronger the signal curve approximates the exponential decay function.

FIGS. 27C, 27D, and 27E now additionally again show the situations, or signal curves, with a longer lead time for the arrival and departure of the air bubble. First, FIG. 27C shows the temporal signal curve of the control signal during ten suction strokes prior to entry of the bubble. FIG. 27D now shows the signal curve, previously discussed with reference to FIGS. 27A and 27B, directly prior to entry of the bubble, during passage of the bubble, as well as directly after the exit of the bubble out of the pump chamber. FIG. 27E finally shows the signal curve during ten suction strokes in which the bubble moves away further and further.

As can be clearly seen in FIGS. 27A to 27E, the occurrence of air bubbles or gas bubbles in liquid-conveying microfluidic components leads to a significant change of the temporal signal curve of the control signal. This is an external influencing factor that can be detected according to the inventive concept described herein. Each external influencing factor, same as the exemplarily described gas bubble, leads to a characteristic deviation in the temporal signal curve, i.e. each external influencing factor leaves an individual fingerprint in the temporal progress of the control signal, which can be detected by means of the inventive concept described herein.

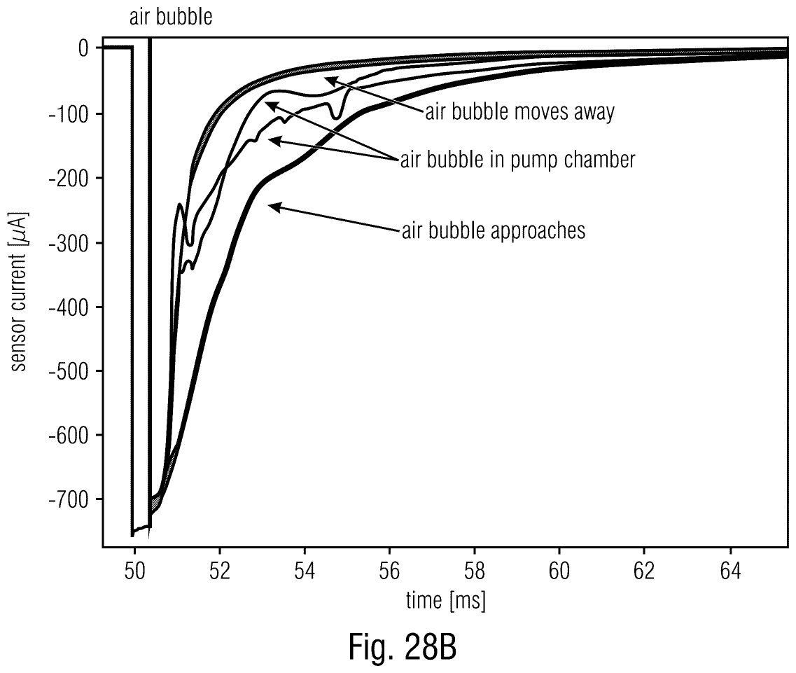

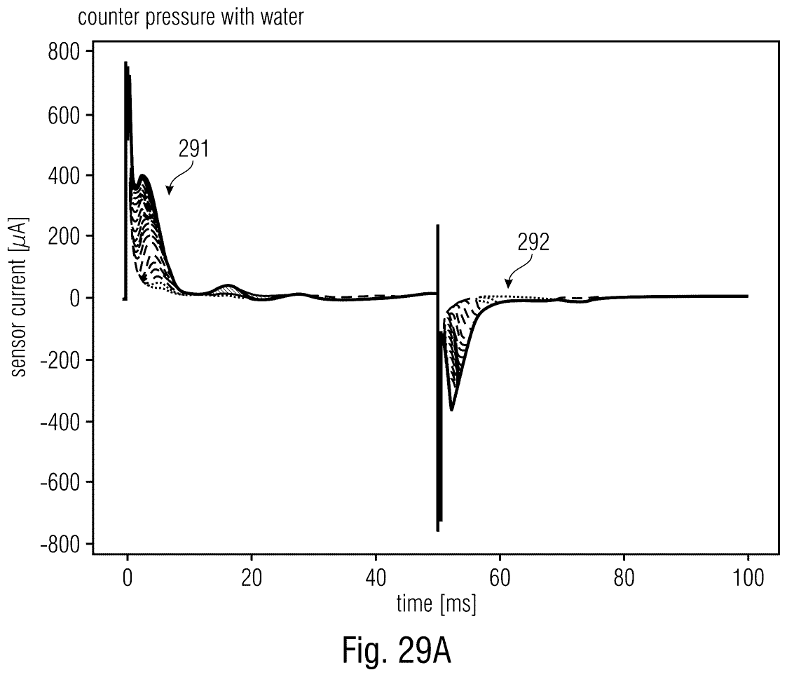

FIGS. 28A and 28B show, purely for the sake of completeness, that such a characteristic fingerprint cannot only be determined in the suction stroke, as just described with reference to FIGS. 27A to 27E, but also in the pressure stroke, even though the fingerprint in the pressure stroke can be significantly less distinct.

In summary, these experiments show that the entry of gas bubbles into the pump chamber can be detected very clearly. This is of extreme practical relevance for many micropump applications: e.g. the size of the gas bubble can be estimated pretty easily using the number of the pump strokes indicating the bubble entry and the stroke volume of the micropump. In the present case, the stroke volume was approximately 6 μl and the number of pump cycles was 3, thus, the gas bubble volume was approximately 6 μl*3=18 μl. Above all, this volume estimation of a gas bubble is useful in the dosage of medication, since very small gas bubbles are medically harmless, whereas larger gas bubbles have to be avoided at all costs.

In addition, a gas bubble also represents a significant disturbance with respect to the dosage accuracy. When the size of the gas bubble is known, the disturbance of the dosage accuracy can be detected and compensated by suitable measures. For example, when a gas bubble with the size of 18 μl (where it is medically harmless when they reach the patient in infusions) is detected and quantified, the dosage does not have to be cancelled with an error message (depending on a medical application), but can continue. Then, the control of the micropump can carry out three additional strokes, so that the previously planned amount of medication reaches the patient. The number and size of gas bubbles can then be noted in an error protocol.

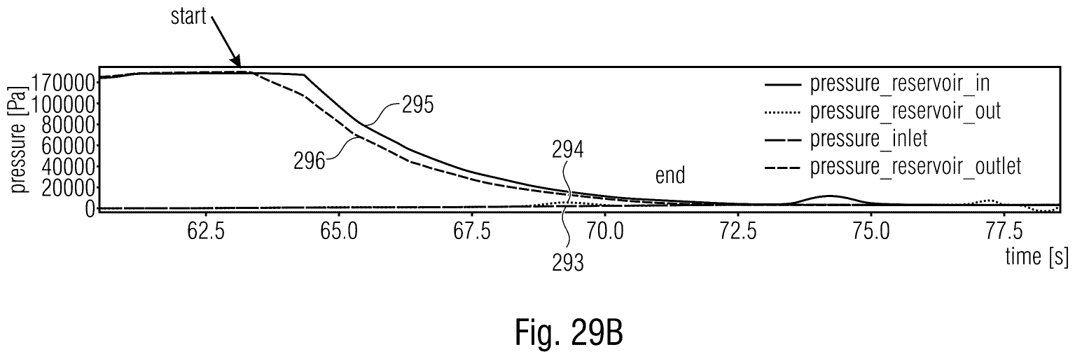

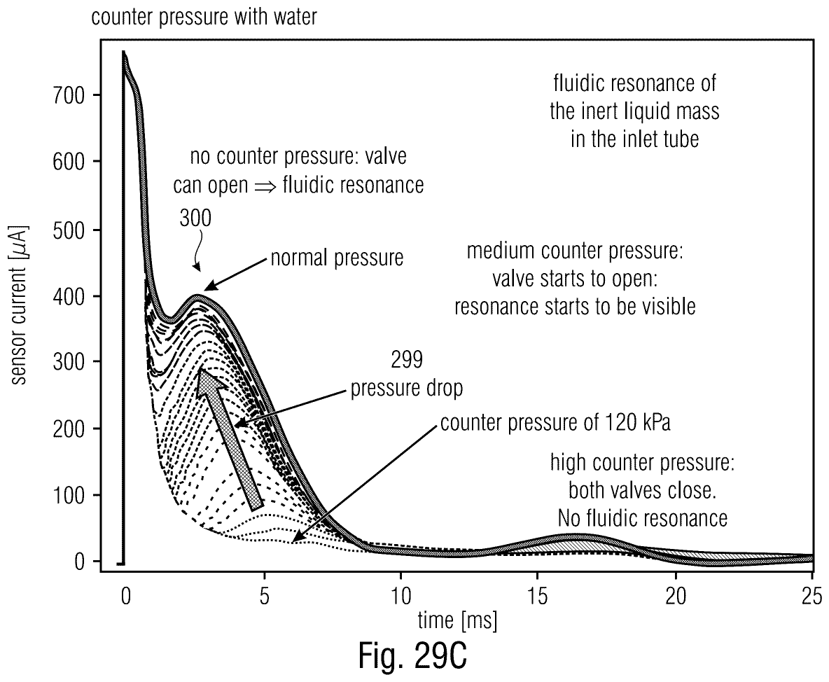

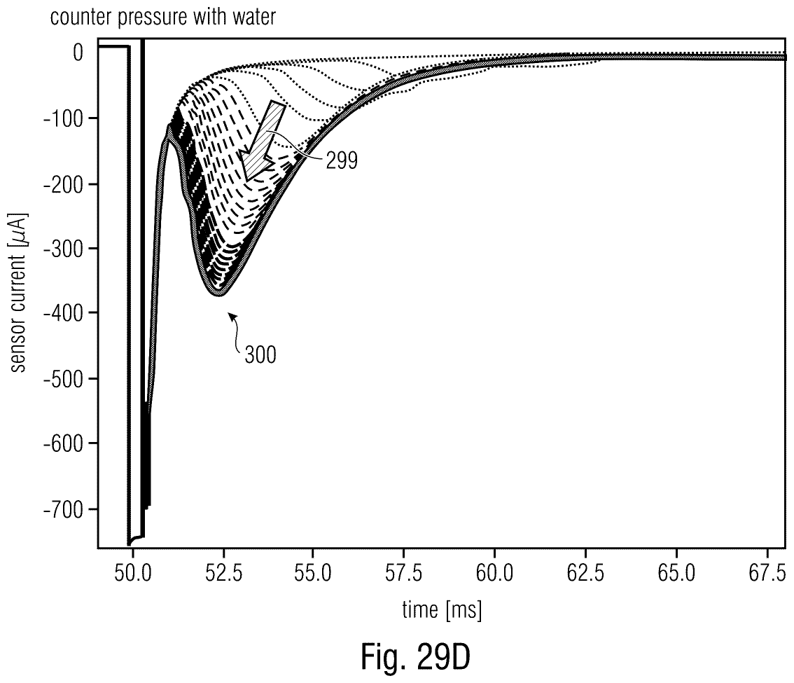

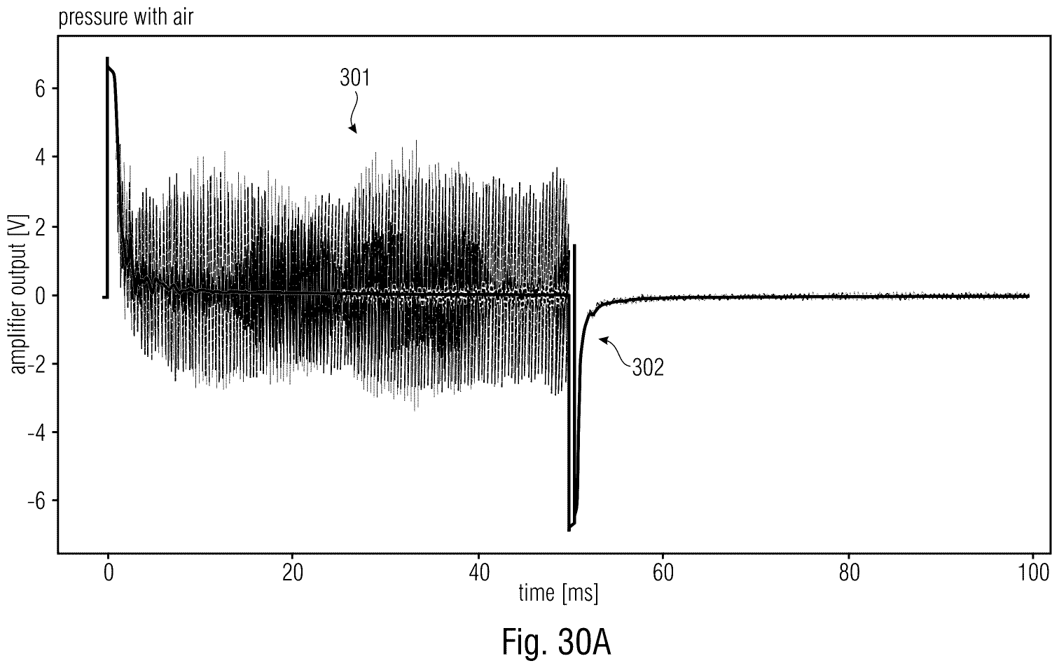

FIGS. 29A to 29D show a further case of detectable external influencing factors, in this case a counter pressure in a liquid-conveying micropump. For example, such micropumps can be used in medication dosage systems. Here, a closure of a catheter may occur, which have important consequences for the patient since the medication can no longer be dosed properly. For example, such as closure of a catheter can generate the mentioned counter pressure corresponding to the blockage pressure of the micropump (the blockage pressure is the micropump's maximum pressure that it can create with liquid being the pump medium). FIG. 29A first shows an overview of the effects of counter pressures with respect to the temporal signal curves in the suction stroke 291 and in the pressure stroke 292.

The measuring curve illustrated in FIG. 29B shows the applied counter pressures. A starting pressure of 120 kPa was used at the beginning, and the pressure was continuously reduced in the course of approximately 10 seconds up to 0 kPa. Measuring curve 293 shows the pressure at the inlet-side reservoir 201 (FIG. 19), measuring curve 294 shows the processor at the outlet-side reservoir 205 (FIG. 19), measuring curve 295 shows the pressure at the pump inlet, and measuring curve 296 shows the pressure at the pump outlet.

FIG. 29C now shows an enlarged section of FIG. 29A, with the pressure curve in the suction stroke being illustrated here. Several measuring curves recorded in the course of the controlled pressure decrease (FIG. 39B) are here again superimposed. The color coding was again used, i.e. the curves with the yellow tones were recorded at the beginning (pressure: 120 kPa), and the curves with the blue and purple tones were recorded towards the end (pressure: 0 kPa).

It can be seen that the measuring curve, at the applied starting pressure of 120 kPa, approximately corresponds to the exponential decay process in the normal state (FIG. 24). Here, there is a high counter pressure. The inlet valve and the outlet valve are closing and there is no fluidic resonance.

With an increasing pressure decrease, illustrated by the arrow 299, the measuring curves move upwards and form a clearer and clearer overshoot 300. With such a medium counter pressure, the valve starts to open and a fluidic resonance becomes visible, which can be seen in the form of the ever increasing overshoot 300.

The overshoot 300 can be seen most clearly in the normal pressure, i.e. at the end of the measuring cycle at 0 kPa. Thus, if there is no more counter pressure, the valve can open in an unobstructed way and there is fluidic resonance, which is then expressed in the previously-mentioned significant overshoot 300.

FIG. 29D illustrates the measuring curves in the pressure stroke. Here, with a decreasing pressure, illustrated by the arrow 299, there is an increasingly clear overshoot 300. The reasons for this are identical to the above-mentioned reasons in the suction stroke.

As can be clearly seen in FIGS. 29A to 29B, different counter pressures in liquid-conveying microfluidic components lead to a significant change of the temporal signal curve of the control signal. This is an external influencing factor that can be detected according to the inventive concept described herein. Each external influencing factor, same as the counter pressures exemplarily described here, leads to a characteristic deviation in the temporal signal curve, i.e. each external influencing factor leaves an individual fingerprint in the temporal progress of the control signal, which may be detected by means of the inventive concept described herein.

The measurement of pressure changes, both in the inlet line as well as in the outlet line, can therefore be detected by a suitable means for signal evaluation. In turn, this is of significant practical relevance. For example, pressure sensors are installed in medication dosage systems in the outlet path so as to detect a closure of a catheter. This additional component may be replaced by the inventive “self-sensor system” of the microfluidic component 1000 described herein.

Furthermore, slow pressure changes can be detected as well. The closure of a patient's access can take place gradually, causing a slow pressure increase in the outlet line. In the future, pressure sensors should be utilized to better determine the wearing time of wearable pump systems. Patch pumps, which are not able to predict this, are often used for much shorter periods of time to avoid this risk. A prediction enables a longer wearing time and has significant economic advantages. The inventive prediction of a slow pressure increase with the inventive “self-sensor system” of the micropump can be carried out, e.g., by the measured signal being stored in larger intervals and by comparing the same with respect to changes, such as in FIG. 29C.

FIGS. 30A to 30E show a further conceivable case that can be detected by means of the inventive concept described herein—a pressure that has been generated. For example, the same may occur when the patient presses the dosage bag so that there is a higher pressure at the pump inlet. This can also lead to significant consequences for the patient with respect to the dosage of the medication. Usually, this process is avoided with a safety valve, but this can also fail in the event of a fault.

To begin with, FIG. 30A again shows an overview of the effects of different pressures with respect to the temporal signal curve in the suction stroke 301 and the pressure stroke 302. The measurements were carried out with an air-conveying micropump driven with a sinusoidal control signal. The pump frequency was 10 Hz. The pressure was varied from a starting pressure of several kPa and was continuously controlled down to a final pressure of 0 kPa.

It can be seen that there are large oscillations in the suction stroke 301. In this case, the color coding from yellow to green, through blue to purple was used again. Accordingly, it can be seen that the measuring curves have a higher amplitude at a higher pressure.

However, there are hardly any oscillations in the pressure stroke 302. This will be described in more detail in the following. First, however, reference is made to FIG. 30B, illustrating an enlarged illustration of the temporal signal progress in the suction stroke.

In FIG. 30B, it can be seen that the measuring curves recorded at a high preliminary pressure at the beginning of the measurements have a large amplitude (yellow). With a decrease of the pressure, the amplitudes decrease accordingly (blue, green). The amplitudes are decreasing more and more (purple) until the temporal signal curve approximates the signal curve in the normal state.

FIG. 30C shows a section of FIG. 30B. At this point in time, the suction stroke has been long completed. However, there are very distinct oscillations clearly visible in the temporal signal curve. Here, reference numeral 303 indicates the large amplitudes (yellow) recorded at a high pressure at the beginning of the measurements. Reference numeral 304 indicates the small signal amplitudes (purple) recorded at the end of the measurements at a pressure that is hardly noticeable.

Since damping is lower in air pumps than in water-conveying pumps, there is a valve oscillation in its natural resonance causing a pressure change that can then be seen in the temporal signal curve. Valve oscillations are here excited by the pressure since the inlet valve is open (free flow). Accordingly, it can be seen in FIG. 30C that the measuring curves have a larger amplitude at high pressures (yellow) than at lower pressures (purple).

FIG. 30D shows the transition from the suction stroke to the pressure stroke. It shows the last millisecond of the suction stroke and the first three milliseconds of the pressure stroke. It clearly shows the different behaviour between suction stroke and pressure stroke, i.e. there are significantly fewer oscillations in the pressure stroke than in the suction stroke.

FIG. 30E shows an enlarged section of FIG. 30D, showing the exponential decay process. Since an overpressure is generated in the pump chamber in the pressure stroke, the inlet valve is closed and cannot oscillate, despite the pressure. Thus, the large oscillations over the entire duration cannot be seen here. However, in the pressure stroke, there are also changes in the valve oscillations occurring in the first milliseconds. Here, the color scheme from yellow through green to purple was used again. It can also be seen again that the amplitudes of the signal curves are larger at a higher pressure and also become smaller and approximate the exponential decay behaviour in the normal state of the pump stroke more and more with a decreasing pressure.

Thus, as can be seen in FIGS. 30A to 30E, different pressures lead to a significant change of the temporal signal curve of the control signal in microfluidic components. This is an external influencing factor that can be detected according to the inventive concept described herein. Each external influencing detector, same as the pressures described exemplarily here, leads to a characteristic deviation in the temporal signal curve, i.e. each external influencing factor leaves an individual fingerprint in the temporal progress of the control signal that can be detected by means of the inventive concept described herein.

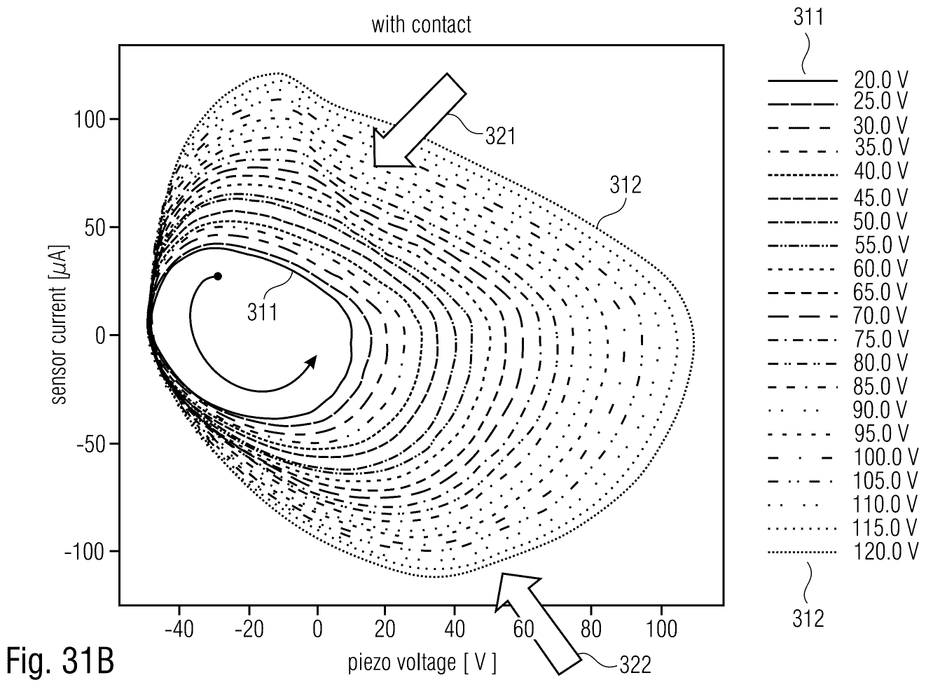

FIGS. 31A and 31B show Lissajous curves (current over voltage) at different control voltages between U=20 V to U=120 V, based on which detection of a contact of the membrane element 101 at the counter electrode in the suction stroke, or at the pump chamber bottom in the pressure stroke is possible. For example, this may be carried out for quality measurements in the context of an end of line test. Alternatively, this may also be carried out during operation, e.g. over several months or years, so as to determine degradation of the membrane actuator 100.

FIGS. 31A and 31B show the sensor current for two different membrane actuators. FIG. 31A shows an actuator in which the drive element can oscillate freely. FIG. 31B shows an actuator in which the drive element contacts the pump chamber bottom. Through this contact and the associated effect of force onto the drive element, the sensor current increases.

The sensor current is plotted over the voltage applied at the drive element instead of over the time. The temporal progress of the signal runs counter-clockwise. The negative amplitude of the suction stroke is the same for all measurements and is −40 V. The positive amplitude is increased in steps of 5 V from 20 V up to 120 V.

FIG. 31A shows a case in which the membrane element 101 does not abut in the suction stroke (positive voltage) and in the pressure stroke (negative voltage) and is able to oscillate freely. FIG. 31B shows the case in which the membrane element 101 contacts the pump chamber bottom when deflecting in the suction stroke, and is released from the pump chamber bottom in the pressure stroke. In the suction stroke, a distinct bend (cf. arrow 321) can be seen, which increases with an increasing drive voltage. In the pressure stroke, a bend can also be seen in the curve progression of the Lissajous curve (cf. arrow 322), highlighting a release of the membrane element 101, with said bend being smaller.

### 6.4 Further Non-Limiting Examples of Detectable External Influencing Factors

The above discussion with reference to FIGS. 20 to 31B has shown that the respective influencing factor can be identified on the basis of the temporal signal curve of the control signal influenced by an external influencing factor. The next sections will show the variety of ways the influencing quantities are able to act on the sensor current and influence the sensor current therewith on the basis of specific examples.

As the above discussion with reference to FIGS. 20 to 31B has shown, each external influencing factor has a characteristic fingerprint in the temporal signal curve of the control signal. The above discussion was carried out using the example of a signal portion or current term Iₚ. That is, there was a discussion of the signal portion or current term Iₚ linked to a temporal change of a pressure acting on the membrane element 101 and, in addition, being proportional to the piezo coupling factor C_{E}*. Beside the above-discussed non-limiting examples for detectable or identifiable external influencing factors, a series of further external influencing factors may be identified on the basis of the signal portion or current term Iₚ.

Correspondingly, according to embodiments of the invention, the signal processing device 105 is configured to examine, on the basis of the signal portion or current term Iₚ, that the fluidic state of a microfluidic component, such as a micropump, operates without disturbances. Disturbances may occur in a variety of ways. Accordingly, the signal processing device 105 may be configured to determine at least one of the following external influencing factors on the basis of the single portion or current term Iₚ:
a change of the counter pressure (e.g., in the case of varying counter pressures, up to the above-mentioned closure of a catheter, the sensor current will change significantly in its time domain),
a change of the preliminary pressure,
a closure of outlet lines, such as of catheters,
a presence of bubbles, e.g. in the pump chamber of a micropump (a gas bubble can generate a blockage pressure at a microvalve due to capillary forces, said blockage pressure being identifiable in the sensor current),
the size of bubbles moving through the pump,
an arrival of a bubble at the pump chamber via the inlet line,
a bubble moving away from the pump chamber via the outlet line,
a change of the pump chamber resistance,
a (sudden) change of the stroke volume by particles being caught,
a change of the ambient parameters, such as a pressure change above the membrane element, a pressure change at the inlet of a valve, a pressure change at the outlet of a valve, a change of temperature,
a state detection of a valve, i.e. whether the valve is open or closed,
a defect of a valve, such as breakage of a valve,
a (sudden) deterioration of valve sealing properties due to particles (e.g. if a hard particle blocks a check valve (e.g. the inlet valve), this may be detected by means of the sensor current in the pressure stroke since ejection of the stroke volume is no longer carried out only via the outlet valve),
a (slow) deterioration of valve sealing properties by sedimentation or agglomeration, e.g. precipitation of solids, denaturation of proteins (if a valve becomes stuck due to denaturation of proteins or precipitation of oil, this can be detected by the sensor current, as the actuator element 102 presses against a closed valve in the corresponding stroke),
the occurrence of capillary sticking when a meniscus blocks a valve,
the occurrence of van der Waals sticking if corresponding molecules are deposited between the valve seat and the support web,
swelling or a change in elastic properties of sealing elements,
a change in an adhesive bond between the actuator element and the membrane element,
since the inertia of liquids in the periphery couples into the micropump (“fluidic resonance”), the micropump (in the case of incompressible liquid as the pump medium) can recognize whether long, short, soft, or hard fluid lines are connected,
a change in the viscosity of the medium, which makes it possible, for example, to check whether the entire medication has been rinsed out and replaced with saline solution during rinsing processes.

The other signal portions or current terms I_{C}, I_{ce}, I_{U} also have effects on the temporal progress of the control signal, i.e. these current terms I_{C}, I_{ce}, I_{U} also influence the control signal, depending on which external influencing factor currently prevails. Thus, according to the invention, these signal portions or current terms I_{C}, I_{ce}, I_{U} can be used to identify certain external influencing factors on the basis of a signal analysis of the temporal progress of the correspondingly influenced control signal.

Thus, according to embodiments of the invention, the signal processing device 105 is configured to verify that the piezoelectric hysteresis process remains unchanged. Possibly, one or more parameters □_{c}, I_{ce} or I_{c} change, which gives an indication as to a mechanical and/or electric change in the piezoceramic. Accordingly, the signal processing device 105 may be configured to determine at least one of the following external influencing factors on the basis of at least one of the signal portions or current terms I_{C} und I_{ce}:
mechanical fatigue of the piezo element, such as breakage or the so-called sub-critical crack growth in a very long continuous operation,
electric fatigue of the piezo element, such as loss of the polarization.

According to further embodiments of the invention, the signal processing device 105 is configured to verify that the electric charging process is carried out properly. Accordingly, the signal processing device 105 may be configured to determine at least one of the following external influencing factors on the basis of the signal portion or current term I_{U}:
tearing of an electrical contact (e.g. bond wire tears),
short circuit of the piezo element (e.g. by condensation of a water droplet at high humidity),
breakage of the piezo element (e.g. when only part of the piezoceramic is electrically contacted, the capacitance and therefore the charge current decreases).

If the inventive measurements and evaluations are carried out in real time, a multitude of verifications of the state of a microfluidic component 1000, such as a micropump or a microvalve, become possible. Obviously, in electrostatically driven microfluidic components 1000, or membrane actuators 100, the signal portions or current terms I_{U} and I_{C} may be used for the same purposes.

Furthermore, in addition to the above-described exemplary amplitudes Iₚ, I_{U}, I_{C}, I_{ce}, alternatively or additionally, their respective decay constants or time constants □ₐ, □ₕ, □□_{P}, □_{d}=□_{c}=□_{piezo} may be used, so as to detect the above-mentioned states or external influencing factors on the basis thereof, i.e. to identify and/or to classify them.

These fluidic verifications are very advantageous.
In case of serious disturbances, an alarm may be output and the dosage may be terminated.
In case of temporary disturbances (e.g. gas bubbles), a system controller may estimate after detection whether and to which extent the gas bubble influences the dosage so that is has to be readjusted.
This disturbance may be put in relationship with the fluidic specification of the respective dosage task of the microfluidic component 1000 (e.g. micropump), and an appropriate reaction may follow.
In fluidic networks with several microfluidic components 1000, e.g., micropumps (e.g., n micropumps), each micropump may report its status. The failure of individual micropumps may be compensated by other micropumps in case of a suitable redundancy.

The effect of this time-dependent mechanical, pneumatic, or hydraulic external influencing factors, or disturbances, with respect to the membrane actuator 100 influences the sensor current like a “fingerprint”.

For example, fluidic resonances of oscillating liquid columns in the supply and drain lines lead to pressure deviations that may in turn be influenced by a gas bubble transported at the inlet tube towards the microfluidic component 1000. These resonances are also influenced by the elasticity, the diameter, and the length of the tube lines used. Furthermore, presence of gas bubbles within the microfluidic component 1000, such as within a pump chamber of a micropump, leads to a significantly more prompt change of the sensor current, since air has a smaller viscosity than water by the factor of 50. When the gas bubble has passed the microfluidic component 1000, the sensor current may be used to observe the transport in the outlet tube in the same way. If a partial bubble remains in the pump chamber, it may be detected as well.

Alternatively or additionally, the following temporal effects may be detected as external influencing factors, i.e. they may be identified and/or classified, by means of the inventive concept described herein.

Thus, for example, it is possible to determine adhesion of the adhesive layer as well as the service life. The mechanical bias of the membrane actuator 100 influences the sensor current. The actuator position is of great significance not only directly after the assembly, but also over the entire lifecycle of the actuator 100. Loss of bias, i.e. a reduction of the mechanical stress in the assembly (i.e. the assembly of the actuator element 102 and the membrane element 101), and a resulting lowering of the membrane element 101 changes the properties of the microfluidic component 1000 and should be detected during operation. This loss of bias may occur due to failure of the adhesive connection (if the polymer chains tear due to very high stresses in the adhesive layer over time and the bias decreases in case of insufficiently hardened adhesives). Creep of the adhesive decreases tension and will therefore influence the electrical capacitance in the sensor current.

In addition to checking the bias, full wettability of the interface can also be verified. Enclosed air bubbles change the voltage state of the ceramic (i.e. the piezoceramic actuator element 102) and can therefore be seen in the sensor current. Sudden or creeping delamination of the assembly during operation leads to a change in the sensor current and can therefore be detected early on.

Not only the adhesive layer is subject to temporal changes, but also the ceramic (i.e. the piezoceramic actuator element 102) itself. Above all, during long operation or extreme control voltages, depolarization of the piezoceramic 102 may occur. This leads to stroke loss and to failure of the microfluidic component 1000 in the extreme case. Early detection enables the adaption of the voltage signal, e.g., to carry out a repolarization or to avoid further depolarization. Such a repolarization may be facilitated by extremely short voltage surges that do not lead to any mechanical deflection and therefore do not influence the conveying behaviour.

In addition, insulation of the actuator element 102 with respect to the membrane element 101 is advantageous for certain applications. For example, the use of multilayer actuators otherwise leads to a short circuit over the membrane element 101. However, many medical applications require insulation of the actuator element 101 from the fluidic path as well. This insulation is then necessarily required for the operation and must not change its insulation properties across the entire service life of the microfluidic component 1000. A slow increase of the leakage current can be seen in the sensor current and can therefore be detected early on.

These monitoring possibilities may be applied to a microvalve in the same way.

7. Methods for Identifying and/or Classifying External Influencing Factors

With the inventive concept described herein, in microfluidic components 1000, the following compensation processes may be measured and distinguished:
charging the electrical capacitance of a piezo membrane actuator 102,
the loss processes in the piezoceramic, illustrated by expansion (shrinkage) of the magnetic domains (Weiss regions), and
the change of the pump chamber pressure in the pump chamber,

This may be done:
in real time,
without having to influence the control signal,
without an additional sensor element,
for each suction stroke,
for each pressure stroke,
solely by time-dependent measurement of the charge current.

To perform the inventive concept, it is advantageous to provide one or more of the following components:
a measurement circuit (as part of the signal processing device 105) for precise, time-resolved measurements of the electric charge current,
a means for real time data acquisition (as part of the signal processing device 105) for the time-dependent charge current,
a means for real time evaluation (as part of the signal processing device 105) of the recorded data, e.g., to determine superimposed amplitudes and/or time constants, through which data reduction can be achieved, and
a means for suitable storage of the data created by the evaluation.

For performing the inventive concept, in principle, there are two different ways that differ, among other things, in their concept for data storage and signal evaluation.

### 7.1 White Box Model

In a so-called white box model, the connection between the measurement signal (influenced control signal 104 including one or more associated signal portions or current terms) and the causal physical disturbance (external influencing factor) is known and may be extracted unambiguously from the influenced control signal including the respective signal portions or current terms. The evaluation of the data already obtains the desired statement about the system, i.e. the external influencing factor that influences the temporal signal curve can be detected and identified.

In the context of the present disclosure, the term “identifying” can be understood such that the type of the external influencing factor, or its physical background, can be indicated clearly, e.g. a gas bubble is located in the pump chamber, a valve is clotted, a valve is blocked, there is certain counter pressure, there is a certain pressure, etc.

With respect to such a wide box model, according to embodiments of the invention, the signal processing device 105 comprises a storage that stores how a certain external influencing factor influences the temporal signal curve of the control signal 104. In this case, the signal processing device 105 is configured, on the basis of temporal signal curve of the influenced control signal 104, to identify the respectively causal external influencing factor on the basis of the influencing factor information stored in the storage.

### 7.2 Black Box Model

In a so-called black box model, the relationship between the measurement signal (influenced control signal 104 including one or more associated signal portions or current terms) and the physical disturbance (external influencing factor) is unknown at first, and cannot be extracted directly from the influenced control signal 104 at first. In such a case, methods of machine learning may be used, wherein a neural network may be utilized. In this case, the membrane actuator 100 may be trained by generating external influencing factors (e.g. disturbances) and by capturing the system response in a statistical significant way. As a result of this training, weighted connections of this neural network are obtained. After this training, the membrane actuator 100 requires only these weights so as to capture the respective causal external influencing factor with a relatively high probability and to classify the same accordingly.

In the context of the present disclosure, the term “classifying” can be understood such that a weight, or a probability, is determined, on the basis of which a statement may be made as to with which probability the external influencing factor determined on the basis of the temporal signal curve of the influenced control signal may be assigned to a certain class (e.g. valve is blocked, valve is clotted, gas bubble, pressure, counter pressure, etc.). For example, such a classification may be carried out with the previously-mentioned neural network.

With respect to such a black box model, according to embodiments of the invention, the signal processing device 105 comprises a neural network trained in advance by generating different external influencing factors and determining their respective effect on the temporal progress of the control signal 104. The neural network is configured, on the basis of the temporal signal curve of the influenced control signal 104, to classify the at least one causal external influencing factor on the basis of the previously created training data.

As described herein in detail, the membrane actuator 100 is fluidically coupled to a system, wherein the interrelationships may be very complex, since they overlap on the one hand, and they can mutually influence each other on the other hand. According to the invention, the sensor current describes an integral across all influencing variables, which again renders it predestined for the use of “machine learning” and “neural networks”. Another indication for this is that these influences can obviously be detected purely through the observation of measuring curves of the sensor current without a direct physical relationship being apparent.

### 7.3 Grey Box Model

Between the above-mentioned black box and white box models, there are different graduations in which the relationship between the measurement signal (influenced control signal 104 including one or more associated signal portions or current terms) and the physical disturbance (external influencing factor) can only be approximated by means of semi-empirical models. This middle ground may be referred to as a grey box model accordingly. In this case, the training may be simplified significantly and may be realized with efficient optimization algorithms. Here, the disturbance detection usually takes place more reliably than in the case of pure neural networks.
1) The calculations in sections 4 and 5, where the “step response” of a piezoelectrically driven microfluidic membrane actuator 100 upon sudden voltage change was analyzed, may be considered as a physical modelling, however, which is subject to certain simplifications (e.g. no consideration of the large signal behaviour, hysteresis or piezo creep, or the phenomenon of the fluidic resonance). Thus, this physical modelling cannot accurately represent reality. However, the model describes some principle features and dependencies of the sensor current with respect to the processes at the membrane actuator 100. Thus, this concept may be considered as a grey box description.
2) Another analog example for a grey box description is the response of the sensor current with respect to a harmonic voltage control, as described in section 4.3.

By using a corresponding physical model, the temporal signal curve of the influenced control signal 104 including the associated one or more signal portions or current terms I_{U}, I_{C}, I_{ce}, Iₚ can be determined by fitting the model to the measurement results (cf. section 5).

With respect to such a grey box model, according to embodiments of the invention, the signal processing device 105 comprises a storage in which a mathematical model with an associated amplitude curve and/or an associated time constant of the respective signal portion is stored for each of the one or more of the individual signal portions I_{U}, I_{C}, I_{ce}, Iₚ. In this case, the signal processing device may be configured to fit the mathematical model to the temporal signal curve of the influenced control signal 104 and to identify the respectively causal external influencing factor with the help of the fitted mathematical model.

Optionally, a neural network may be used to optimize the fitting. In this case, the external influencing factor may be classified on the basis of a fitting carried out with a previously trained neural network.

### 7.4 Possible Realization and System Integration

FIG. 32 shows a schematic block circuit diagram of a conceivable realization in hardware and software of the inventive concept described herein. To begin with, it shows a self-sufficient system that represents the inventive microfluidic component 1000.

The microfluidic component 1000 comprises the membrane actuator 100 that may be driven piezoelectrically or electrostatically. Furthermore, the microfluidic component 1000 comprises the signal generation device 103 configured to control the membrane actuator 100 with the control signal 104. External influencing factors 116 that may characteristically influence the temporal progress of the control signal 104 in the sense of an individual fingerprint may act on the membrane actuator 100.

The signal processing device 105 measures the control signal 104 that, upon presence of external influencing factors 116, may comprise an influenced temporal signal curve. The signal processing device 105 is further configured to determine the influence on the temporal signal curve of the control signal 104 and, on the basis thereof, to identify and/or classify at least one external influencing factor 116 that causes the same.

As explained in sections 4 and 5, the influenced control signal 104, depending on the embodiment of the actuator element 102, may comprise several (up to four) different signal portions I_{U}, I_{C}, I_{ce}, Iₚ, also referred to a current terms 117 in the context of the present disclosure. The signal processing device 105 may identify and/or classify the external influencing factors 116 on the basis of the individual current terms I_{U}, I_{C}, I_{ce}, Iₚ.

The membrane actuator 100 may be controlled by a microcontroller. Optionally, the microcontroller may be configured together with the signal generation device 103, as exemplarily illustrated here in FIG. 32. The charge and sensor current, i.e. the control signal 104, may be pre-processed by means of the signal processing device 105 (current term measurement circuit) and may be sampled by means of the microcontroller. Through this, the temporal signal curve of the control signal 104 may be discretized.

The current term data 117′ discretized in such a way may be transferred to a powerful PC 118 via a serial interface. If a neural network is used for classifying the external influencing factor 116, the training of the neural network may be carried out on the PC 118. For example, the neural network may be optimized explicitly for the microcontroller and may be transferred to the microcontroller after training. Optionally, the system states may be additionally detected by means of an external sensor system 119 and may also be transferred to the PC 118.

Thus, the inventive microfluidic component 1000 is able to detect its system state and to react accordingly. For example, the control signal 104 may be adapted or changed so that tracking or post-control of the operating point is possible (cf. edge 121).

Optionally, a user interface 122 may be provided, by means of which the operating point may be controlled manually. Alternatively or additionally, a user may obtain information, such as information about the identified and/or classified external influencing factor, via the user interface 122. If the signal processing device 105 determines a deviation of the operating point from the normal state, e.g. due to a detected external influencing factor 116, the detected deviation from the normal state may be indicated to the user by means of the user interface 122 via an optical and/or acoustic signal. To this end, e.g., an alarm may be triggered.

FIG. 33 shows a schematic block illustration of individual conceivable components of the signal processing device 105, or the microcontroller, if neural networks are used.

To begin with, FIG. 33 shows in a purely schematic way the analog measurement circuit with an operational amplifier (OPA) 109 measuring resistor 110, and the Zener diodes 111, 112 as previously described with reference to FIGS. 3 and 4. As also described there, the ground electrode of the microfluidic component 1000 and the ground electrode of the analog circuit may be interconnected.

This generates a virtual ground potential so that the analog circuit does not apply a load to the signal processing device 103 and the control signal 104 is therefore not distorted.

A control signal 104 amplified by means of the OPA 109 may be forwarded to a data processing module 123. Here, the data may be discretized, e.g. by means of an ADC. Optionally, the signal of the signal generator (T=1/f) may be input into the data pre-processing module 123 so as to determine the considered duration (one pump cycle: one suction stroke, one pressure stroke). Optionally, an adjustment of the sampling rate may be possible. To this end, there may be a connection to the microcontroller.

The input vector 124 with the discretized raw data 123 may then be forwarded to an AI module 125 (AI: artificial intelligence). The AI module 125 may comprise a neural network. The output vector 126 of the AI module 125 may be forwarded to an analog-digital converter (ADC) 127. The analog measurement values of the analog measurement circuit may also be forwarded to the ADC 127, highlighted by means of the edge 128. The signal digitized by the ADC 127 may then be forwarded to a defined interface 129 (UART, USB, I²C, SPI, . . . ).

Thus, a possible control of the microfluidic component 1000 would therefore be conceivable by means of a corresponding microcontroller with an ADC (analog-digital converter), a serial interface coupled to the signal processing device 105 (measurement circuit), and a driver (e.g. pump driver) with a means for generating high voltages.

A conceivable concept for the data evaluation could include one or more of the following components:
classification of the stages by means of time series classification (e.g. detection of anomalies with an auto encoder)
reaction/control with respect to the error state: adapting/adjusting the charge current (e.g. by adjustment of the PWM signal at the micropump driver) to the current state so as to keep the flow rate constant
integration of the algorithms directly into the pump controller (ASIC)
development of a “disturbance variable IC”, e.g., by means of FPGA, evaluating the data from the sensor current electronics and providing the required information/closed-loop control to the pump driver (small, energy efficient)
if the microfluidic component 1000 comprises a pump and a valve, the pump may also react to the error states of the valve

With the inventive concept described herein, it becomes possible to provide a self-sufficiently operated microfluidic component 1000 with a (e.g. piezoelectrically or electrostatically driven) membrane actuator 100 that detects a system state (e.g. by means of a neural network) itself and reacts to the same in a problem-solving manner, or informs the user accordingly.

### 8. Additional Explanations Regarding the Above Discussion

The above discussion presumed prior knowledge, or basic theoretical knowledge, with respect to the pump chamber pressure, the time behaviour after a voltage change and the use boundary conditions of micropumps as an example for inventive microfluidic components 1000. For the sake of completeness, the presumed basics will be explained in the following.

### 8.1 Pump Chamber Pressure

The pressure in the fluid under the membrane element 101 is a scalar quantity that can adopt different values in each point of the pump chamber, in principle. Thus, the pressure could differ in each point and at each point in time.

Now, if the pump chamber height is very large so that the pressure does not drop significantly in case of a flow in the pump chamber, this may be referred to as a homogenous pump chamber pressure p (early micropumps from the 1990s were constructed in such a way). In this case, the pump chamber pressure p will have the same size at any place in the pump chamber at any given point in time. The theoretical considerations of the present disclosure assume such a case.

However, in modem micropumps, the pump chamber is configured to be very flat in order to decrease the dead volume and to therefore increase the compression ratio. The pressure drop in the pump chamber can no longer be neglected. In many cases, it is even larger than the pressure drop at the valves. The assumption of a homogenous pump chamber pressure is therefore not a good approximation, which is why the theoretical considerations only represent reality with a certain uncertainty (grey box model).

In reality, when carrying out the suction and pressure strokes, there will be a pressure drop that is greater the faster the fluid flows in or out at a given point in time. Regardless, there is a sum effect of force onto the membrane element 101, causing a time-dependent charge transfer dQ/dt=Iₚ, caused by the direct piezoelectrical effect. This charge transfer is then correlated by the integral of the location-dependent pressure at the respective point in time t.

8.2 Temporal Behavior after a Voltage Change

Assuming an infinitely fast voltage change (which does not exist in practice), there would be several effects:
1) If, after applying the voltage infinitely quickly (e.g. within one 1 μs if the voltage is generated with a frequency generator and piezo amplifier that may also provide the corresponding currents), an electric field acts in the piezoceramic (piezo actuator element 102), leading to the contraction of the piezoceramic according to the coefficient d31, wherein this contraction applies a bending torque onto the membrane element 101 via the adhesive layer (between the membrane element 101 and the actuator element 102). These mechanical signals propagate with the speed of sound. In case of an assumed speed of sound of 1500 m/s in a liquid and a lateral expansion of the micropump of up to 0.015 mm, this signal would accordingly require a time of t=0.015/1500=10 μs to propagate across the entire membrane element 101 (accordingly, this is quicker for smaller micropumps).
2) Assuming that an incompressible liquid is located under the membrane element 101, and the effect of mechanical force has appeared in the bending actuator 102 after 10 μs, a pressure change occurs in the fluid under the membrane element 101 within the same time range (the speed of sound is still assumed to be 1500 m/s). Since a fluid does not move through the valve in this short time range, the incompressible liquid generates a counter force (action=reaction). Since liquid does not yet flow in this short time range, there are no pressure drops in the pump chamber yet and one can even speak of a homogeneous pump chamber pressure. This maximum pressure is the blockage pressure or “stall pressure”. According to the much slower time constant of the valve and the pump chamber flow, the pressure in the fluid starts to change, i.e. the fluid pressure becomes location-variable (due to the flow) and it decreases temporally. If compressible air or partially compressible air (through a gas bubble of the volume V_{gas}) was in the pump chamber instead of water, this gas bubble would also be compressed in a very short time after switching on the voltage according to its state equation (or would be expanded in the suction stroke), i.e. before the medium is able to move through the valves, wherein the piezo membrane transducer loses force according to its fluidic capacity and is no longer able to generate its blocking pressure.
3) The piezo membrane interconnection (i.e. the membrane element 101+adhesive+actuator element 102) has a mechanical resonance frequency of several 10 kHz, depending on the design and depending on whether there is liquid or air under the membrane element 101. The membrane element 101 is excited in its resonance frequency and overshoots (if the voltage change is quicker than the resonance frequency), which can be observed in the form of an increased volume, a larger mechanical stress, and larger transient strokes. These larger strokes can be observed in gas micropumps, for example, when the pump is controlled with a hard rectangular signal. In principle, this behaviour can also be detected and examined with the inventive concept described herein. However, in practice, this phenomenon should not occur since the rise of the voltage level is usually configured such that these resonance frequencies are not excited.
4) The microvalves in the pump chamber are also movable elements and have a resonance frequency. The same is in the order of kHz and may also drop below 1 kHz (depending on the design), e.g. when the effective oscillating mass is increased due to presence of a liquid. Depending on the implementation of the control electronics, the microvalves can be excited to oscillate in case of quick voltage changes, which was already observed in experiments. These oscillations of the valve lead to pressure oscillations in the pump chamber. These pressure oscillations could already be proven in experiments with the sensor current or current term Iₚ. They occur significantly when air is at the valve flap (e.g. FIG. 21), however, they can also be observed in the case of water (FIG. 25). Since, in the case of a natural frequency oscillation, the surrounding medium has to be moved as well, the effective mass of the oscillating system increases, thus, the observed natural frequency is higher in the oscillation in water (FIG. 25) than in the oscillation in air (FIG. 21). Due to the lower viscosity, since the damping of the oscillation is significantly smaller in air than it is in water, the oscillation amplitudes of the valves are significantly larger in air than they are in water. It has to be highlighted that oscillations by no means have to occur in every valve design. If the damping is large enough (e.g. at very low pump chamber heights), the asymptotic boundary case can also be reached in case of a rectangular excitation in air, and there is no oscillation.

### 8.3 Monitoring a Microfluidic Component During Operation on the Basis of the Sensor Current

There are often cases in which the usage boundary conditions of a microfluidic component 1000 are known and typically do not change. One example for this would be a medication dosage by means of a micropump, wherein the micropump is attached together with the medication reservoir near the body and administers the medication to the patient via a catheter. For these cases, the measured current I (i.e. the control signal 104) can be determined for each suction stroke and for each pressure stroke in a time-resolved way, i.e. I(t). Thus, one obtains a temporal current curve for the suction stroke of the pump I_{suction}(t) and for the subsequent pressure stroke Iₚᵣₑₛₛᵤᵣₑ(t). These currents I_{suction}(t) or Iₚᵣₑₛₛᵤᵣₑ(t) again consist of the above-described signal portions or current terms I_{U}, I_{C}, I_{ce} and I_{P}.

In the steady state, if the micropump operates without disturbances, the temporal current curve of the pump cycle n+1 is very similar to the previous pump cycle n. Now, if a disturbance of the pump operation occurs in the pump cycle n+1 (e.g. the valve breaks, entry of a large bubble, unplugging the tube, bending the tube, clogging of access of the patient, blockage of the valve by a particle), the temporal signal curve of at least one current term I_{U}, I_{C}, I_{ce}, I_{P} changes and therefore also the temporal signal curve of the control signal 104, i.e. according to the disturbance in the suction stroke, in the pressure stroke, or in both strokes. That is, the signal processing device 104 can detect a change, e.g., by comparing the current signal (control signal 104) of cycle n+1 I_{suction}(t)ₙ₊₁, with the current signal of cycle n I_{suction}(t), or with any previous current signal (e.g. of cycle n−1 I_{suction}(t)ₙ₊₁).

According to embodiments of the invention, thus, the signal processing device 105 can be configured to compare the temporal signal curve of the control signal 104 of an actuation cycle (n+1) of the microfluidic component 1000 to the temporal signal curve of a temporally preceding actuation cycle (n), and to detect deviations between the two signal curves.

In case of detected deviations, e.g., the signal processing device 105 may be configured to indicate the detected deviation by means of an optical and/or acoustic signal. In many cases, it is enough to indicate that a disturbance has occurred in the dosage process. In cases in which a micro-dosage is safety relevant (e.g. vital medications), an alarm may be triggered and corresponding measures may be started (e.g. changing the dosage system). However, in non-critical cases, it can be indicated that the dosage module does not operate normally, and the pump can indicate this in an optical or acoustic way and report it to a control center.

The control signals 104 and the suction stroke I_{suction}(t) and/or in the pressure stroke Iₚᵣₑₛₛᵤᵣₑ(t) may be captured in real time. Thus, e.g., if a micropump pumps with a pump frequency of f=10 Hz, the control signals I_{suction}(t) or Iₚᵣₑₛₛᵤᵣₑ(t) may be captured every 100 ms. It is possible, but not required, to fully store this raw data. A comparison of the raw data would be very intensive with respect to storage and computational capacity. For example, the following would be possibilities to reduce data:
The time ranges of interest of the measured current I(t) are known, and measurements are only carried out in this range with a suitable sampling rate. In the example of a micropump pumping with 10 Hz and controlled with electronics that generates the voltage within a millisecond, the suction stroke and the pressure stroke (depending on the flow resistance of the valves and the pump chamber as well as the viscosity of fluid) are performed in a few milliseconds (e.g. FIG. 23). The above-mentioned potentially occurring disturbances that all influence the current term Iₚ(t) will cause a significant change only in this time window. Thus, it would make sense to sample the time range up to approximately 5 ms after the start of the suction or pressure stroke, and to then no longer capture measurement values. The time window from the remaining 45 ms to the next stroke may be used for evaluations of the raw data and storage of appropriately processed data. According to embodiments of the invention, the signal processing device 105 may be configured to use, during an actuation cycle (suction stroke or pressure stroke) of the microfluidic component 1000, a first temporal portion of the actuation cycle to determine the temporal signal curve of the control signal 104, and to use the remaining second temporal portion of the actuation cycle, up to the beginning of the subsequent actuation cycle, for storing and/or evaluating the determined signal curve.
The amount of data may be reduced further by suitably fitting the measured values concerning the temporal signal curve and by storing only the respective fitting parameters. Models for this fit are already available in the case of grey box models. In the above-discussed examples, the total current I(t) was split into a sum of partial currents I_{U}(t), I_{C}(t), I_{ce}(t), I_{P}(t), that each decay exponentially. The amplitudes and time constants of these partial currents were obtained as fitting parameters. According to embodiments of the invention, e.g., only these fitting parameters may be stored for each suction and pressure stroke. The large amount of raw data will then be reduced to very few values. That is, the signal processing device 105 may be configured to store the determined signal curve in the form of parameters each representing a temporal amplitude curve and an associated time constant of at least one signal portion I_{U}, I_{C}, I_{ce}, Iₚ of the control signal I(t).
Thus, as long as the amount of data has been reduced, as described above, the correspondingly reduced values may then be compared very easily. Furthermore, the signal processing device 105 may also evaluate a trend development of these values across many pump cycles and use this information to assess the state of the micropump.
In many cases, it is not required to measure each individual pump cycle. In the case of a pump that pumps with 10 Hz, this measurement (and the comparison with respect to a disturbance-free operation) may be done in any longer interval, e.g., once per second (i.e. in every tenth stroke) or once per hour. This saves a great amount of storage and computational capacity and therefore also energy, above all in battery-operated applications, or in long-time implants. Correspondingly, according to embodiments of the invention, the signal processing device 105 may be configured to capture the temporal signal curve of the control signal 104 during two actuation cycles (e.g. first and tenth pumps stroke), with there being a multitude of further actuation cycles between these two actuation cycles, during which the signal processing device 105 does not capture any data.
In addition, it would be conceivable in principle to detect signs of fatigue and degradation: In such cases, a comparison of parameters may be carried out by comparing the stored parameters over long periods of time (weeks, months or even years) (e.g. in long-time implants, or in high-quality long-life industrial applications such as lubricant dosage of quick-rotating bearings or micro-cooling of servers).
   If, e.g., there are micro-tears in the piezoceramic during very long operation, then:
      The stiffness of the membrane may decrease and the stroke of the micropump may decrease (which changes the current term Iₚ),
      The piezo properties (d31 and capacitance) may change, the coefficient d31 is directed proportional to C_{E}*, thus, it influences the current terms I_{ce} and I_{C}
   or if the adhesive strength decreases between the piezoceramic (actuator element 102) and the membrane element 101. There are strong shear stresses in this adhesive layer, thus, if polymer chains of the adhesive tear over a long duration, this may decrease the bias of the piezo membrane transducer, reducing the compression ratio, which in turn affects the current term Iₚ.

Thus, in summary, it can be noted that the inventive concept described herein provides a membrane actuator 100 for micropumps or microvalves, wherein the membrane actuator 100 contacts a fluid (gas or liquid) on one side, and has applied thereto a time-variant electric control signal 104 U(t), wherein U(t) or a quantity I(t) derived therefrom is determined in an electrically precise way by a measurement circuit 105 during operation of the membrane actuator, and the time-variant influence on the electric control signal 104 I(t) through hydraulic, pneumatic, piezo-electric or mechanical processes acting on the membrane actuator 100 is captured, wherein these different processes are detected by evaluation of the control signal 104 I(t) and may be distinguished.

The above-described embodiments provide only an illustration of the principles of the innovative concept described herein. It is obvious that modifications and variations of the arrangements and details described herein will be obvious to those skilled in the art. Thus, it is intended that the concept described herein shall only be limited by the protective scope of the following claims, and not by specific details presented on the basis of the description and the explanation of the embodiments herein.

Some or all of the method steps may be carried out by a hardware device (or using a hardware device), such as a microprocessor, a programmable computer, or an electronic circuit. In some embodiments, some or several of the most important method steps may be carried out by such a device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable.

Some embodiments in accordance with the invention thus comprise a data carrier that comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing any of the methods described herein, said computer program being stored on a machine-readable carrier. In other words, an embodiment of the inventive method thus is a computer program which has a program code for performing any of the methods described herein, when the computer program runs on a computer.

A further embodiment of the inventive methods thus is a data carrier (or a digital storage medium or a computer-readable medium) on which the computer program for performing any of the methods described herein is recorded. The data carrier, the digital storage medium, or the computer-readable medium are typically tangible, or non-volatile.

A further embodiment of the inventive method thus is a data stream or a sequence of signals representing the computer program for performing any of the methods described herein. The data stream or the sequence of signals may be configured, for example, to be transmitted via a data communication link, for example via the internet.

A further embodiment includes a processing unit, for example a computer or a programmable logic device, configured or adapted to perform any of the methods described herein.

A further embodiment includes a computer on which the computer program for performing any of the methods described herein is installed.

A further embodiment in accordance with the invention includes a device or a system configured to transmit a computer program for performing at least one of the methods described herein to a receiver. The transmission may be electronic or optical, for example. The receiver may be a computer, a mobile device, a memory device, or a similar device, for example. The device or the system may include a file server for transmitting the computer program to the receiver, for example.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Microfluidic component, comprising
a membrane actuator with a membrane element and an actuator element for deflecting the membrane element,
a signal generation device configured to generate an electric control signal with a time-variant signal curve for controlling the membrane actuator, by which the actuator element actuates the membrane element,
a signal processing device configured to determine, during operation of the microfluidic component, an influence on the temporal signal curve of the control signal, caused by one or more external influencing factors, and
to identify and/or classify, based on said influence on the temporal signal curve, at least one causal external influencing factor.

2. Microfluidic component according to claim 1,
wherein the signal processing device is configured to
differentiate a first temporal signal curve of the control signal corresponding to an actuation of the membrane actuator without external influence from a different second temporal signal curve of the control signal corresponding to an actuation of the membrane actuator with at least one prevailing external influencing factor.

3. Microfluidic component according to claim 1,
wherein the signal processing device is configured to
identify and/or classify a hydraulic, pneumatic, or mechanical force acting on at least one membrane side of the membrane element as the causal external influencing factor for the effect on the temporal signal curve.

4. Microfluidic component according to claim 1,
wherein the membrane actuator is a piezoelectrically driven membrane actuator whose actuator element comprises at least one piezo element, and
wherein the control signal causes deformation of the piezo element by using the inverse piezo effect, by which the piezo element applies an actuation force onto the membrane element, and
wherein the temporal signal curve of the control signal is influenced by a signal that originates from the piezo element, which the piezo element generates due to a counter force of the membrane element on the basis of the direct piezo effect.

5. Microfluidic component according to claim 4,
wherein the signal processing device is configured to perform a signal analysis of the temporal signal curve of the control signal for determining and/or classifying the at least one causal external influencing factor,
wherein individual signal portions of the control signal are determined, wherein the individual portions are correlated with different external influencing factors that differently influence the temporal progress of the control signal,
and wherein the signal processing device is configured to assign a specific signal portion to a specific external influencing factor and to use this to identify and/or classify the respective external influencing factor.

6. Microfluidic component according to claim 4,
wherein the signal processing device is configured to differentiate at least four different signal portions of the influenced control signal from each other, wherein
a first signal portion is linked to a temporal change of the electric voltage when charging or discharging the capacitance between the membrane element and the piezo element,
a second signal portion is linked to a temporal change of a pressure acting onto the membrane element,
a third signal portion is linked to a temporal change of the electrical capacitance caused by large signal effects of the piezo element, and
a fourth signal portion is linked to a temporal change of the piezo coefficient d31 that changes due to large signal effects in the piezo element.

7. Microfluidic component according to claim 5,
wherein each of the individual signal portions strives to achieve a state of balance through an individual temporal compensation process, wherein, during the respective temporal compensation process, each signal portion comprises an individual temporal amplitude curve and an individual time constant within which the temporal compensation process occurs, and
wherein the signal processing device is configured to determine the external influencing factor on the basis of the respective amplitude curve and/or the respective time constant from one or more of the individual signal portions.

8. Microfluidic component according to claim 5,
wherein the signal processing device is configured to determine at least one of the following external influencing factors on the basis of the second signal portion:
a change of the counter pressure,
a change of the preliminary pressure,
a closure of outlet lines, such as of catheters,
a presence of bubbles in the pump chamber,
the size of bubbles in the pump,
an arrival of bubbles at the pump chamber via the inlet line,
bubbles moving away from the pump chamber via the outlet line,
a change of the pump chamber resistance,
a change of the stroke volume by particles being caught,
a change of the ambient parameters, such as a pressure change above the membrane element, a pressure change at the inlet of a valve, a pressure change at the outlet of a valve, a change of temperature,
a state detection of a valve, i.e. whether the valve is open or closed,
a defect of a valve, such as breakage of a valve,
a deterioration of valve sealing properties due to particles,
a deterioration of valve sealing properties by sedimentation or agglomeration, e.g. precipitation of solids, denaturation of proteins,
an occurrence of capillary sticking when a meniscus blocks a valve,
an occurrence of van der Waals sticking if corresponding molecules are deposited between the valve seat and the support web,
swelling or a change in elastic properties of sealing elements,
a change in an adhesive bond between the actuator element and the membrane element,
since the inertia of liquids in the periphery couples into the micropump, the micropump (in the case of incompressible liquid as the pump medium) can recognize whether long, short, soft, or hard fluid lines are connected,
a change in the viscosity of the medium, which makes it possible, for example, to check whether the entire medication has been rinsed out and replaced with saline solution during rinsing processes.

9. Microfluidic component according to claim 5,
wherein the signal processing device is configured to determine at least one of the following external influencing factors on the basis of the third and/or fourth signal portions:
mechanical fatigue of the piezo element, such as breakage or the so-called sub-critical crack growth in a very long continuous operation,
electric fatigue of the piezo element, such as loss of the polarization.

10. Microfluidic component according to claim 5,
wherein the signal processing device is configured to determine at least one of the following external influencing factors on the basis of the first signal portion:
tearing of an electrical contact,
short circuit of the piezo element,
breakage of the piezo element, e.g. when only part of the piezoceramic is electrically contacted, the capacitance and therefore the charge current decreases.

11. Microfluidic component according to claim 1,
wherein the membrane actuator is an electrostatically driven membrane actuator whose membrane element forms a moveable electrode and whose actuator element forms a counter electrode, wherein the actuator element and the membrane element cooperate capacitively,
wherein the control signal causes a charge flow on the counter electrode, by which the membrane element moves relative to the counter electrode, and
wherein the temporal progress of the control signal is influenced by a change of capacitance created during the movement of the membrane element relative to the counter electrode.

12. Microfluidic component according to claim 11,
wherein the signal processing device is configured to perform signal analysis of the temporal signal curve of the control signal for determining and/or classifying the at least one causal external influencing factor,
wherein individual signal portions of the control signal are determined, wherein the individual signal portions are each correlated with different external influencing factors that differently influence the temporal progress of the control signal,
and wherein the signal processing device is configured to assign a specific signal portion to a specific external influencing factor and to use this to identify and/or classify the respective external influencing factor.

13. Microfluidic component according to claim 11,
wherein the signal processing device is configured to differentiate at least two different signal portions of the influenced control signal from each other, wherein
a first signal portion is linked to a temporal change of the electric voltage when charging or discharging the capacitance between the membrane element and the actual element, and
a second signal portion is linked to a temporal change of the capacitance between the membrane element and the actuator element due to the movement of the membrane element.

14. Microfluidic component according to claim 13,
wherein, during movement of the membrane towards the actuator element, the capacitance between the membrane element and the actuator temporally changes so that the second signal portion changes, and
wherein the signal processing device is configured to determine the temporally variable position of the membrane element relative to the actuator element on the basis of the variable second signal portion.

15. Microfluidic component according to claim 14,
wherein the temporally variable position of the membrane element depends on a pressure that acts on the membrane element, and
wherein the signal processing device is configured, on the basis of the second signal portion, to determine the pressure acting on the membrane element and to identify the same as the external influencing factor.

16. Microfluidic component according to claim 15,
wherein the signal processing device knows the temporal signal curve of the second signal portion without any external influencing factor, and
wherein the signal processing device is configured to detect a deviation, caused by the pressure, of the temporal signal curve of the second signal portion compared to the known temporal progress of the second signal portion and, on the basis of this deviation, to determine the pressure acting on the membrane element and to identify the same as the external influencing factor.

17. Microfluidic component according to claim 5,
wherein the signal processing device comprises a storage in which a mathematical model with an associated amplitude curve and/or an associated time constant of the respective signal portion is stored for each of the one or more of the individual signal portions, and
wherein the signal processing device is configured to fit the mathematical model to the temporal signal curve of the influenced control signal and to identify, with the help of the fitted mathematical model, the respective causal external influencing factor.

18. Microfluidic component according to claim 1,
wherein the signal processing device comprises a storage that stores how a certain external influencing factor influences the temporal signal curve of the control signal, and
wherein the signal processing device is configured, on the basis of the temporal signal curve of the influence control signal, to identify the respectively causal external influencing factor on the basis of the influencing factor information stored in the storage.

19. Microfluidic component according to claim 1,
wherein the signal processing device comprises a neural network trained in advance by generating different external influencing factors and determining their respective effect on the temporal progress of the control signal,
wherein the neural network is configured, on the basis of the temporal signal curve of the influenced control signal, to classify the at least one causal external influencing factor on the basis of the previously created training data.

20. Microfluidic component according to claim 1,
wherein the microfluidic component comprises a microfluidic pump with a pump chamber, wherein at least one membrane side of the membrane element is in contact with a fluid located in the pump chamber, wherein a variable pump chamber pressure is generated in the pump chamber by actuating the membrane actuator,
and wherein the signal processing device is configured, on the basis of the temporal signal curve of the control signal, to determine the variable pump chamber pressure and to use this to identify and/or classify the external influencing factor.

21. Microfluidic component according to claim 1,
wherein the microfluidic component comprises a microfluidic valve that enables opening and/or closing a fluid path, and
wherein the signal processing device is configured, on the basis of the temporal signal curve of the control signal, to identify and/or classify the external influencing factor and/or to determine a time-variant operation parameter of the micro fluid valve.

22. Microfluidic component according to claim 1,
wherein the signal processing device is configured, on the basis of the temporal signal curve of the control signal, to determine the type of the fluid used in the microfluidic component and to carry out a differentiation of the aggregate state of the fluid between gaseous and liquid, and
identify and/or classify the determined fluid and/or its determined aggregate state as the external influencing factor.

23. Microfluidic component according to claim 1,
wherein the signal processing device is configured to compare the temporal signal curve of the control signal of an actuation cycle of the microfluidic component with the temporal signal curve of a temporal preceding actuation cycle and to detect deviations between the signal curves.

24. Microfluidic component according to claim 23,
wherein the signal processing device is configured to indicate a detected deviation by means of an optical and/or acoustic signal.

25. Microfluidic component according to claim 1,
wherein the signal processing device is configured, during an actuation cycle of the microfluidic component,
to use a first temporal portion of the actuation cycle to determine the temporal signal curve of the control signal, and
to use a remaining second temporal portion of the same actuation cycle, up to the start of a subsequent actuation cycle, for storing and/or evaluating the determined signal curve.

26. Microfluidic component according to claim 25,
wherein the signal processing device is configured to store the determined signal curve in the form of parameters, each representing a temporal amplitude curve and an associated time constant of at least one signal portion of the control signal.

27. Microfluidic component according to claim 25,
wherein the signal processing device is configured to determine a temporal trend development of the temporal signal curve across a multitude of actuation cycles and to use this trend development to determine the external influencing factor and/or to assess a state of the microfluidic component.

28. Microfluidic component according to claim 25,
wherein the signal processing device is configured to capture the temporal signal curve of the control signal during two actuation cycles, wherein there is a multitude of further actuation cycles between these two actuation cycles, during which the signal processing device does not capture any data.

29. Microfluidic component according to claim 1,
wherein the microfluidic component is configured to detect the external influencing factor purely on the basis of a signal analysis of the temporal signal curve of the electric control signal without using additional sensor systems in the membrane element and/or in the actuator element.

30. Microfluidic component according to claim 1,
wherein the signal processing device comprises an operational amplifier, wherein an inverting input of the operational amplifier is connected to a signal output of the membrane actuator, and wherein a non-inverting input of the operational amplifier is connected to the same ground potential as the signal generation device so that a virtual ground potential is generated at the inverting input of the operational amplifier, and
wherein the signal processing device further comprises a measuring resistor connected between the inverting input and the output of the operational amplifier,
wherein the control signal processing the signal processing device drops across this measuring resistance.

31. Method for operating a microfluidic component with a membrane actuator comprising a membrane element and an actuator element for deflecting the membrane element, the method comprising:
generating an electric control signal for controlling the membrane actuator, by which the actuator element actuates the membrane element, wherein the electric control signal comprises a time-variant signal curve,
determining, during operation of the microfluidic component, a temporal signal curve of the control signal influenced by one or more external influencing factors, and
identifying and/or classifying at least one external influencing factor on the basis of the determined influenced temporal signal curve.

32. A non-transitory digital storage medium having a computer program stored thereon to perform the method for operating a microfluidic component with a membrane actuator comprising a membrane element and an actuator element for deflecting the membrane element, the method comprising:
generating an electric control signal for controlling the membrane actuator, by which the actuator element actuates the membrane element, wherein the electric control signal comprises a time-variant signal curve,
determining, during operation of the microfluidic component, a temporal signal curve of the control signal influenced by one or more external influencing factors, and
identifying and/or classifying at least one external influencing factor on the basis of the determined influenced temporal signal curve,
when said computer program is run by a computer.
